(19) United States
(12) Patent Application Publication
(10) Pub. No.: US 2026/0358599 A1
(43) Pub. Date: Nov. 12, 2026

(54) OPTICAL SYSTEM AND CAMERA MODULE COMPRISING SAME

(71) Applicant: LG INNOTEK CO., LTD., Seoul (KR)

(72) Inventor: Kyu Jin KIM, Seoul (KR)

(21) Appl. No.: 19/153,561

(22) PCT Filed: Feb. 2, 2024
(86) PCT No.: PCT/KR2024/001622

§ 371 Date: Aug. 4, 2025

(30) Foreign Application Priority Data
Feb. 2, 2023 (KR) 10-2023-0014502
Feb. 15, 2023 (KR) 10-2023-0020353

(51) Int. Cl. G02B 13/00; G02B 1/04; G02B 3/00; G02B 7/02; G02B 9/62; G03B 30/00

(52) U.S. Cl. CPC G02B 13/0045; G02B 1/041; G02B 7/028; G02B 9/62; G02B 2003/0093; G03B 30/00

(57) ABSTRACT

An optical system according to one embodiment of the present disclosure comprises first to sixth lenses disposed along an optical axis, wherein the first lens has a negative (−) refractive power, the second lens has a positive (+) refractive power, the third lens has a positive (+) refractive power, the fourth lens has a negative (−) refractive power, the fifth lens has a positive (+) refractive power, the sixth lens has a negative (−) refractive power, an aperture is disposed between the second lens and the third lens, and the distance between the first lens and the second lens is the largest of the distances between adjacent lenses on the optical axis.

### TECHNICAL FIELD

The present embodiment relates to an optical system having improved optical performance and a camera module including the same.

### BACKGROUND ART

ADAS (Advanced Driving Assistance System) is an advanced driver assistance system that assists the driver in driving and includes configurations that senses the situation ahead, determines the situation based on the sensed results, and controls the behavior of the vehicle based on the situation determination. For example, the ADAS sensor device detects the vehicle ahead and recognizes the lane. Afterwards, when the target lane, target speed, and target ahead are determined, the vehicle's ESC (Electrical Stability Control), EMS (Engine Management System), MDPS (Motor Driven Power Steering), or the like are controlled. Representative examples of ADAS may include automatic parking systems, low-speed city driving assistance systems, and blind spot warning systems.

Sensor devices for detecting the situation ahead in ADAS include GPS sensors, laser scanners, front radars, and Lidar, and the most representative one is a camera for photographing the front, rear, and side of the vehicle.

These cameras can be placed outside or inside the vehicle to detect the surroundings of the vehicle. In addition, the cameras can be placed inside the vehicle to detect the situations of the driver and passengers. For example, the camera can photograph the driver at a location adjacent to the driver and detect the driver's health status, whether he or she is drowsy, whether he or she is drinking, or the like. In addition, the camera can photograph the passenger at a location adjacent to the passenger and detect the passenger's sleep status, health status, or the like, and provide the driver with information about the passenger.

In particular, the most important element for obtaining an image from a camera is the imaging lens that forms the image. Recently, interest in high-definition and high-resolution, or the like, has been increasing, and research on an optical system including a plurality of lenses is being conducted to implement this. However, there is a problem that the characteristics of the optical system change when the camera is exposed to a harsh environment, such as high temperature, low temperature, moisture, or high humidity, outside or inside the vehicle. In this case, the camera has a problem that it is difficult to uniformly derive excellent optical characteristics and aberration characteristics.

In addition, since the vehicle camera module is exposed to the outside, the photographing quality may deteriorate due to moisture and temperature. In particular, the camera module has a problem in that the optical characteristics change according to the ambient temperature and the material of the lens.

Therefore, a new optical system and camera that can solve the above-mentioned problems are required.

### DISCLOSURE

### Technical Problem

An object of the present embodiment is to provide an optical system and a camera module with improved optical characteristics.

In addition, an object of the present embodiment is to provide an optical system and a camera module that can provide excellent optical characteristics in a low-temperature or high-temperature environment.

In addition, an object of the present embodiment is to provide an optical system and a camera module that can prevent or minimize changes in optical characteristics in various temperature ranges.

In addition, the present embodiment can provide a camera system that can predict and compensate for changes in the focal length of a lens within a camera module.

In addition, the present embodiment can provide a camera system capable of predicting a temperature change of at least one lens within a camera module and adjusting an optical axis distance.

In addition, the present embodiment can provide a control system for controlling a camera module applied to a device or structure subject to a large temperature change.

### Technical Solution

In order to solve the above technical problem, an optical system according to the first embodiment of the present disclosure includes a first lens having positive (+) refractive power; a second lens; and a third lens having negative (−) refractive power, in which the first to third lenses may be sequentially arranged from an object-side to an image side, an aperture may be arranged between the first lens and the second lens, and a thickness of the second lens on the optical axis may be greater than a thickness of the third lens.

In order to solve the above technical problem, the optical system according to the first embodiment includes a first lens having positive (+) refractive power; a second lens; and a third lens having negative (−) refractive power, in which the first to third lenses may be sequentially arranged from the object-side to the image side and an aperture may be arranged between the first lens and the second lens, and at least two of the first to third lenses may have refractive indices of 1.6 or more.

A distance between the first to second lenses on the optical axis may be greater than a thickness of the third lens.

A difference in Abbe's numbers of at least two of the first to third lenses may be 0 or more and 10 or less.

A difference in refractive indices of at least two of the first to third lenses may be 0 or more and 0.1 or less.

The refractive indices of at least two of the first to third lenses may be the same.

The absolute value of the radius of curvature of the object-side surface of the first lens may be smaller than the absolute value of the radius of curvature of the sensor-side of the first lens.

The absolute value of the radius of curvature of the object-side surface of the third lens may be larger than the absolute value of the radius of curvature of the sensor-side surface of the third lens.

The following conditional expression may be satisfied. <Conditional expression>3<f<4 (In the above conditional expression, f means the total focal length of the optical system.)

The following conditional expression may be satisfied. <Conditional expression>1.8<Fno<2.2 (In the above conditional expression, Fno means the F-number of the optical system.)

The following conditional expression may be satisfied. <Conditional expression>1.6<n1 <1.7 (In the above conditional expression, n1 means the refractive index of the first lens.)

The following conditional expression may be satisfied. <Conditional expression>20<v1 <30 (In the above conditional expression, v1 means the Abbe's number of the first lens.)

The following conditional expression can be satisfied. <Conditional expression>0.5<f1/f2<1 (In the above conditional expression, f1 is the focal length of the first lens, and f2 is the focal length of the second lens.)

The following conditional expression can be satisfied. <Conditional expression>5<TTL <6 (In the above conditional expression, TTL is the optical axis distance from the object-side of the first lens to the image sensor.)

The second lens may have positive (+) refractive power.

In order to solve the above technical problem, an optical system according to another embodiment of the present disclosure includes first to sixth lenses arranged along an optical axis, in which the first lens may have negative (−) refractive power, the second lens may have positive (+) refractive power, the third lens may have positive (+) refractive power, the fourth lens may have negative (−) refractive power, the fifth lens may have positive (+) refractive power, the sixth lens may have negative (−) refractive power, an aperture may be arranged between the second lens and the third lens, and, among the distances between adjacent lenses on the optical axis, the distance between the first lens and the second lens may be the greatest.

At least one of the first lens and the third lens may be made of glass, and at least one of the second lens, the fourth lens, and the fifth lens may be made of plastic.

The thickness of the second lens among the first to sixth lenses on the optical axis may be the greatest.

The second lens may have a meniscus shape convex toward the sensor.

The fifth lens may have convex surfaces on both sides.

The sixth lens may have a meniscus shape convex toward the sensor.

The following conditional expression may be satisfied. <Conditional expression>10<TTL <15 (In the above conditional expression, TTL means the distance from the object-side of the first lens to the upper surface of the image sensor on the optical axis.).

The following conditional expression may be satisfied. <Conditional expression>0.3<ΣCT/TTL <0.8 (In the above conditional expression, ΣCT means the sum of the central thicknesses of the first to sixth lenses, and TTL means the distance from the object-side of the first lens to the upper surface of the image sensor on the optical axis.).

The following conditional expression may be satisfied. <Conditional expression>0.5<CA_L1/CA_L6<1.5 (In the above conditional expression, CA_L1 means the clear aperture of the first lens, and CA_L6 means the clear aperture of the sixth lens.).

In order to solve the above technical problem, an optical system according to the first embodiment includes first to sixth lenses arranged along an optical axis, in which the second lens may have positive (+) refractive power, the fourth lens may have negative (−) refractive power, the fifth lens may have positive (+) refractive power, the sixth lens may have negative (−) refractive power, the second lens may have the largest thickness among the first to sixth lenses on the optical axis, the fifth lens has a convex shape on both sides, and the sixth lens may have a meniscus shape convex toward the sensor-side.

Among the first to sixth lenses, the clear aperture of the first lens may be the largest, and among the first to sixth lenses, the clear aperture of the third lens may be the smallest.

Among the distances between adjacent lenses on the optical axis, the distance between the third lens and the fourth lens may be the smallest.

The distance between the second lens and the third lens on the optical axis may be smaller than the distance between the fifth lens and the sixth lens.

The following conditional expression may be satisfied. <Conditional expression>1.5<TTL/ImgH <2.5 (In the above conditional expression, TTL means the distance on the optical axis from the object-side of the first lens to the upper surface of the image sensor, and ImgH means ½ of the maximum diagonal length of the image sensor on the optical axis.)

The following conditional expression may be satisfied. <Conditional expression>1<ΣCT/ΣCG <2.5 (In the above conditional expression, ΣCT means the sum of the central thicknesses of the first to sixth lenses on the optical axis, and ΣCG means the sum of the distances between adjacent lenses on the optical axis.)

### Advantageous Effect

The optical system and camera module according to the embodiment can have improved optical characteristics. Specifically, in the optical system according to the embodiment, a plurality of lenses can have set thicknesses, refractive powers, and distances with adjacent lenses. Accordingly, the optical system and camera module according to the embodiment can have improved MTF characteristics, aberration control characteristics, resolution characteristics, or the like in a set field of view range, and may have good optical performance in the periphery of the field of view.

In addition, the optical system and camera module according to the embodiment may have good optical performance in a low temperature to high temperature temperature range (−40 °C to 105 °C). Specifically, a plurality of lenses included in the optical system can have set materials, refractive powers, and refractive indices. Accordingly, when the refractive index of each lens changes according to a temperature change, and the focal length of each lens changes due to this, the plastic lens and the glass lens can mutually compensate for each other. In other words, the optical system can effectively perform distribution of refractive power in a low temperature to high temperature temperature range, and can prevent or minimize changes in optical characteristics in a low temperature to high temperature temperature range. Accordingly, the optical system and camera module according to the embodiment can maintain improved optical characteristics over a variety of temperature ranges.

In addition, the optical system and camera module according to the embodiment can satisfy the set field of view by mixing plastic lenses and glass lenses and can implement excellent optical characteristics. As a result, the optical system can provide a slimmer vehicle camera module. Therefore, the optical system and camera module can be provided to various applications and devices, and can have excellent optical characteristics even in harsh temperature environments, such as when exposed to the outside of a vehicle or inside a vehicle at high temperatures in the summer.

In addition, the BFL (Back focal length) change in the camera module can be compensated for. In addition, at least one lens can be moved on the optical axis direction according to temperature change, thereby minimizing performance change. In addition, the ambient temperature information of the camera module can be detected from an internal or external device of the vehicle, and the distance between at least one lens and the sensor can be adjusted within a predictable range for each temperature. Accordingly, the performance change according to the temperature of the camera module can be minimized.

### DESCRIPTION OF DRAWINGS

FIG. 1 is a plan view of a vehicle to which a camera module or optical system according to the first embodiment is applied.

FIG. 2 and FIG. 3 are drawings illustrating the interior of a vehicle to which a camera module or optical system according to the first embodiment is applied.

FIG. 4 is a configuration diagram of an optical system according to the first embodiment.

FIG. 5 is a graph of diffraction MTF characteristics of an optical system in a low temperature (−40 °C) environment.

FIG. 6 is a graph of diffraction MTF characteristics of an optical system compensated for peak reference according to actuator operation in a low temperature (−40 °C) environment.

FIG. 7 is a graph of aberrations of an optical system in a low temperature (−40 °C) environment.

FIG. 8 is a graph of diffraction MTF characteristics of an optical system in a room temperature (20 °C) environment.

FIG. 9 is a graph of the diffraction MTF characteristics of the optical system with the peak reference compensated according to the actuator drive in a room temperature (20 °C) environment.

FIG. 10 is a graph of the aberration diagram of the optical system in a room temperature (20 °C) environment.

FIG. 11 is a graph of the diffraction MTF characteristics of the optical system in a high temperature (85 °C) environment.

FIG. 12 is a graph of the diffraction MTF characteristics of the optical system with the peak reference compensated according to the actuator drive in a high temperature (85 °C) environment.

FIG. 13 is a graph of the aberration diagram of the optical system in a high temperature (85 °C) environment.

FIG. 14 is a side cross-sectional view of the optical system according to the second embodiment and the camera module having the same.

FIG. 15 is a table illustrating the aspherical coefficients of the lenses in the optical system of FIG. 14.

FIG. 16 is a table illustrating the thickness of each lens of the optical system of FIG. 14 and the distance between adjacent lenses.

FIG. 17 is a table illustrating the Sag values of the lens surfaces of the first to sixth lenses of the optical system of FIG. 14.

FIG. 18 is a graph illustrating data on the diffraction MTF (Modulation Transfer Function) of the optical system of FIG. 14 at low temperatures.

FIG. 19 is a graph illustrating data on the aberration characteristics of the optical system of FIG. 14 at low temperatures.

FIG. 20 is a graph illustrating data on the diffraction MTF of the optical system of FIG. 14 at room temperature.

FIG. 21 is a graph illustrating data on the aberration characteristics of the optical system of FIG. 14 at room temperature.

FIG. 22 is a graph illustrating data on the diffraction MTF of the optical system of FIG. 14 at high temperature.

FIG. 23 is a graph illustrating data on the aberration characteristics of the optical system of FIG. 14 at high temperature.

FIG. 24 is a graph illustrating data on the diffraction MTF of the optical system of FIG. 14 at RGB wavelength.

FIG. 25 is a graph illustrating data on the diffraction MTF of the optical system of FIG. 14 at IR wavelength.

FIG. 26 is a cross-sectional side view of an optical system according to the third embodiment and a camera module having the same.

FIG. 27 is a table illustrating aspherical coefficients of lenses in the optical system of FIG. 26.

FIG. 28 is a table illustrating the thickness of each lens and the distance between adjacent lenses in the optical system of FIG. 26.

FIG. 29 is a table illustrating the Sag values of the lens surfaces of the first to sixth lenses in the optical system of FIG. 26.

FIG. 30 is a graph illustrating data on the diffraction MTF (Modulation Transfer Function) at low temperatures of the optical system of FIG. 26.

FIG. 31 is a graph illustrating data on the aberration characteristics of the optical system of FIG. 26 at low temperatures.

FIG. 32 is a graph illustrating data on the diffraction MTF of the optical system of FIG. 26 at room temperature.

FIG. 33 is a graph illustrating data on the aberration characteristics of the optical system of FIG. 26 at room temperature.

FIG. 34 is a graph illustrating data on the diffraction MTF of the optical system of FIG. 26 at high temperatures.

FIG. 35 is a graph illustrating data on the aberration characteristics of the optical system of FIG. 26 at high temperatures.

FIG. 36 is a graph illustrating data on the diffraction MTF of the optical system of FIG. 26 at RGB wavelengths.

FIG. 37 is a graph illustrating data on the diffraction MTF of the optical system of FIG. 26 at IR wavelengths.

FIG. 38 is a cross-sectional side view of an optical system according to the fourth embodiment and a camera module having the same.

FIG. 39 is a table illustrating aspherical coefficients of lenses in the optical system of FIG. 38.

FIG. 40 is a table illustrating the thickness of each lens of the optical system of FIG. 38 and the distance between adjacent lenses.

FIG. 41 is a table illustrating the Sag values of the lens surfaces of the first to sixth lenses in the optical system of FIG. 38.

FIG. 42 is a graph illustrating data on the diffraction MTF (Modulation Transfer Function) of the optical system of FIG. 38 at low temperatures.

FIG. 43 is a graph illustrating data on the aberration characteristics of the optical system of FIG. 38 at low temperatures.

FIG. 44 is a graph illustrating data on the diffraction MTF of the optical system of FIG. 38 at room temperature.

FIG. 45 is a graph illustrating data on the aberration characteristics of the optical system of FIG. 38 at room temperature.

FIG. 46 is a graph illustrating data on the diffraction MTF of the optical system of FIG. 38 at high temperatures.

FIG. 47 is a graph illustrating data on the aberration characteristics of the optical system of FIG. 38 at high temperatures.

FIG. 48 is a graph illustrating data on the diffraction MTF of the optical system of FIG. 38 at RGB wavelengths.

FIG. 49 is a graph illustrating data on the diffraction MTF at the IR wavelength of the optical system of FIG. 38.

FIG. 50 is a diagram illustrating the camera system of the present embodiment.

FIGS. 51 (A) and (B) are drawings explaining the change in the focal length of the lens according to the temperature in the camera module.

FIG. 52 is a cross-sectional side view illustrating an example of a camera module in the camera system of the present embodiment.

FIG. 53 is a table illustrating the lens correction rate according to the temperature stored in the storage of the camera system of the present embodiment.

FIG. 54 is a graph illustrating the lens correction rate according to the temperature in the camera system of the present embodiment.

FIG. 55 is a view illustrating a table illustrating the temperature compensation rate according to the reference BFL stored in the storage of the camera system of the present embodiment.

FIG. 56 is a graph illustrating the focal length correction method according to the temperature in the camera system of the present embodiment.

FIG. 57 is a configuration diagram for explaining some terms in the optical system according to the present embodiment.

### BEST MODE

Hereinafter, preferred embodiments of the present disclosure will be described in detail with reference to the attached drawings.

However, the technical idea of the present disclosure is not limited to some of the embodiments described, but can be implemented in various different forms, and within the scope of the technical idea of the present disclosure, one or more of the components between the embodiments can be selectively combined or substituted and used.

In addition, terms (including technical and scientific terms) used in the first embodiment can be interpreted as meanings that can be generally understood by a person having ordinary knowledge in the technical field to which the first embodiment belongs, unless explicitly and specifically defined and described, and terms that are commonly used, such as terms defined in a dictionary, can be interpreted in consideration of the contextual meaning of the related technology.

In addition, terms used in the first embodiment are used to describe the embodiments and are not intended to limit the present disclosure.

In this specification, the singular may also include the plural unless specifically stated otherwise in the phrase, and when it is described as “at least one (or one or more) of A, B, C”, it may include one or more of all combinations that can be combined with A, B, C.

In addition, in describing components of the first embodiment, terms such as first, second, A, B, (a), (b), or the like may be used. These terms are only intended to distinguish the components from other components, and are not intended to limit the nature, order, or sequence of the components.

In addition, when a component is described as being ‘connected’, ‘coupled’, or ‘accessed’ to another component, it may include not only cases where the component is ‘connected’, ‘coupled’, or ‘accessed’ directly to the other component, but also cases where the component is ‘connected’, ‘coupled’, or ‘accessed’ by another component between the component and the other component.

In addition, when described as being formed or arranged “above” or “below” each component, “above” or “below” includes not only the case where the two components are in direct contact with each other, but also the case where one or more other components are formed or arranged between the two components. In addition, when expressed as “above” or “below”, the meaning of the downward direction as well as the upward direction based on one component may be included.

In addition, the convex surface of the lens may mean that the lens surface on the optical axis area has a convex shape, and the concave surface of the lens may mean that the lens surface on the optical axis area has a concave shape.

In addition, the “object-side” may mean the surface of the lens facing the object-side based on the optical axis, and the “sensor-side” may mean the surface of the lens facing the image sensor based on the optical axis. The “object-side” may be the “material-side”. The “sensor-side” may be the “image-side”.

In addition, the vertical direction may mean the direction perpendicular to the optical axis, and the end of the lens or lens surface may mean the extreme end of the effective area of the lens through which the incident light passes.

In addition, the center thickness of the lens may mean the length in the direction of the optical axis between the object-side and the sensor-side from the optical axis of the lens.

In addition, the size of the clear aperture of the lens surface may have a measurement error of up to ±0.4 mm according to the measurement method, or the like.

In addition, in the embodiment, low temperature may mean a specific temperature (−40 °C) or a temperature range of about −40 °C to about 30 °C, and room temperature may mean a specific temperature (20 °C) or a temperature range of about 18 °C to about 30 °C. In addition, high temperature may mean a specific temperature (85 °C) or a temperature range of about 80 °C to about 105 °C.

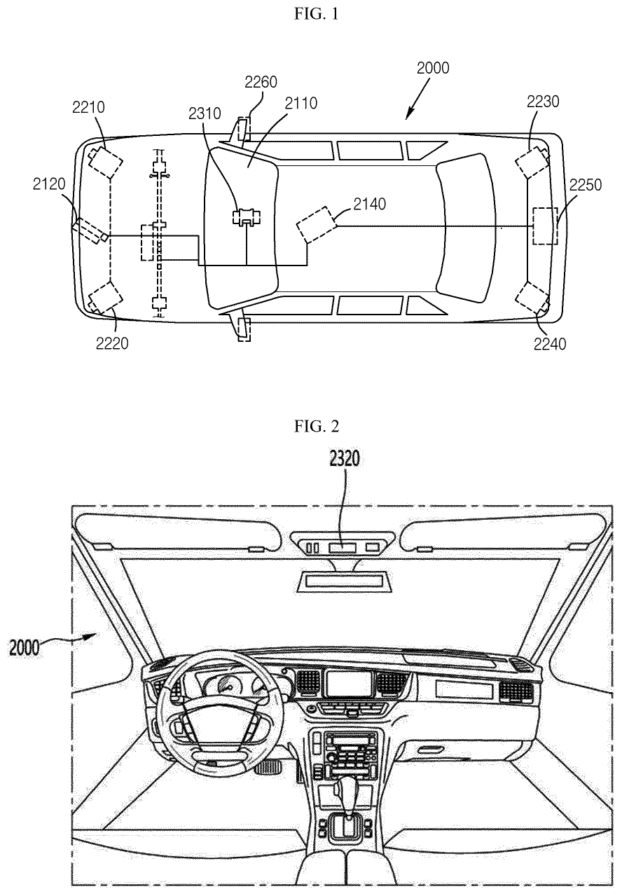

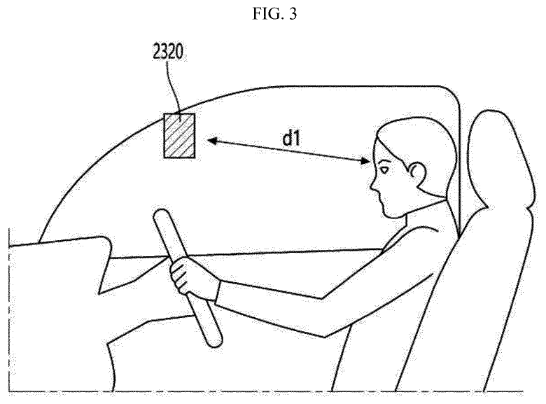

FIG. 1 is a plan view of a vehicle to which a camera module or optical system according to the first embodiment is applied, and FIG. 2 and FIG. 3 are drawings illustrating the interior of a vehicle to which a camera module or optical system according to the first embodiment is applied.

First, referring to FIG. 1, the vehicle camera system according to the first embodiment of the present disclosure includes an image generation part 2110, a first information generation part 2120, a second information generation part 2210, 2220, 2230, 2240, 2250, 2260, and a control part 2140.

The image generation part 2110 may include at least one first camera module 2310 disposed outside or inside the vehicle 2000, and may generate a front image of the vehicle 2000. In addition, the image generation part 2110 may capture not only the front of the vehicle 2000 but also the surroundings of the vehicle 2000 in one or more directions using the first camera module 2310 to generate an image of the surroundings of the vehicle 2000. Here, the front image and the surrounding images may be digital images, and may include color images, black and white images, infrared images, or the like. Additionally, the front image and surrounding image may include still images and moving images. The image generation part 2110 may provide the front image and surrounding image to the control part 2140.

Next, the first information generation part 2120 may include at least one radar and/or camera placed in the vehicle 2000, and detects the front of the vehicle 2000 to generate first detection information. Specifically, the first information generation part 2120 may be placed in the vehicle 2000 and detect the position and speed of the vehicles (2000) located in front of the vehicle 2000, whether there is a pedestrian, and the position of the pedestrian, or the like to generate first detection information.

Using the first detection information generated by the first information generation part 2120, the distance between the vehicle 2000 and the vehicle in front may be controlled to be maintained at a constant level, and the driving stability of the vehicle 2000 may be improved in specific cases set in advance, such as when the driver wants to change the driving lane of the vehicle 2000 or when parking in reverse. The first information generation part 2120 may provide the first detection information to the control part 2140.

Next, the second information generation part 2210, 2220, 2230, 2240, 2250, 2260 detects each side of the vehicle 2000 and generates second detection information based on the front image generated by the image generation part 2110 and the first detection information generated by the first information generation part 2120. Specifically, the second information generation part 2210, 2220, 2230, 2240, 2250, 2260 may include at least one radar and/or camera disposed in the vehicle 2000, and may detect the position and speed of vehicles located on the side of the vehicle 2000 or capture images. Here, the second information generation parts 2210, 2220, 2230, 2240, 2250, 2260 may be respectively positioned at the front two corners, side mirrors, and the rear center and rear two corners of the vehicle 2000.

In addition, referring to FIGS. 2 and 3, the image generation part 2110 may include at least one second camera module 2320 positioned inside the vehicle 2000. The second camera module 2320 may be positioned adjacent to the driver and passengers. For example, the second camera module 2320 may be positioned at a first distance d1 away from the driver and passengers to generate an interior image of the vehicle 2000. At this time, the first distance d1 may be about 500 mm or more. In detail, the first distance d1 may be about 600 mm or more. In addition, the second camera module 2320 may have a field of view (FOV) of about 55 degrees or more.

The image generation part 2110 may capture a driver and/or passenger inside the vehicle 2000 using the second camera module 2320 to generate an interior image of the vehicle 2000. Here, the interior image of the vehicle may be a digital image, and may include a color image, a black and white image, an infrared image, or the like. In addition, the interior image may include a still image and a moving image. The image generation part 2110 provides the interior image of the vehicle 2000 to the control part 2140.

The control part 2140 can provide information to the passengers of the vehicle 2000 based on the information provided from the image generation part 2110. For example, the control part 2140 can detect the driver's health status, whether he or she is drowsy, whether he or she is drinking, or the like based on the information provided from the image generation part 2110, and can provide the driver with corresponding information such as guidance and warnings. In addition, the control part 2140 can detect the passenger's sleep status, health status, or the like based on the information provided from the image generation part 2110, and can provide the driver and/or the passenger with information about this.

This vehicle camera system can include a camera module having an optical system 1000 according to the first embodiment below, and can provide or process information obtained through the front, rear, each side, or corner area of the vehicle 2000 to the user to protect the vehicle 2000 and objects from autonomous driving or surrounding safety. In addition, the vehicle camera system can be placed inside the vehicle 2000 to provide various information to the driver and passengers. In other words, at least one of the first camera module 2310 and the second camera module 2320 may include an optical system 1000 to be described later.

A plurality of optical systems of the camera module according to the first embodiment may be installed in a vehicle for safety regulation, reinforcement of autonomous driving function, and increased convenience. In addition, the optical system of the camera module is applied in a vehicle as a component for control such as a lane keeping assistance system (LKAS), a lane departure warning system (LDWS), and a driver monitoring system (DMS). Such a vehicle camera module may implement stable optical performance even under ambient temperature changes and may provide a module with price competitiveness, thereby securing the reliability of vehicle components.

The optical system according to the first embodiment will be described in detail below. The optical system 1000 according to the first embodiment may include a plurality of lenses 101 and an image sensor 600. In detail, the optical system 1000 according to the first embodiment may include two or more lenses. For example, the optical system 1000 may include three lenses, and may include a first lens 101, a second lens 102, a third lens 103, and an image sensor 600 that are sequentially arranged from the object-side to the sensor-side. The first to third lenses 101-103 may be sequentially arranged along the optical axis OA of the optical system 1000.

In this case, light corresponding to the information of the object may pass through the first lens 101, the second lens 102, and the third lens 103 and be incident on the image sensor 600.

Each of the plurality of lenses 101-103 may include an effective area and an ineffective area. The effective area may be an area through which light incident on each of the first to third lenses 101-103 passes. In other words, the effective area may be an area in which the incident light is refracted and implements optical characteristics. The effective area may be a clear aperture area.

The ineffective area may be arranged around the effective area. The ineffective area may be an area in which light is not incident. In other words, the ineffective area may be an area unrelated to the optical characteristics. In addition, the ineffective area may be an area fixed to a barrel (not illustrated) that accommodates the lens. The ineffective area may be an non-clear aperture area.

The image sensor 600 may detect light. In detail, the image sensor 600 can detect light that has passed through a plurality of lenses, specifically the first to third lenses 101-103 sequentially. The image sensor 600 can include a device capable of detecting incident light, such as a CCD (Charge Coupled Device) or a CMOS (Complementary Metal Oxide Semiconductor).

The image sensor 600 may include a plurality of pixels having a set size. For example, the pixel size of the image sensor 600 can be about 3 m. The image sensor 600 may detect light of a set wavelength. For example, the image sensor 600 can detect infrared (IR; Infrared Ray) light. In detail, the image sensor 600 can detect near infrared ray light of about 1500 nm or less. For example, the image sensor can detect light in a wavelength band of about 880 nm to about 1000 nm.

The optical system 1000 according to the first embodiment may further include a cover glass 400 and a filter 500.

The cover glass 400 may be placed between a plurality of lenses 101-103 and the image sensor 600. The cover glass 400 may be placed adjacent to the image sensor 600. The cover glass 400 may have a shape corresponding to the image sensor 600. The cover glass 400 may be provided in a size larger than or equal to the image sensor 600 to protect the upper part of the image sensor 600.

In addition, the filter 500 may be placed between the plurality of lenses 101-103 and the image sensor 600. The filter 500 may be placed between the last lens (the third lens 103) that is closest to the image sensor 600 among the plurality of lenses 101-103 and the image sensor 600. In detail, the filter 500 may be placed between the last lens (the third lens 103) and the cover glass 400.

The filter 500 may pass light of a set wavelength band and filter light of a different wavelength band. The filter 500 may pass light of a wavelength band corresponding to light received by the image sensor 600 and block light of a wavelength band that does not correspond to light received. In detail, the filter 500 may pass light of an infrared wavelength band and block light of an ultraviolet ray and a visible light band. For example, the filter 500 may include at least one of an IR Pass filter and an IR Cutoff filter.

The optical system 1000 according to the first embodiment may include an aperture STOP. The aperture STOP may be arranged between the first lens 101 and the second lens 102. The aperture STOP may be arranged closer to the first lens 101 than to the second lens 102. The aperture STOP may be spaced apart from the object-side of the second lens 102. The aperture STOP may control the amount of light incident from a subject. The aperture STOP may control the amount of light passing through the first lens 101. The aperture STOP may control the amount of light incident to the third lens 103. The aperture STOP may include an aperture stop.

Hereinafter, with reference to Table 1, a plurality of lenses according to the first embodiment will be described in more detail.

TABLE 1

| | | Radius of | Thickness | | | Clear |
|---|---|---|---|---|---|---|
| | | Curvature | or Distance | Refractive | Abbe's | aperture |
| Lens | Surface | (mm) | (mm) | index | number | Size |
| First | First | 2.422 | 1.150 | 1.6400 | 23.5000 | 2.288 |
| Lens | Surface(S1) | | | | | |
| | Second | −11.024 | 0.010 | | | 1.680 |
| | Surface(S2) | | | | | |
| STOP | — | infinity | 0.726 | | | 1.560 |
| Second | Third | −1.487 | 1.000 | 1.6400 | 23.5000 | 1.810 |
| Lens | Surface(S3) | | | | | |
| | Fourth | −1.114 | 0.050 | | | 2.475 |
| | Surface(S4) | | | | | |
| Third | Fifth | 7.644 | 0.800 | 1.6400 | 23.5000 | 3.124 |
| Lens | surface(S5) | | | | | |
| | Sixth | 1.526 | 0.171 | | | 3.859 |
| | surface(S6) | | | | | |
| Filter | | infinity | 0.300 | | | 3.955 |
| | | infinity | 0.600 | | | 4.058 |
| Cover | | infinity | 0.400 | | | 4.375 |
| Glass | | | | | | |
| Image | | infinity | 0.051 | | | 4.539 |
| Sensor | | | | | | |

Table 1 illustrates the radius of curvature of the first to third lenses 101-103 according to the first embodiment, the thickness of each lens on the optical axis OA, the distance between each lens on the optical axis OA, the refractive index for light in the d-line (587.562 mm) wavelength band, the Abbe's number, and the size of the clear aperture (CA). Here, the lens data described in Table 1 is data at room temperature (approximately 20 °C).

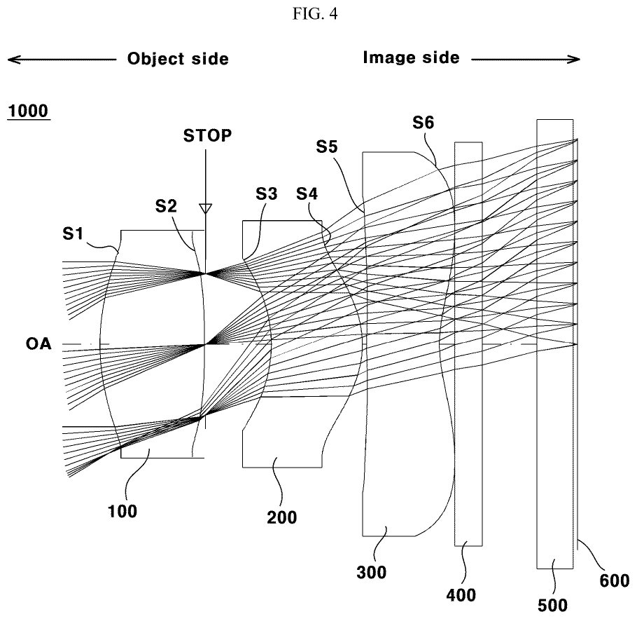

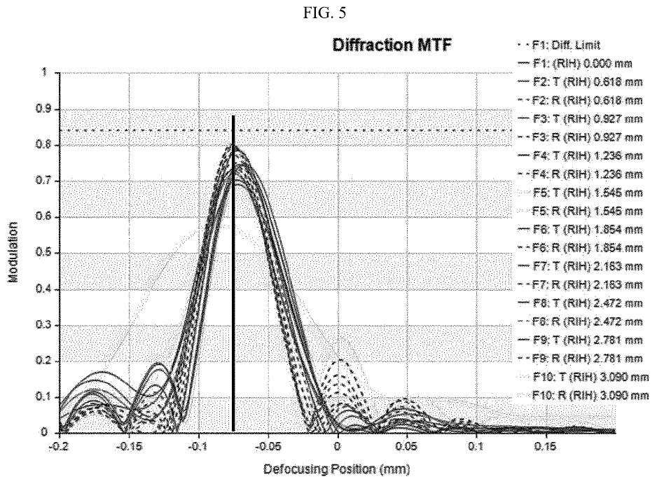

Referring to FIG. 4 and Table 1, the first lens 101 of the optical system 1000 according to the first embodiment may be made of plastic and may have positive (+) refractive power on the optical axis OA.

The first surface S1 on the object-side of the first lens 101 on the optical axis OA may have a convex shape, and the second surface S2 on the sensor-side may have a convex shape. The first lens 101 may have a convex shape on both sides on the optical axis OA. At least one surface among the first surface S1 and the second surface S2 may be an asphere. For example, both the first surface S1 and the second surface S2 may be aspheres.

The second lens 102 may have positive (+) or negative (−) refractive power on the optical axis OA. The second lens 102 may have positive (+) refractive power on the optical axis OA. The second lens 102 may be made of a plastic material.

The object-side third surface S3 of the second lens 102 on the optical axis OA may have a concave shape, and the sensor-side fourth surface S4 may have a convex shape. The second lens 102 may have a concave meniscus shape on the object-side on the optical axis OA. The second lens 102 may have a convex meniscus shape on the sensor-side on the optical axis OA. At least one of the third surface S3 and the fourth surface S4 may be an asphere. For example, both the third surface S3 and the fourth surface S4 may be aspheres.

The third lens 103 may have positive (+) or negative (−) refractive power on the optical axis OA. The third lens 103 may have negative (−) refractive power on the optical axis OA. The third lens 103 may be made of a plastic material.

The fifth surface S5 on the object-side of the third lens 103 on the optical axis OA may have a convex shape, and the sixth surface S6 may be concave. The third lens 103 may have a meniscus shape convex toward the object-side on the optical axis OA. In contrast, the fifth surface S5 may have a convex shape on the optical axis OA, and the sixth surface S6 may be convex on the optical axis OA. In other words, the third lens 103 may have a biconvex shape on the optical axis OA. In contrast, the fifth surface S5 may have a concave shape on the optical axis OA, and the sixth surface S6 may be convex on the optical axis OA. In other words, the third lens 103 may have a meniscus shape that is convex toward the sensor on the optical axis OA. In contrast, the fifth surface S5 may have a concave shape on the optical axis OA, and the sixth surface S6 may be concave on the optical axis OA. In other words, the third lens 103 may have a shape in which both sides are concave on the optical axis OA.

At least one surface among the fifth surface S5 and the sixth surface S6 may be an asphere. For example, both the fifth surface S5 and the sixth surface S6 may be aspheres. The fifth surface S5 may include at least one inflection point. The fifth surface S5 may include at least one inflection point in the flange region, which is an area other than the clear aperture area. The sixth surface S6 may include at least one inflection point. The sixth surface S6 may include at least one inflection point within the clear aperture area.

At least two lenses among the first to third lenses 101-103 may have refractive indices of 1.6 or more. At least two lenses among the first to third lenses 101-103 may have the same refractive indices. The difference in refractive indices between at least two lenses among the first to third lenses 101-103 may be 0.1 or less. At least two lenses among the first to third lenses 101-103 may be high-refractive lenses. When the lenses are made of a plastic material, the refractive indices of the lenses may be 1.6 or more and 1.7 or less. For example, the refractive indices of the first to third lenses 101-103 may all be the same. Through this, when at least two lenses or three lenses among the first to third lenses 101-103 have the same refractive index, vehicle optical performance can be secured, and the lens can be lightweight and easy to manufacture with the plastic lens.

The Abbe's numbers of at least two lenses among the first to third lenses 101-103 may be 20 or more and 30 or less. The difference between the Abbe's numbers of at least two lenses among the first to third lenses 101-103 may be 0 or more and 10 or less. The Abbe's numbers of at least two lenses among the first to third lenses 101-103 may be the same. For example, the Abbe's numbers of the first to third lenses 101-103 may all be the same. Accordingly, when the Abbe's numbers of at least two lenses or three lenses among the first to third lenses 101-103 are the same, vehicle optical performance can be secured, and the plastic lens can be lightweight and easy to manufacture.

Table 2 below illustrates Sag data according to the vertical height (0.2 mm distance) of the optical axis OA of each of the object-side (first surface S1) and the sensor-side (second surface S2) of the first lens 101 at room temperature (approximately 20 °C).

In addition, Table 3 illustrates data on lens thickness according to the vertical height (0.2 mm distance) of the optical axis OA at room temperature (approximately 20 °C). In detail, D_1 of Table 3 is the center thickness of the first lens 101, which is the thickness (mm) at the optical axis OA of the first lens 101. In addition, D_1_ET of Table 3 means the thickness (mm) on the optical axis OA direction at the end of the effective area of the first lens 101. In detail, it refers to the distance (mm) in the direction of the optical axis OA between the end of the effective area of the object-side (the first surface S1) of the first lens 101 and the end of the effective area of the sensor-side (the second surface S2) of the first lens 101.

TABLE 2

| Vertical height of | | Vertical height of | |
|---|---|---|---|
| optical axis from | Sag on | optical axis from | Sag on |
| optical axis on | object-side | optical axis on | sensor-side |
| object-side of | of first | sensor-side of | of first |
| first lens (mm) | lens (mm) | first lens (mm) | lens (mm) |
| 0 | 0 | 0 | 0 |
| 0.2 | 0.008249 | 0.2 | −0.001881 |
| 0.4 | 0.032860 | 0.4 | −0.008381 |
| 0.6 | 0.073236 | 0.6 | −0.022371 |
| 0.8 | 0.127552 | 0.8 | −0.049386 |
| 1.0 | 0.190200 | — | — |
| 1.2 | 0.243354 | — | — |

TABLE 3

| Vertical height of optical | Thickness along optical | |
|---|---|---|
| axis from optical axis (mm) | axis of first lens (mm) | |
| 0 | 1.15 | (D_1) |
| 0.2 | 1.13987 | |
| 0.4 | 1.10876 | |
| 0.6 | 1.05439 | |
| 0.8 | 0.97306 | |
| 1.0 | 0.86375 | (D_1_ET) |

TABLE 4

| | Slope angle (degree) | Slope angle (degree) |
|---|---|---|
| Vertical height of | of object-side | of sensor-side |
| optical axis from | (first surface S1) | (second surface S2) |
| optical axis (mm) | of first lens | of first lens |
| 0 | 0.0 | 0.0 |
| 0.2 | 4.8 | −1.0 |
| 0.4 | 9.5 | −2.0 |
| 0.6 | 14.3 | −5.0 |
| 0.8 | 18.9 | −10.0 |
| 1.0 | 23.3 | −15.0 |
| 1.2 | 26.9 | — |
| 1.4 | 27.8 | — |

Referring to Table 2 and Table 3, the thickness in the direction of the optical axis OA of the first lens 101 can become thinner as it goes from the optical axis OA to the end of the clear aperture of the first lens 101. In addition, Table 4 illustrates data on the Slope Angle (degree) of the object-side (first surface S1) of the first lens and the sensor-side (second surface S2) of the first lens according to the vertical height (0.2 mm distance) of the optical axis OA at room temperature (approximately 20 °C). The Slope Angle refers to the angle formed by the tangent line touching the lens surface and the line perpendicular to the optical axis OA.

Accordingly, the first lens 101 can have improved aberration control characteristics by controlling the incident light.

The following Table 5 illustrates Sag data according to the vertical height (0.2 mm distance) of the optical axis OA of each of the object-side (third side S3) and the sensor-side (fourth side S4) of the second lens 102 at room temperature (approximately 20 °C).

In addition, Table 6 illustrates data on lens thickness according to the vertical height (0.2 mm distance) of the optical axis OA at room temperature (approximately 20 °C). In detail, D_2 in Table 6 is the center thickness of the second lens 102, which is the thickness (mm) at the optical axis OA of the second lens 102. In addition, D_2_ET in Table 6 means the thickness (mm) on the optical axis OA direction at the end of the effective area of the second lens 102. In detail, it refers to the distance (mm) in the direction of the optical axis OA between the end of the effective area of the object-side (third surface S3) of the second lens 102 and the end of the effective area of the sensor-side (fourth surface S4) of the second lens 102.

TABLE 5

| Vertical height of | | Vertical height of | |
|---|---|---|---|
| optical axis from | | optical axis from | |
| optical axis on | Sag on object- | optical axis on | Sag on sensor- |
| object-side of | side of second | sensor-side of | side of second |
| second lens (mm) | lens (mm) | second lens (mm) | lens (mm) |
| 0 | 0 | 0 | 0 |
| 0.2 | −0.013540 | 0.2 | −0.017990 |
| 0.4 | −0.055287 | 0.4 | −0.071711 |
| 0.6 | −0.127777 | 0.6 | −0.157494 |
| 0.8 | −0.227851 | 0.8 | −0.265603 |
| 1.0 | −0.388666 | 1.0 | −0.374942 |
| — | — | 1.2 | −0.438760 |

TABLE 6

| Vertical height of optical | Thickness along optical |
|---|---|
| axis from optical axis (mm) | axis of second lens (mm) |
| 0 | 1.000(D_2) |
| 0.2 | 0.996 |
| 0.4 | 0.984 |
| 0.6 | 0.970 |
| 0.8 | 0.962 (D_2_ET) |

TABLE 7

| | Slope angle (degree) | Slope angle (degree) |
|---|---|---|
| Vertical height of | of object-side | of sensor-side |
| optical axis from | (third surface S3) | (fourth surface S4) |
| optical axis (mm) | of second lens | of second lens |
| 0 | 0.0 | 0.0 |
| 0.2 | −7.0 | −10.0 |
| 0.4 | −15.0 | −19.0 |
| 0.6 | −23.0 | −26.0 |
| 0.8 | −28.0 | −29.0 |
| 1.0 | — | −25.0 |
| 1.2 | — | −6.0 |

Referring to Table 5 and Table 6, the thickness in the direction of the optical axis OA of the second lens 102 can become thinner as it goes from the optical axis OA to the end of the clear aperture of the second lens 102. In addition, Table 7 illustrates data on the Slope Angle (degree) of the object-side (third surface S3) of the second lens 102 and the sensor-side (fourth surface S4) of the second lens 102 according to the vertical height (0.2 mm distance) of the optical axis OA at room temperature (approximately 20 °C). The Slope Angle refers to the angle formed by the tangent line touching the lens surface and the line perpendicular to the optical axis OA.

Accordingly, the second lens 102 can prevent or minimize changes in optical characteristics according to temperature in a temperature range from low to high temperature.

Table 8 below illustrates Sag data according to the vertical height (0.2 mm distance) of the optical axis OA of each of the object-side (fifth surface S5) and the sensor-side (sixth surface S6) of the third lens 103 at room temperature (approximately 20 °C).

In addition, Table 9 illustrates data on lens thickness according to the vertical height of the optical axis OA at room temperature (approximately 20 °C). In detail, D_3 in Table 9 is the center thickness of the third lens 103, which is the thickness (mm) at the optical axis OA of the third lens 103. In addition, D_3_ET in Table 9 means the thickness (mm) on the optical axis OA direction at the end of the effective area of the third lens 103. In detail, D_3_ET refers to the distance (mm) in the direction of the optical axis OA between the end of the effective area of the object-side (the fifth surface S5) of the third lens 103 and the end of the effective area of the sensor-side (the sixth surface S6) of the third lens 103.

TABLE 8

| Vertical height of | | Vertical height of | |
|---|---|---|---|
| optical axis from | | optical axis from | |
| optical axis on | Sag on object- | optical axis on | Sag on sensor- |
| object-side of | side of third | sensor-side of | side of third |
| third lens (mm) | lens (mm) | third lens (mm) | lens (mm) |
| 0 | 0 | 0 | 0 |
| 0.2 | 0.002211 | 0.2 | 0.012516 |
| 0.4 | 0.005322 | 0.4 | 0.044221 |
| 0.6 | 0.004764 | 0.6 | 0.083653 |
| 0.8 | −0.000091 | 0.8 | 0.121359 |
| 1.0 | −0.008168 | 1.0 | 0.150905 |
| 1.2 | −0.016829 | 1.2 | 0.167098 |
| 1.4 | −0.024887 | 1.4 | 0.164794 |
| 1.6 | −0.041508 | 1.6 | 0.136875 |
| 1.8 | — | 1.8 | 0.069147 |
| 2.0 | — | 2.0 | −0.076172 |

TABLE 9

| Vertical height of optical | Thickness along optical |
|---|---|
| axis from optical axis (mm) | axis of third lens (mm) |
| 0 | 0.800 (D_3) |
| 0.2 | 0.810 |
| 0.4 | 0.839 |
| 0.6 | 0.879 |
| 0.8 | 0.921 |
| 1.0 | 0.959 |
| 1.2 | 0.984 |
| 1.4 | 0.990 (D_3_ET) |

TABLE 10

| | Slope angle (degree) | Slope angle (degree) |
|---|---|---|
| Vertical height of | of object-side | of sensor-side |
| optical axis from | (fifth surface S5) | (sixth surface S6) |
| optical axis (mm) | of third lens | of third lens |
| 0 | 0 | 0 |
| 0.2 | 1.0 | 6.0 |
| 0.4 | 0.0 | 10.0 |
| 0.6 | 0.0 | 11.0 |
| 0.8 | −1.0 | 9.0 |
| 1.0 | −2.0 | 6.0 |
| 1.2 | −2.0 | 2.0 |
| 1.4 | −2.0 | −3.0 |
| 1.6 | −10.0 | −12.0 |
| 1.8 | — | −25.0 |

Referring to Table 8 and Table 9, the thickness in the direction of the optical axis GA of the third lens 103 may become thicker as it goes from the optical axis GA to the end of the clear aperture of the third lens 103. In addition, Table 10 illustrates data on the Slope Angle (degree) of the object-side (the fifth surface S5) of the third lens 103 and the sensor-side (the sixth surface S6) of the third lens 103 according to the vertical height (0.2 mm distance) of the optical axis GA at room temperature (approximately 20 °C). The Slope Angle refers to the angle formed by the tangent line touching the lens surface and the line perpendicular to the optical axis GA.

Accordingly, the third lens 103 can prevent or minimize changes in optical characteristics according to temperature in a temperature range from low to high temperatures.

The values of the aspherical coefficients of each lens surface in the optical system 1000 according to the first embodiment are as illustrated in Table 11 below.

TABLE 11

| | First | Second | Third | Fourth | Fifth | Sixth |
|---|---|---|---|---|---|---|
| | surface | surface | surface | surface | surface | surface |
| | (S1) | (S2) | (S3) | (S4) | (S5) | (S6) |
| Y | 2.4217 | −11.0244 | −1.4870 | −1.1135 | 7.6436 | 1.5255 |
| K | −0.1463 | 75.9915 | 1.1916 | −0.7604 | −90.8230 | −9.0024 |
| A | −0.0131 | −0.0337 | 0.0278 | −0.0057 | −0.2508 | −0.1118 |
| B | −0.0080 | −0.0209 | 0.0180 | 0.2354 | 0.5698 | 0.1013 |
| C | 0.0001 | 0.0337 | −0.0131 | −0.1523 | −0.8632 | −0.0823 |
| D | −0.0033 | −0.0439 | 0.7017 | −0.2975 | 0.8830 | 0.0469 |
| E | | 0.0252 | −1.0732 | 0.7458 | −0.6038 | −0.0183 |
| F | | 0.0000 | 0.5648 | −0.6472 | 0.2725 | 0.0048 |
| G | | | | 2.61E−01 | −7.82E−02 | −8.20E−04 |
| H | | | | −4.12E−02 | 1.30E−02 | 8.42E−05 |
| J | | | | | −9.47E−04 | −4.00E−06 |

In addition, the distance (first distance) between the first lens 101 and the second lens 102 in the optical system 1000 according to the first embodiment may be as illustrated in Table 12 below at room temperature (approximately 20 °C).

TABLE 12

| Vertical height | Distance along | Distance along | Vertical height |
|---|---|---|---|
| of optical axis | optical axis from | optical axis from | of optical axis |
| from optical | sensor-side of | sensor-side of | from optical |
| axis on | first lens to | aperture to | axis on |
| sensor-side of | object-side of | object-side of | object-side of |
| first lens (mm) | aperture (mm) | second lens (mm) | second lens (mm) |
| 0 | 0.010 | 0.726 | 0 |
| 0.2 | 0.012 | 0.713 | 0.2 |
| 0.4 | 0.018 | 0.671 | 0.4 |
| 0.6 | 0.032 | 0.598 | 0.6 |
| 0.8(L1) | 0.059 | — | 0.8(L1) |

Referring to Table 12, the first distance d12 may mean a distance on the optical axis direction from the sensor-side of the first lens 101 to the object-side of the second lens 102. The first distance d12 may be the sum of the distance on the optical axis direction from the sensor-side of the first lens 101 to the object-side of the aperture and the distance on the optical axis direction from the sensor-side of the aperture to the object-side of the second lens 102. The first distance d12 may be a first air distance d12.

The first distance may become smaller as it goes from the optical axis OA to the first point L1, which is the end of the clear aperture of the second surface S2. Here, the value meant by the first point L1 is an approximate value of the effective radius value of the second surface S2 having a smaller clear aperture size among the sensor-side (second surface S2) of the first lens 101 and the object-side (third surface S3) of the second lens 102 facing each other, and means an approximate value of ½ of the clear aperture value of the second surface S2 described in Table 2.

The first distance can have a maximum value at the optical axis OA and a minimum value at the first point L1. The maximum value of the first distance can be about 1 to about 1.3 times the minimum value. For example, in the first embodiment, the maximum value of the first distance can be about 1.03 times the minimum value.

In addition, the distance (second distance) between the second lens 102 and the third lens 103 in the optical system 1000 according to the first embodiment may be as illustrated in Table 13 below at room temperature (approximately 20 °C).

TABLE 13

| Vertical height of | Optical axis | Vertical height of |
|---|---|---|
| optical axis from | distance of second | optical axis from |
| optical axis on | air distance | optical axis on |
| sensor-side of | (d23) (mm) | object-side of |
| second (mm) | (second distance) | third lens (mm) |
| 0 | 0.050 | 0 |
| 0.2 | 0.070 | 0.2 |
| 0.4 | 0.127 | 0.4 |
| 0.6 | 0.212 | 0.6 |
| 0.8 | 0.316 | 0.8 |
| 1.0 | 0.417 | 1.0 |
| 1.2(L2) | 0.472 | 1.2(L2) |

Referring to Table 13, the second distance d23 may mean the direction of the optical axis from the sensor-side of the second lens to the object-side of the third lens. The second distance d23 may be the second air distance d23.

The second distance may increase from the optical axis OA to the second point L2, which is the end of the clear aperture of the fourth surface S4. Here, the value indicated by the second point L2 is an approximate value of the effective radius value of the fourth surface S4 which has a smaller clear aperture among the sensor-side (fourth surface S4) of the second lens 102 and the object-side (fifth surface S5) of the third lens 103 facing each other, and means an approximate value of ½ of the clear aperture value of the fourth surface S4 described in Table 2.

The second distance can have a maximum value at the second point L2 and a minimum value at the optical axis OA. The maximum value of the second distance can be about 8 to about 10 times the minimum value. For example, in the first embodiment, the maximum value of the second distance can be about 9.4 times the minimum value.

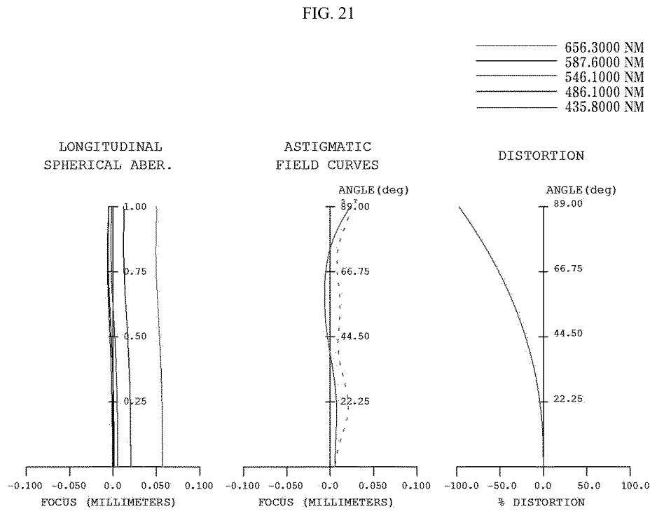

The optical system 1000 according to the first embodiment can satisfy at least one of the mathematical expressions described below. Accordingly, the optical system 1000 according to the first embodiment can prevent or minimize changes in optical characteristics according to temperature in a temperature range from low temperature to high temperature, thereby implementing improved optical characteristics at various temperatures. In addition, the optical system 1000 according to the embodiment can have improved distortion and aberration characteristics at various temperatures by satisfying at least one of the mathematical expressions described below. Terms expressed in some mathematical expressions will be described with reference to FIG. 21.

1.2<L1_CT/L1_ET<1.5 [Mathematical expression 1]

In mathematical expression 1, L1_CT is the thickness (mm) at the center of the first lens 101 at room temperature (approximately 20 °C) and the thickness at the optical axis OA of the first lens 101, and L1_ET means the thickness (mm) in the direction of the optical axis OA at the end of the effective area of the first lens 101 at room temperature (approximately 20 °C). When the optical system 1000 according to the embodiment satisfies mathematical expression 1, a factor affecting the field of view of the optical system 1000 can be set, and a factor affecting the effective focal length (EFL) can be set. In the first embodiment, mathematical expression 1 may preferably satisfy 1.3<L1_CT/L1_ET<1.4.

1<L2_CT/L2_ET<1.5 [Mathematical expression 2]

In mathematical expression 2, L2_CT is the thickness (mm) at the center of the second lens 102 at room temperature (approximately 20 °C) and the thickness of the second lens 102 at the optical axis OA. In addition, L2_ET means the thickness (mm) on the optical axis OA direction at the end of the effective area of the second lens 101 at room temperature (approximately 20 °C). L1_ET may be the thickness of the flange part outside the clear aperture of the first lens 101. When the optical system 1000 according to the embodiment satisfies mathematical expression 2, the optical system 1000 may have improved chromatic aberration reduction characteristics. In the first embodiment, mathematical expression 2 may preferably satisfy 1<L2_CT/L2_ET<1.2.

0.5<L3_CT/L3_ET<1 [Mathematical expression 3]

In mathematical expression 3, L3_CT is the thickness (mm) at the center of the third lens 103 at room temperature (approximately 20 °C) and the thickness of the third lens 103 at the optical axis OA. In addition, L3_ET means the thickness (mm) on the optical axis OA direction at the end of the effective area of the third lens 103 at room temperature (approximately 20 °C). L3_ET may be the thickness of the flange part outside the clear aperture of the third lens 103. When the optical system 1000 according to the embodiment satisfies mathematical expression 3, the optical system 1000 may have improved aberration reduction characteristics. In the first embodiment, mathematical expression 3 may preferably satisfy 0.8<L3_CT/L3_ET<1.

1.6<n1 <1.7 [Mathematical expression 4]

In mathematical expression 4, n1 is the refractive index of the light of the d-line (587.6 nm) wavelength band of the first lens 101. If mathematical expression 4 is satisfied, the refractive performance of the first lens 101 arranged closest to the object-side in the optical system 1000 can be secured. In the first embodiment, mathematical expression 4 may preferably satisfy 1.62<n1 <1.66.

20<v1 <30 [Mathematical expression 5]

In mathematical expression 5, it means the Abbe's number of the first lens 101. If mathematical expression 5 is satisfied, the refractive performance of the first lens 101 arranged closest to the object-side in the optical system 1000 can be secured. In the first embodiment, mathematical expression 5 may preferably satisfy 22<v1<27.

1.6<n2<1.7 [Mathematical expression 6]

In mathematical expression 6, n2 is the refractive index of the light of the d-line (587.6 nm) wavelength band of the second lens 102. When mathematical expression 6 is satisfied, the refractive performance of the second lens 102 arranged closest to the object-side in the optical system 1000 may be secured. In the first embodiment, mathematical expression 6 may preferably satisfy 1.62<n2<1.66.

1.2<L3S2_max_sag to Sensor <1.5 [Mathematical expression 7]

In mathematical expression 7, L3S2_max_sag to Sensor means the distance (mm) in the direction of the optical axis OA from the point of the maximum Sag value of the sensor-side (sixth surface S6) of the third lens 103 to the image sensor 600. When mathematical expression 7 is satisfied, the size of the camera module including the optical system 1000 can be minimized. In the first embodiment, mathematical expression 7 may preferably satisfy 1.3<L3S2_max_sag to Sensor <1.4.

1<BFL/L3S2_max_sag to Sensor <1.5 [Mathematical expression 8]

In mathematical expression 8, L3S2_max_sag to Sensor means the distance (mm) in the direction of the optical axis OA from the point of the maximum Sag value of the sensor-side (sixth surface S6) of the third lens 103 to the image sensor 600. The BFL (Back focal length) is the distance (mm) on the optical axis OA from the apex of the sensor-side of the lens closest to the image sensor 600 to the upper surface of the image sensor 600 at room temperature (approximately 20 °C). When mathematical expression 8 is satisfied, the size of the camera module including the optical system 1000 may be minimized. In the first embodiment, mathematical expression 8 may preferably satisfy 1<BFL/L3S2_max_sag to Sensor <1.3.

30<|L3S2_max slope|<35 [Mathematical expression 9]

In mathematical expression 9, L3S2_max slope angle means the maximum value of the angle between the tangent line touching the sensor-side of the third lens 103 and the line perpendicular to the optical axis OA. When the optical system 1000 according to the embodiment satisfies mathematical expression 9, the optical system 1000 may minimize the flare phenomenon. In the first embodiment, mathematical expression 9 may preferably satisfy 33<|L3S2_max slope|<35.

7<d23_max/d23_CT<10 [Mathematical expression 10]

In mathematical expression 10, d23_max means the largest distance (mm) among the distances from the sensor-side (fourth surface S4) of the second lens 102 to the object-side (fifth surface S5) of the third lens 103 at room temperature (approximately 20 °C), and d23_CT means the distance (mm) from the sensor-side (fourth surface S4) of the second lens 102 to the object-side (fifth surface S5) of the third lens 103 on the optical axis OA at room temperature (approximately 20 °C). When the optical system 1000 according to the embodiment satisfies mathematical expression 10, the optical system 1000 may have improved characteristics of peripheral field of view, chromatic aberration, and distortion characteristics. In the first embodiment, mathematical expression 10 may preferably satisfy 9<d23_max/d23_CT<10.

0.1<L2_CT/L1_CT<1 [Mathematical expression 11]

In mathematical expression 11, L2_CT means the central thickness of the second lens 102 in the direction of the optical axis OA at room temperature (approximately 20 °C). In addition, L1_CT means the central thickness of the first lens 101 in the direction of the optical axis OA at room temperature (approximately 20 °C). When mathematical expression 11 is satisfied, a factor affecting the field of view of the optical system may be set, and a factor affecting the effective focal length (EFL) can be set. In the first embodiment, mathematical expression 11 may preferably satisfy 0.5<L2_CT/L1_CT<1.

1.2<L2R1/L2R2<1.5 [Mathematical expression 12]

In mathematical expression 12, L2R1 is a radius of curvature of the object-side (third surface S3) of the second lens 102 at room temperature (about 20 °C), and L2R2 is a radius of curvature of the sensor-side (fourth surface S4) of the second lens 102 at room temperature (about 20 °C). When the optical system 1000 according to the embodiment satisfies mathematical expression 12, the optical system 1000 may have improved aberration control characteristics. In the first embodiment, mathematical expression 12 may preferably satisfy 1.3<L2R1/L2R2<1.4.

0.1<CA_L1/CA_L2<1 [Mathematical expression 13]

In mathematical expression 13, CA_L1 means the size of the clear aperture of the first lens 101, and CA_L2 means the size of the clear aperture of the second lens 102. The size of the clear aperture of each lens means the average value of the object-side and the sensor-side of the lens. When mathematical expression 13 is satisfied, the deterioration of optical characteristics due to temperature change may be suppressed, and the optical system 1000 may control the incident light and set the factor affecting the aberration. In the first embodiment, mathematical expression 13 may preferably satisfy 0.5<CA_L1/CA_L2<1.

0.5<CA_L2/CA_L3<1 [Mathematical expression 14]

In mathematical expression 14, CA_L2 means the size of the clear aperture of the second lens 102, and CA_L3 means the size of the clear aperture of the third lens 103. The size of the clear aperture of each lens means the average value of the object-side and the sensor-side of the lens. When mathematical expression 14 is satisfied, the deterioration of optical characteristics due to temperature change may be suppressed, and the optical system 1000 may control the incident light and set the factor affecting the aberration. In the first embodiment, mathematical expression 14 may preferably satisfy 0.5<CA_L2/CA_L3<0.7.

1<L_CT_Max/Air_Max <2 [Mathematical expression 15]

In mathematical expression 15, L_CT_Max means the value having the largest center thickness among the first to third lenses 101-103 on the optical axis OA direction. In addition, Air_Max means the larger value among the distance between the first lens 101 and the second lens 102 and the distance between the second lens 102 and the third lens 103 on the optical axis OA direction. When the optical system 1000 according to the embodiment satisfies mathematical expression 15, the optical system 1000 may have good optical performance and TTL reduction characteristics at the set field of view and focal length. In the first embodiment, mathematical expression 15 may preferably satisfy 1.4<L_CT_Max/Air_Max <1.7.

3<ΣL_CT/ΣAir_CT<3.5 [Mathematical expression 16]

In mathematical expression 16, ΣL_CT means the sum of the central thicknesses of the first to third lenses 101-103 on the optical axis OA direction. In addition, ΣAir_CT means the sum of the distances between the first lens 101 and the second lens 102 and the distances between the second lens 102 and the third lens 103 on the optical axis OA direction. When the optical system 1000 according to the embodiment satisfies mathematical expression 16, the optical system 1000 may have good optical performance and TTL reduction characteristics at the set field of view and focal length. In the first embodiment, mathematical expression 16 may preferably satisfy 3<ΣL_CT/ΣAir_CT<3.2.

10<ΣAbb/ΣIndex <15 [Mathematical expression 17]

In mathematical expression 17, ΣIndex means the sum of refractive indices at each d-line of the first to third lenses 101-103 at room temperature (approximately 20 °C). In addition, ΣAbb means the sum of Abbe's numbers of the first to third lenses 101-103 at room temperature (approximately 20 °C). When the optical system 1000 according to the embodiment satisfies mathematical expression 17, the optical system 1000 may have improved aberration characteristics and resolution. In the first embodiment, mathematical expression 17 may preferably satisfy 13<ΣAbb/ΣIndex <15.

1<CA_L1S1/CA_min <1.5 [Mathematical expression 18]

In mathematical expression 18, CA_L1S1 is the size of the clear apearture of the object-side S1 of the first lens 101, and CA_min is the size of the clear apearture (CA) of the lens surface having the smallest clear apearture (CA) size at room temperature (approximately 20 °C) among the lens surfaces of the plurality of lenses 101-103 included in the optical system 1000. When the optical system 1000 according to the embodiment satisfies mathematical expression 18, the optical system 1000 may have optical performance and TTL reduction structural characteristics. In the first embodiment, mathematical expression 18 may preferably satisfy 1<CA_L1S1/CA_min <1.2.

1.5<CA_max/CA_min <2 [Mathematical expression 19]

In mathematical expression 19, CA_max is the size of the clear aperture (CA) of the lens surface having the largest clear apearture (CA) size at room temperature (approximately 20 °C) among the lens surfaces of the plurality of lenses 101-103 included in the optical system 1000. In addition, CA_min is the size of the clear apearture (CA) of the lens surface having the smallest clear apearture (CA) size at room temperature (approximately 20 °C) among the lens surfaces of the plurality of lenses 101-103 included in the optical system 1000. When the optical system 1000 according to the embodiment satisfies mathematical expression 19, the optical system 1000 may have optical performance and TTL reduction structural characteristics. In the first embodiment, mathematical expression 19 may preferably satisfy 1.5<CA_max/CA_min <1.8.

1<CA_max/CA_Aver <1.5 [Mathematical expression 20]

In mathematical expression 20, CA_max is the size of the clear apearture (CA) of the lens surface having the largest clear apearture (CA) size at room temperature (approximately 20 °C) among the lens surfaces of the plurality of lenses 101-103 included in the optical system 1000. In addition, CA_Aver means the average (mm) of the clear apearture (CA) sizes of the lens surfaces (object-side, sensor-side) of the plurality of lenses 101-103 included in the optical system 1000 at room temperature (approximately 20 °C). When the optical system 1000 according to the embodiment satisfies mathematical expression 20, the optical system 1000 may have optical performance and TTL reduction structural characteristics. In the first embodiment, mathematical expression 20 may preferably satisfy 1.2<CA_max/CA_Aver <1.5.

0.5<CA_min/CA_Aver <1 [Mathematical expression 21]

In mathematical expression 21, CA_min is the size of the clear apearture (CA) of the lens surface having the smallest clear apearture (CA) size at room temperature (approximately 20 °C) among the lens surfaces of the plurality of lenses 101-103 included in the optical system 1000. In addition, CA_Aver means the average (mm) of the clear apearture (CA) sizes of the lens surfaces (object-side, sensor-side) of the plurality of lenses 101-103 included in the optical system 1000 at room temperature (approximately 20 °C). When the optical system 1000 according to the embodiment satisfies mathematical expression 21, the optical system 1000 can be provided with a slim and compact structure and can have an appropriate size for implementing optical performance in a temperature range from low temperature to high temperature. In the first embodiment, mathematical expression 21 may preferably satisfy 0.5<CA_min/CA_Aver <0.8.

0.5<CA_max/(2*ImgH)<1 [Mathematical expression 22]

In mathematical expression 22, CA_max is the size of the clear apearture (CA) of the lens surface having the largest clear apearture (CA) size at room temperature (approximately 20 °C) among the lens surfaces of the plurality of lenses 101-103 included in the optical system 1000. In addition, ImgH is the value of the vertical distance of the optical axis OA from the 0 field (fielded) area of the image sensor 600 that overlaps the optical axis OA at room temperature (approximately 20 °C) to the 1.0 field area of the image sensor 600. In other words, ImgH means ½ of the total diagonal length (mm) of the image sensor 600 at room temperature (approximately 20 °C). When the optical system 1000 according to the embodiment satisfies mathematical expression 22, the optical system 1000 can be provided with a slim and compact structure and can have an appropriate size for implementing optical performance in a temperature range from low temperature to high temperature. In the first embodiment, mathematical expression 22 may preferably satisfy 0.5<CA_max/(2*ImgH)<0.8.

1.4<f/L1R1<1.8 [Mathematical expression 23]

In mathematical expression 23, f means the effective focal length (mm) of the optical system 1000 at room temperature (about 20 °C). f may be EFL (Effective Focal Length). In addition, L1R1 is the radius of curvature of the object-side (the first surface S1) of the first lens 101 at room temperature (about 20 °C). When the optical system 1000 according to the embodiment satisfies mathematical expression 23, the optical system 1000 may be provided with a TTL reduction structure. In the first embodiment, mathematical expression 23 may preferably satisfy 1.4<f/L1R1<1.7.

0.5<EPD/L1R1<1 [Mathematical expression 24]

In mathematical expression 24, EPD (Entrance Pupil Diameter) means the diameter of the entrance pupil. In addition, L1R1 is the radius of curvature of the object-side (the first surface S1) of the first lens 101 at room temperature (approximately 20 °C). When the optical system 1000 according to the embodiment satisfies mathematical expression 24, the optical system 1000 may have incident light control characteristics. In the first embodiment, mathematical expression 24 may preferably satisfy 0.6<EPD/L1R1<0.8.

0.5<f1/f2<1 [Mathematical expression 25]

In mathematical expression 25, f1 is the focal length (mm) of the first lens 101 at room temperature (about 20 °C), and f2 is the focal length (mm) of the second lens 102 at room temperature (about 20 °C). When the optical system 1000 according to the embodiment satisfies mathematical expression 25, the optical system 1000 can have appropriate refractive power for controlling the incident light path of the first lens 101 and the second lens 102, and the optical system 1000 can have improved resolution. In the first embodiment, mathematical expression 25 may preferably satisfy 0.8<f1/f2<1.

5<TTL<6 [Mathematical expression 26]

In mathematical expression 26, TTL is the distance (mm) from the object-side (first surface S1) of the first lens 101 to the upper surface of the image sensor 600 on the optical axis OA at room temperature (approximately 20 °C). If mathematical expression 26 is satisfied, a suitable vehicle optical system can be provided. In the first embodiment, mathematical expression 26 may preferably satisfy 5<TTL <5.5.

2<ImgH<3 [Mathematical expression 27]

In mathematical expression 27, ImgH is the value of the vertical distance of the optical axis OA from the 0 field area of the upper surface center of the image sensor 600 overlapping with the optical axis OA to the 1.0 field area of the image sensor 600 at room temperature (approximately 20 °C). In other words, ImgH means ½ of the total diagonal length (mm) of the image sensor 600 at room temperature (about 20 °C). If mathematical expression 27 is satisfied, an optical system having a vehicle sensor size can be provided. In the first embodiment, mathematical expression 27 may preferably satisfy 2<ImgH <2.5.

1.2<BFL<1.8 [Mathematical expression 28]

In mathematical expression 28, BFL (Back focal length) is the distance (mm) from the apex of the sensor-side of the lens closest to the image sensor 600 to the upper surface of the image sensor 600 on the optical axis OA at room temperature (about 20 °C). If mathematical expression 28 is satisfied, the installation space of the filter 500 and the cover glass can be secured, and the assembling of the components can be improved through the distance between the image sensor 400 and the last lens, and the coupling reliability can be improved. If the BFL is less than the range of mathematical expression 28, some of the light that goes to the image sensor may not be transmitted to the image sensor, which may cause a decrease in resolution. If the BFL exceeds the range of mathematical expression 28, stray light may be introduced, which may deteriorate the aberration characteristics of the optical system. In the first embodiment, mathematical expression 28 may preferably satisfy 1.3<BFL <1.6.

3<f<4 [Mathematical expression 29]

In mathematical expression 29, f means the effective focal length (mm) of the optical system 1000 at room temperature (approximately 20 °C). F may be an Effective Focal Length (EFL). If mathematical expression 29 is satisfied, a focal length suitable for a vehicle optical system can be set. In the first embodiment, mathematical expression 29 may preferably satisfy 3.5<f<4.

50<FOV<70 [Mathematical expression 30]

In mathematical expression 30, FOV means the field of view (FOV) of the optical system 1000 in an environment of room temperature (approximately 20 °C), low temperature (approximately −40 °C), and high temperature (approximately 85 °C). If mathematical expression 30 is satisfied, an field of view suitable for a vehicle optical system can be provided. In the first embodiment, mathematical expression 30 may preferably satisfy 60<FOV <70.

1.2<TTL/CA_max <1.8 [Mathematical expression 31]

In mathematical expression 31, TTL is a distance (mm) from the object-side (first surface S1) of the first lens 101 to the upper surface of the image sensor 600 on the optical axis OA in an environment of room temperature (approximately 20 °C). In addition, CA_max is a size (CA) of an clear apearture of a lens surface having the largest clear apearture (CA) size at room temperature (approximately 20 °C) among the lens surfaces of a plurality of lenses 101-103 included in the optical system 1000. When the optical system 1000 according to the embodiment satisfies the mathematical expression 31, the optical system 1000 has good optical performance at the center and periphery of the field of view (FOV), and can be provided with a slim and compact structure. In the first embodiment, the mathematical expression 31 may preferably satisfy 1.4<TTL/CA_max <1.7.

2<TTL/ImgH<2.5 [Mathematical expression 32]

In the mathematical expression 32, TTL is the distance (mm) from the object-side (first surface S1) of the first lens 101 to the upper surface of the image sensor 600 on the optical axis OA in an environment of room temperature (approximately 20 °C). In addition, ImgH is a value of the vertical distance of the optical axis OA from the 0 field area of the image sensor 600 at the center of the upper surface that overlaps the optical axis OA at room temperature (approximately 20 °C) to the 1.0 field area of the image sensor 600. In other words, ImgH means ½ of the total diagonal length (mm) of the image sensor 600 at room temperature (approximately 20 °C). When the optical system 1000 according to the embodiment satisfies mathematical expression 32, the optical system 1000 can secure a BFL (Back focal length) for applying a relatively large-sized image sensor 600, for example, a large image sensor 600 of about 1 inch, and can have a smaller TTL, thereby implementing high quality and having a slim structure. In the first embodiment, mathematical expression 32 may preferably satisfy 2.3<TTL/ImgH <2.5.

0.2<BFL/ImgH<0.7 [Mathematical expression 33]

In mathematical expression 33, BFL (Back focal length) is the distance (mm) from the apex of the sensor-side of the lens closest to the image sensor 600 to the upper surface of the image sensor 600 on the optical axis OA at room temperature (approximately 20 °C). In addition, ImgH is the value of the vertical distance of the optical axis OA from the 0 field area of the upper surface center of the image sensor 600 overlapping the optical axis OA to the 1.0 field area of the image sensor 600 at room temperature (approximately 20 °C). In other words, ImgH means ½ of the total diagonal length (mm) of the image sensor 600 at room temperature (approximately 20 °C). When the optical system 1000 according to the embodiment satisfies the mathematical expression 33, the optical system 1000 can secure a BFL (Back focal length) for applying a relatively large image sensor 600, for example, a large image sensor 600 of about 1 inch, and can minimize the distance between the last lens and the image sensor 600, so that it may have good optical characteristics at the center and periphery of the field of view (FOV). In the first embodiment, preferably, the mathematical expression 33 can satisfy 0.5<BFL/ImgH <0.7.

3<TTL/BFL<4 [Mathematical expression 34]

In the mathematical expression 34, TTL is the distance (mm) from the object-side (first surface S1) of the first lens 101 to the upper surface of the image sensor 600 on the optical axis OA in an environment of room temperature (about 20 °C). In addition, the BFL (Back focal length) is the distance (mm) from the top of the sensor-side of the lens closest to the image sensor 600 to the upper surface of the image sensor 600 on the optical axis OA at room temperature (about 20 °C). When the optical system 1000 according to the embodiment satisfies the mathematical expression 34, the optical system 1000 can be provided slim and compactly while securing the BFL. In the first embodiment, preferably, the mathematical expression 34 can satisfy 3.2<TTL/BFL <3.5.

0.5<f/TTL<1 [Mathematical expression 35]

In the mathematical expression 35, f means the effective focal length (mm) of the optical system 1000 at room temperature (about 20 °C). F can be the EFL (Effective Focal Length). In addition, TTL is the distance (mm) from the object-side (first surface S1) of the first lens 101 to the upper surface of the image sensor 600 on the optical axis OA in an environment of room temperature (approximately 20 °C). When the optical system 1000 according to the embodiment satisfies mathematical expression 35, the optical system 1000 can be provided in a slim and compact manner. In the first embodiment, preferably, mathematical expression 35 can satisfy 0.6<f/TTL<0.8.

2<f/BFL<2.5 [Mathematical expression 36]

In mathematical expression 36, f means the effective focal length (mm) of the optical system 1000 at room temperature (about 20 °C). f may be EFL (Effective Focal Length). In addition, BFL (Back focal length) is the distance (mm) from the apex of the sensor-side of the lens closest to the image sensor 600 to the upper surface of the image sensor 600 on the optical axis OA at room temperature (about 20 °C). When the optical system 1000 according to the embodiment satisfies mathematical expression 36, the optical system 1000 can have a set field of view and an appropriate focal length, and can be provided in a slim and compact manner. In addition, the optical system 1000 can minimize the distance between the last lens and the image sensor 600, so that it may have good optical characteristics at the periphery of the field of view (FOV). In the first embodiment, preferably, the mathematical expression 36 can satisfy 2.3<f/BFL <2.5.

1.3<f/ImgH<1.8 [Mathematical expression 37]

In the mathematical expression 37, f means the effective focal length (mm) of the optical system 1000 at room temperature (about 20 °C). F may be EFL (Effective Focal Length). In addition, ImgH is the value of the vertical distance of the optical axis OA from the 0 field area of the image sensor 600 that overlaps the optical axis OA at room temperature (about 20 °C) to the 1.0 field area of the image sensor 600. In other words, ImgH means ½ of the total diagonal length (mm) of the image sensor 600 at room temperature (about 20 °C). When the optical system 1000 according to the embodiment satisfies the mathematical expression 37, the optical system 1000 can apply a relatively large-sized image sensor 600, for example, a large image sensor 600 of about 1 inch, and can have improved aberration characteristics. In the first embodiment, preferably, the mathematical expression 37 can satisfy 1.5<f/ImgH <1.7.

2<f/EPD<2.3 [Mathematical expression 38]

In the mathematical expression 38, f means the effective focal length (mm) of the optical system 1000 at room temperature (about 20 °C). F can be the EFL (Effective Focal Length). In addition, EPD (Entrance Pupil Diameter) means the diameter of the entrance pupil. In the first embodiment, preferably, the mathematical expression 38 can satisfy 2<f/EPD <2.1.

1.8<Fno<2.2 [Mathematical expression 39]

In mathematical expression 39, Fno means the F-number of the optical system. When the optical system 1000 according to the embodiment satisfies mathematical expression 39, it can take pictures in a dark environment as well as in a bright environment, and in particular, it can detect near infrared ray light. In the first embodiment, preferably, mathematical expression 38 can satisfy 1.9<Fno<2.1.

$$z = \frac{{cY}^{2}}{1 + \sqrt{1 - ( 1 + K ) {c}^{2} {Y}^{2}}} + {AY}^{4} + {BY}^{5} + {CY}^{4} + {DY}^{5} + {EY}^{4} + … \qquad [ Mathematical expression 40 ]$$

In the mathematical expression 40, Z may mean a distance in the direction of the optical axis from an arbitrary position on the asphere to the apex of the asphere. In addition, Y may mean a distance in the direction perpendicular to the optical axis from an arbitrary position on the asphere to the optical axis. In addition, c may mean the curvature of the lens, and K may mean the conic constant. In addition, A, B, C, D, . . . may mean aspheric coefficients.

In other words, in the optical system 1000 according to the embodiment, the first lens 101, the second lens 102, and the third lens 103 may be provided with the same material, and may satisfy at least one of the mathematical expressions 1 to 39 described above. Accordingly, the optical system 1000 may prevent or minimize changes in optical characteristics according to temperature, and may have improved optical characteristics at various temperatures.

In addition, the optical system 1000 according to the embodiment can prevent or minimize changes in distortion and aberration characteristics at various temperatures by satisfying at least one of the mathematical expressions 1 to 39, thereby having improved optical characteristics.

The following Table 14 illustrates items of the mathematical expressions described above in the optical system 1000 according to the first embodiment, such as the focal lengths of the first to third lenses 101-103 at room temperature (approximately 20 °C), the TTL (Total track length), BFL (Back focal length), F value, ImgH, and effective focal length (EFL) values of the optical system 1000 according to temperature.

Table 15 illustrates result values for the mathematical expressions 1 to 39 described above in the optical system 1000 according to the first embodiment.

TABLE 14

| | First | |
|---|---|---|
| | embodiment | |
| L1_CT | 1.15 | mm |
| L2_CT | 1.00 | mm |
| L3_CT | 0.80 | mm |
| L1_ET | 0.8615 | mm |
| L2_ET | 0.8462 | mm |
| L3_ET | 0.8252 | mm |
| f1 (room temperature (about 20 °C)) | 3.3247 | mm |
| f2 (room temperature (about 20 °C)) | 3.5516 | mm |
| f3 (room temperature (about 20 °C)) | −3.2493 | mm |
| EPD (room temperature (about 20 °C)) | 1.8232 | mm |
| ImgH (room temperature (about 20 °C)) | 2.2640 | mm |
| TD(L1S1~L3S2) | 3.7361 | mm |
| (room temperature (about 20 °C)) | | |
| SD(Stop~L3S2) | 2.5761 | mm |
| (room temperature (about 20 °C)) | | |
| EFL (room temperature (about 20 °C)) | 3.6852 | mm |
| EFL (low temperature (−40 °C)) | 3.6197 | mm |
| EFL (High temperature (85 °C)) | 3.7597 | mm |
| BFL (room temperature (about 20 °C)) | 1.5207 | mm |
| BFL (low temperature (−40 °C)) | 1.5153 | mm |
| BFL (High temperature (85 °C)) | 1.8401 | mm |

| | |
|---|---|
| Fno (room temperature (about 20 °C)) | 2.02 |
| Fno (low temperature (−40 °C)) | 1.99 |
| Fno (High temperature (85 °C)) | 2.06 |

TABLE 15

| Mathematical | Mathematical | First |
|---|---|---|
| expression | expression | embodiment |
| 1 | 1.2 < L1_CT/L1_ET < 1.5 | 1.334 |
| 2 | 1 < L2_CT/L2_ET < 1.5 | 1.181 |
| 3 | 0.5 < L3_CT/L3_ET < 1 | 0.969 |
| 4 | 1.6 < n1 < 1.7 | 1.64 |
| 5 | 20 < v1 < 30 | 23.5 |
| 6 | 1.6 < n2 < 1.7 | 1.64 |
| 7 | 1.2 < L3S2_max_sag to Sensor < 1.5 | 1.303 |
| 8 | 1 < BFL/L3S2_max_sag to Sensor < 1.5 | 1.167 |
| 9 | 30 < \|L3S2_max slope\| < 35 | 34.0 |
| 10 | 7 < d23_max/d23_CT < 10 | 9.44 |
| 11 | 0.1 < L2_CT/L1_CT < 1 | 0.869 |
| 12 | 1.2 < L2R1/L2R2 < 1.5 | 1.335 |
| 13 | 0.1 < CA_L1/CA_L2 < 1 | 0.926 |
| 14 | 0.5 < CA_L2/CA_L3 < 1 | 0.613 |
| 15 | 1 < L_CT_Max/Air_Max < 2 | 1.583 |
| 16 | 3 < ²/Σ?Air_CT < 3.5 | 3.114 |
| 17 | 10 < ²/Σ?Index < 15 | 14.329 |
| 18 | 1 < CA_L1S1/CA_min < 1.5 | 1.153 |
| 19 | 1.5 < CA_max/CA_min < 2 | 1.759 |
| 20 | 1 < CA_max/CA_Aver < 1.5 | 1.374 |
| 21 | 0.5 < CA_min/CA_Aver < 1 | 0.781 |
| 22 | 0.5 < CA_max/(2*ImgH) < 1 | 0.771 |
| 23 | 1.4 < f/L1R1 < 1.8 | 1.523 |
| 24 | 0.5 < EPD/L1R1 < 1 | 0.752 |
| 25 | 0.5 < f1/f2 < 1 | 0.936 |
| 26 | 5 < TTL < 6 | 5.2572 |
| 27 | 2 < ImgH < 3 | 2.264 |
| 28 | 1.2 < BFL < 1.8 | 1.5212 |
| 29 | 3 < f < 4 | 3.69 |
| 30 | 50 < FOV < 70 | 63 |
| 31 | 1.2 < TTL/CA_max < 1.8 | 1.505 |
| 32 | 2 < TTL/ImgH < 2.5 | 2.322 |
| 33 | 0.2 < BFL/ImgH < 0.7 | 0.671 |
| 34 | 3 < TTL/BFL < 4 | 3.455 |
| 35 | 0.5 < f/TTL < 1 | 0.701 |
| 36 | 2 < f/BFL < 2.5 | 2.425 |
| 37 | 1.3 < f/ImgH < 1.8 | 1.629 |
| 38 | 2 < f/EPD < 2.3 | 2.023 |
| 39 | 1.8 < Fno < 2.2 | 2 |

Referring to Table 15, it can be seen that the optical system 1000 according to the first embodiment satisfies at least one of mathematical expressions 1 to 39. In detail, it can be seen that the optical system 1000 according to the first embodiment satisfies all of mathematical expressions 1 to 39.

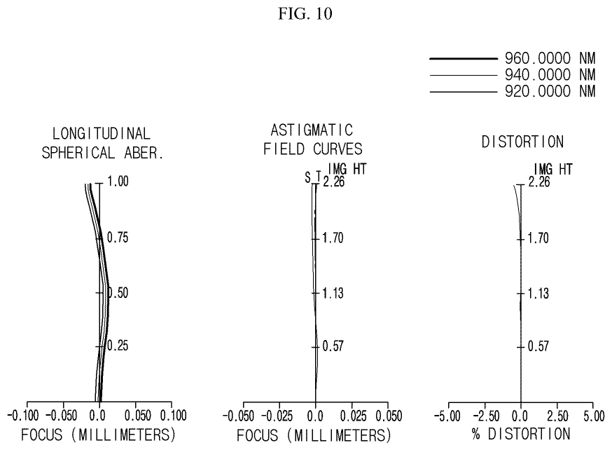

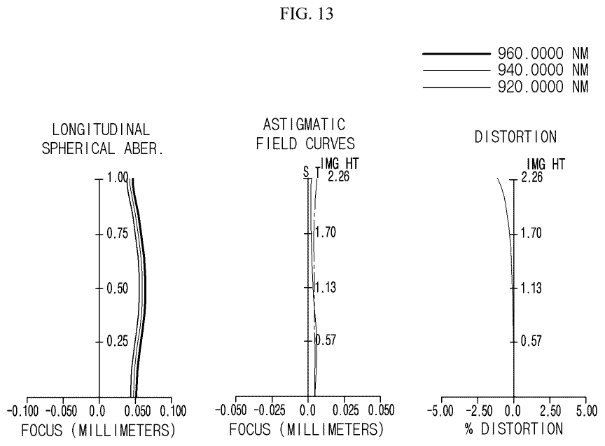

Accordingly, the optical system 1000 according to the first embodiment has a field of view of about 60 degrees (60±1 degrees) in a temperature range of low temperature (−40 °C) to high temperature (85 °C), and can have optical characteristics as illustrated in FIGS. 5 to 13.

FIGS. 5 to 13 are graphs of diffraction MTF characteristics and aberrations of the optical system 1000 according to temperature.

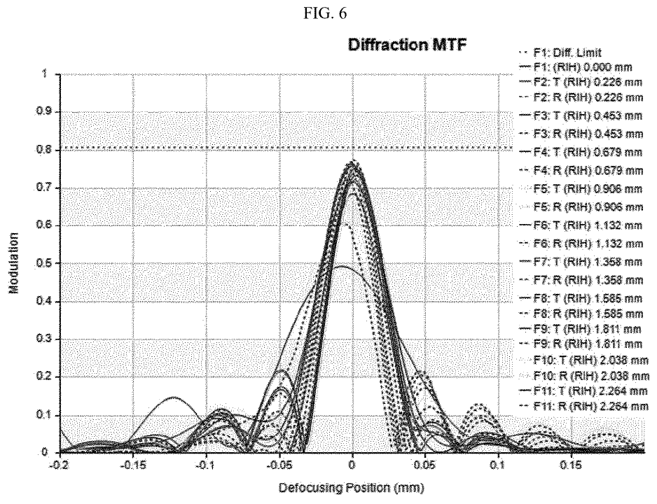

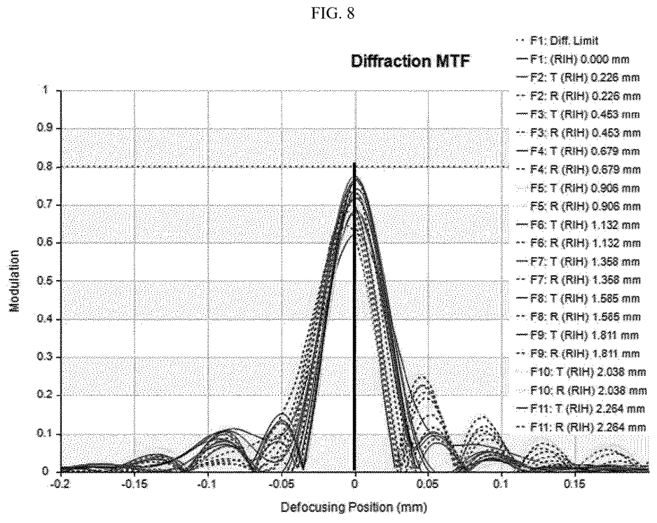

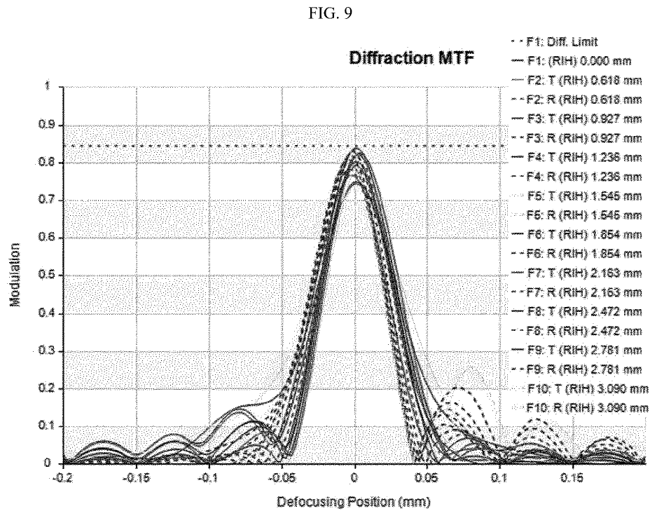

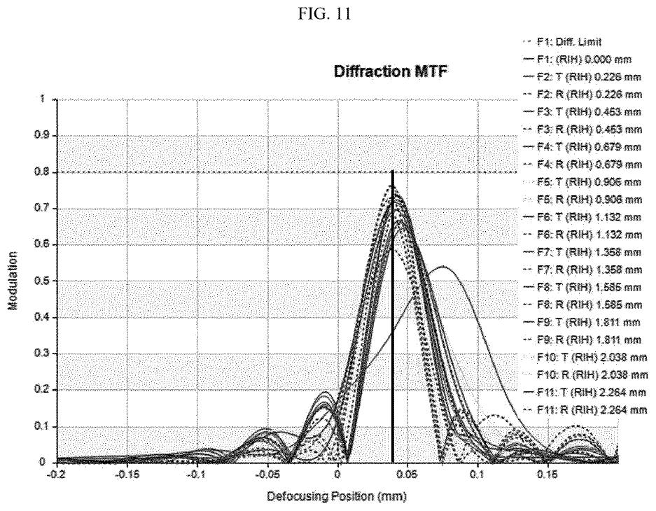

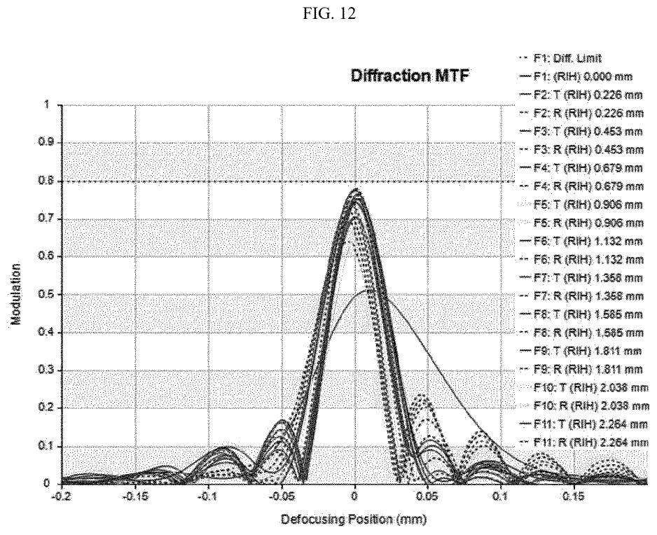

In detail, FIG. 5 is a graph of diffraction MTF characteristics of an optical system 1000 in a low temperature (−40 °C) environment, and FIG. 6 is a graph of diffraction MTF characteristics of an optical system 1000 in which peak criterion is compensated according to actuator driving in a low temperature (−40 °C) environment. FIG. 8 is a graph of diffraction MTF characteristics of an optical system 1000 in a room temperature (20 °C) environment, and FIG. 9 is a graph of diffraction MTF characteristics of an optical system 1000 in which peak criterion is compensated according to actuator driving in a room temperature (20 °C) environment. FIG. 11 is a graph of the diffraction MTF characteristics of an optical system 1000 in a high temperature (85 °C) environment, and FIG. 12 is a graph of the diffraction MTF characteristics of an optical system 1000 with peak reference compensated according to actuator operation in a high temperature (85 °C) environment.

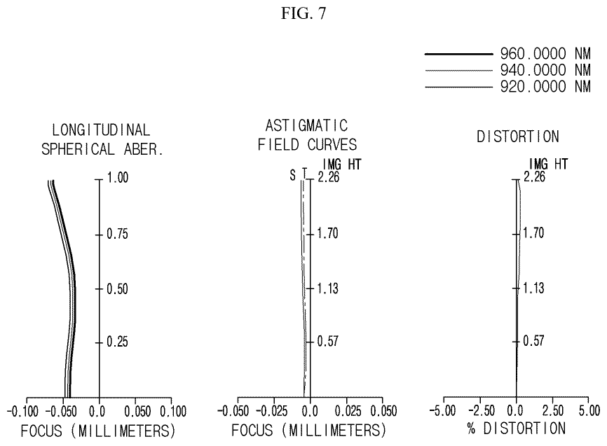

In addition, FIGS. 7, 10, and 13 are graphs of aberrations of the optical system 1000 in low temperature (−40 °C), room temperature (20 °C), and high temperature (85 °C) environments, respectively, in which spherical aberration (Longitudinal Spherical Aberration), astigmatic field curves, and distortion are measured from left to right. In FIGS. 7, 10, and 13, the X-axis may represent a focal length (mm) or distortion (%), and the Y-axis may represent the height of the image. In addition, the graph for spherical aberration is a graph for light in wavelength bands of about 920 nm, about 940 nm, and about 960 nm, and the graphs for astigmatic aberration and distortion are graphs for light in wavelength bands of 940 nm.

In the aberration diagrams of FIGS. 7, 10, and 13, the closer each curve is to the Y-axis, the better the aberration correction function can be interpreted, and referring to FIGS. 7, 10, and 13, it can be seen that the optical system 1000 according to the first embodiment has measurement values close to the Y-axis in almost all areas.

Referring to FIGS. 5 to 13, it can be seen that the optical system 1000 according to the first embodiment has little or no change in MTF characteristics and aberration characteristics even when the temperature changes in the range of low temperature (−40 °C) to high temperature (85 °C). In detail, it can be seen that the change in MTF characteristics at low temperature (−40 °C) and high temperature (85 °C) is less than 10% of that at room temperature (22 °C).

In other words, the optical system 1000 according to the first embodiment can maintain excellent optical characteristics in various temperature ranges. In detail, the optical system 1000 may include the same plastic material as the first lens 101 and the second lens 102 and the third lens 103.

At this time, the first to third lenses 101-103 according to the first embodiment are provided with set refractive indices, shapes, thicknesses, or the like, so that they can mutually compensate for changes in focal length caused by changes in refractive indices that change according to temperature. Therefore, the optical system 1000 can prevent or minimize changes in optical characteristics in a temperature range of low temperature (−40 °C) to high temperature (85 °C), and can maintain improved optical characteristics.

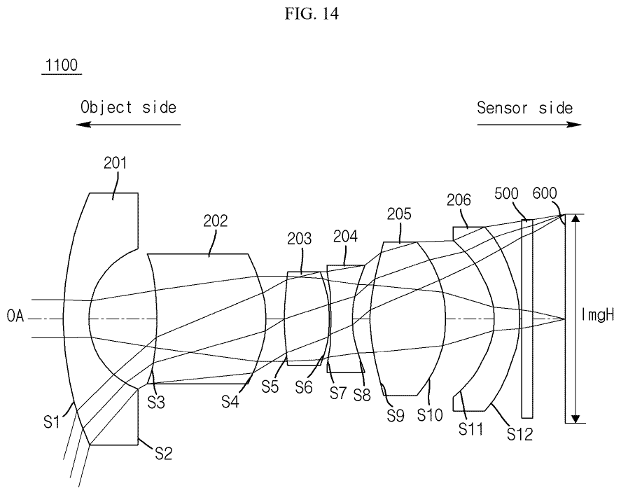

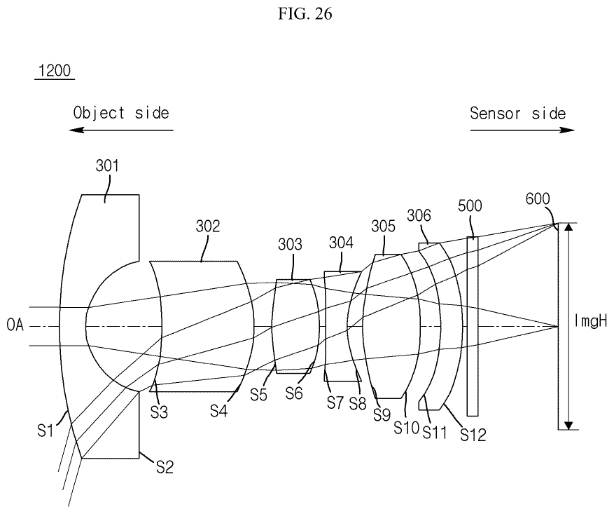

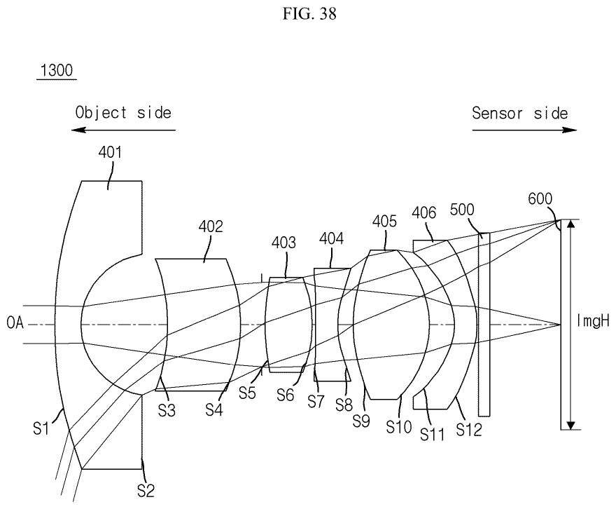

As illustrated in FIG. 14, FIG. 26 and FIG. 38, the optical system 1100, 1200, 1300 according to the second to fourth embodiments of the present disclosure may include five or more lenses. The optical system 1100, 1200, 1300 and the camera module having the same may be mounted inside or outside a vehicle to monitor a driver or sense external objects or lanes. The material of the lenses may be selected from glass or plastic, and the coefficient of linear expansion of the glass material is smaller than that of the plastic material. Accordingly, the glass lens is employed to suppress the change in the focal imaging position due to temperature change. However, the glass lens is expensive compared to the plastic lens, and there is a problem that it is difficult to meet the demand for low cost. Therefore, the lenses in the optical system 1100, 1200, 1300 are required to have a configuration in which the glass lens and the plastic lens are mixed. By adopting these plastic lenses, the optical system 1100, 1200, 1300 can provide weight reduction and low cost because the thickness of the plastic lens can be reduced, and various aberrations such as spherical aberration and chromatic aberration can be well corrected due to the plastic lens. In addition, since the plastic lenses can provide aspherical lenses, the distortion portion of the peripheral part can be minimized.

The optical system 1100, 1200, 1300 can include n lenses, and the n-th lens can be the last lens adjacent to the image sensor 600, and the n−1-th lens can be the lens closest to the last lens. n is an integer greater than or equal to 5, for example, 5 to 8. The n lenses may have a ratio of glass lenses to plastic lenses in the range of 2:4 to 3:4.

At least one lens closest to the object in the optical system 1100, 1200, 1300 can be made of glass material. The two or fewer lenses closest to the object, for example, one lens, can be made of glass. Since the rate of contraction and expansion of glass lenses due to temperature changes is smaller than that of plastic lenses, the glass lenses can be placed in the area adjacent to the outside within the lens barrel.

At least one lens closest to the image sensor 600 in the optical system 1100, 1200, 1300 may be made of plastic. For example, at least two lenses closest to the image sensor 600 may be made of plastic, and preferably, at least two lenses adjacent to the image sensor 600 may be made of plastic. In other words, since the nth and n-lth lenses in the optical system 1100, 1200, 1300 are arranged as plastic lenses, various aberrations can be corrected for the incident light of the image sensor 600.

In the optical system 1100, 1200, 1300, lenses made of plastic may be arranged sequentially, and lenses made of glass may be arranged sequentially. In the optical system 1100, 1200, 1300, lenses made of plastic may be arranged between lenses made of glass. Within the optical system 1100, 1200, 1300, a glass lens may be placed between plastic lenses.

Each lens 201-206, 301-306, 401-406 may have an object-side and a sensor-side. The optical system may have a number of lenses having an aspherical sensor-side and an aspherical object-side more than the number of plastic lenses. The optical system may have a number of lenses having a spherical sensor-side and a spherical object-side less than the number of lenses having aspheres on both sides. Since the optical system 1100, 1200, 1300 has more aspherical lenses than spherical lenses, various aberrations can be corrected.

Among the lenses of the optical system 1100, 1200, 1300, a lens having a maximum refractive index may be positioned adjacent to the object. The maximum refractive index may be 1.8 or higher. The color dispersion of light incident on the lens having the maximum refractive index can be increased, and the center thickness can be made thinner than the edge thickness. In addition, since the lens having the maximum refractive index is arranged on the object-side, it is easy to change the radius of curvature of the second and subsequent lenses, and the center thickness can be increased.

The lens having the maximum clear apearture in the optical system 1100, 1200, 1300 can be arranged in the center part of the object-side and the sensor-side. The clear apearture of the lens can become larger and smaller as it goes from the object-side to the sensor-side. The clear apearture of the lens can become smaller and larger and smaller again as it goes from the object-side to the sensor-side. Through this, since the light incident on the optical system 1100, 1200, 1300 is structured to move away from the optical axis and then gather back to the optical axis, the optical system 1100, 1200, 1300 can form a stable optical path.

The clear apearture may be the diameter of the effective area where effective light is incident from each lens. The clear apearture is the length in the direction (X, Y) orthogonal to the optical axis, and is the average of the clear apearture on the object-side and the clear apearture on the sensor-side of each lens. The “diameter of the lens surface” may mean the “clear apearture of the lens.” The “diameter of the lens” may be the diameter of the entire lens including the flange part of the lens in addition to the effective area of the lens. Although the flange of the lens is not illustrated in FIGS. 14, 26, and 38, the flange may be a portion that protrudes perpendicularly to the optical axis from the side of the lens so that the lens is coupled to the barrel. The flange may not be subject to effective light. A spacer may be additionally arranged between the flanges of different lenses so that the lenses are coupled to the barrel.

Each of the lenses 201-206, 301-306, 401-406 may include an effective area and an ineffective area. The effective area may be an area through which light incident on each lens passes. In other words, the effective area may be defined as an effective area or clear apearture in which the incident light is refracted to implement optical characteristics. The ineffective area may be arranged around the effective area. The ineffective area may be an area in which effective light is not incident on a plurality of lenses. In other words, the ineffective area may be an area unrelated to optical characteristics. In addition, the end of the ineffective area may be an area fixed to a lens barrel or the like that accommodates the lens.

In the optical system 1100, 1200, 1300, the TTL (Total top length) may be 1.5 times greater than Imgh, for example, 1.7 times greater and 2.5 times less. The TTL (Total track length) is a distance from the center of the object-side of the first lens to the upper surface of the image sensor 600 on the optical axis OA. Imgh is ½ of the maximum diagonal length of the image sensor 600. Within the optical system 1100, 1200, 1300, the effective focal length (EFL) is provided to be 2 mm or more and the field of view (FOV) is provided to be 145 degrees or more and less than 160 degrees, so that the vehicle camera module can be provided as an optical system for monitoring the interior of a vehicle. For example, the optical system and camera module according to the embodiment can be applied to a camera for an ADAS (Advanced Driving Assistance System) installed inside or outside a vehicle.

The optical system 1100, 1200, 1300 may have a condition of TTL/Imgh of 1.5 or more and 2.5 or less, for example, 1.7 or more and 2 or less. By setting the value of TTL/Imgh to 1.5 or more and 2.5 or less, the optical system 1100, 1200, 1300 may provide a vehicle lens optical system. Accordingly, the optical system 1100, 1200, 1300 may provide an image without exaggeration or distortion for the image formed.

The clear apearture of at least one plastic lens in the optical system 1100, 1200, 1300 may be smaller than the length of the image sensor 600. The clear apearture is the diameter or length of the effective area where light is incident. The length of the image sensor 600 is the maximum length of the diagonal in the direction orthogonal to the optical axis OA. The number of lenses having an clear apearture larger than the length of the image sensor 600 in the optical system 1100, 1200, 1300 may be 50% or more or 60% or more, and the number of lenses having an clear apearture smaller than the length of the image sensor 600 may be less than 50% or less than 40%. It is possible to efficiently guide light reaching the image sensor 600 while maintaining TTL below a certain value. There is an effect of maximizing light efficiency while achieving miniaturization.

The lens part may be a mixture of glass lenses and plastic lenses. The number of plastic lenses may be 60% or more compared to the total number of lenses, and may be in the range of 40% to 85% or 60% to 80%. Accordingly, when more plastic lenses are arranged in the camera module, the weight of the camera module can be reduced, and the plastic material makes it easy to polish and process, is resistant to external impacts, has high price competitiveness, and is easy to secure materials. In addition, various aberrations can be corrected by the plastic lens, thereby preventing deterioration of optical performance.

The embodiment of the disclosure can reduce the weight of the camera module by further mixing the plastic lens into the optical system 1100, 1200, 1300, can provide a lower manufacturing cost, can suppress deterioration of optical characteristics due to temperature change, various types of plastic lenses can replace glass lenses, and can facilitate polishing and processing of lens surfaces such as aspherical or free-form surfaces.

The lens part may include lenses of a first material and lenses of a second material arranged along the optical axis OA. The first material may be a glass material, and the second material may be a plastic material. The lenses of the first material may be arranged between the lenses of the second material. The lenses of the second material may be arranged between the lenses of the first material.

The lens part may include lenses of a first material having an asphere, lenses of a first material having a spherical surface, and lenses of a second material having an asphere along the optical axis OA. The first material may be a glass material, and the second material may be a plastic material. The lenses of the first material having a spherical surface may be arranged between the lenses of the second material having an asphere. The lenses of the second material may be arranged between the lenses of the first material having an asphere and the lenses of the first material having a spherical surface.

The clear apearture of the lens closest to the object-side within the lens part may be larger than the clear apearture of the lens closest to the image sensor 600. Accordingly, the brightness of the optical system can be controlled. The clear apearture may be the average clear apearture of the object-side and the sensor-side of each lens. By controlling the clear apearture size of each lens, the optical system 1100, 1200, 1300 can control the incident light to compensate for the deterioration of the optical characteristics due to resolution and temperature change, improve the chromatic aberration control characteristics, and improve the vignetting characteristics of the optical system 1100, 1200, 1300.

The lens part may include a first lens 201, 301, 401, a second lens 102, 202, 302, a third lens 103, 203, 303, a fourth lens 104, 204, 304, a fifth lens 105, 205, 305, a sixth lens 106, 206, 306, and a seventh lens 107, 207, which are aligned from the object-side toward the sensor-side along the optical axis.

Within the lens part, when the focal length is an absolute value, the focal length of the lens closest to the object may be greater than the focal length of the plastic lens. Here, the plastic lens may be at least one lens arranged on the sensor-side of the cemented lens, or at least one lens adjacent to the image sensor.

The lens part may be arranged in a camera module having an inner barrel on one side or the entire inner surface of the lens barrel. The lens part may be arranged in a camera module having a plurality of inner barrels around different lenses of the lens barrel. The lens part may be arranged in a camera module having a first inner barrel in contact with an outer surface of at least one lens of the lens barrel and a second inner barrel in contact with an outer surface of at least one lens. The lens part may be arranged in a camera module having a plurality of inner barrels each arranged between the outer surface of at least one or two or more lenses and the lens barrel. The lens part may be arranged in a camera module having a plurality of inner barrels having a material different from that of the lens barrel.

At least some of the lenses made of glass among the lenses forming the lens part may be arranged in the lens barrel, and at least some of the lenses made of plastic may be arranged in the inner barrel arranged within the lens barrel. Through this, the optical system 1100, 1200, 1300 may maintain resolution according to temperature changes. The lens part is arranged in a camera module having heterogeneous barrels, so as to minimize the decenter of a lens, for example, a plastic lens, which expands according to temperature change. The lens barrel in which the lens part is arranged has a plurality of inner barrels within the lens barrel, so as to maintain the resolution of the optical system according to temperature change and suppress deformation of the lenses. Therefore, the clear apearture of at least some of the glass material lenses included in the lens part may be smaller than the clear apearture of at least some of the plastic material lenses.

The number of lenses larger than the average clear apearture of the plastic lenses in the lens part may be at least one, for example, at least two. When the average clear apearture of the plastic material lenses is PLca_Aver and the average clear apearture of the glass material lenses is GLca_Aver, the condition of PLca_Aver <GLca_Aver may be satisfied. In addition, the condition of 1<GLca_Aver/PLca_Aver <1.5 may be satisfied. In addition, the relationship between the length of the image sensor 600 and the average clear apearture (PLca_Aver) of the plastic lens can satisfy the condition of 1<PLca_Aver/Imgh <1.5. In addition, the relationship between the average clear apearture of the glass material and the length of the image sensor 600 can satisfy the condition of 1.1<GLca_Aver/Imgh <1.5. The difference between the maximum length of the image sensor 600 and the clear apearture of the plastic lens can be arranged not to be large. Accordingly, by arranging a plastic lens having a small clear apearture and an asphere adjacent to the image sensor 600, the plastic lenses can disperse color from the center to the periphery of the image sensor 600.

The average clear apearture of the glass materials may be 4 mm or more, for example, in the range of 4.2 mm to 5 mm. The average clear apearture of the plastic material may be 3 mm or more, for example, in the range of 3.5 mm to 4 mm. The lens having the minimum clear apearture may be made of plastic, and the lens having the maximum clear apearture may be made of glass. The minimum clear apearture within the lens part may be in the range of 2 mm to 3 mm, and the maximum clear apearture may be in the range of 6 mm to 7 mm. The plastic lens is designed to have a smaller clear apearture than the glass lens, and is arranged so as not to contact the lens barrel to which the glass lens is in contact, thereby minimizing changes in optical performance due to temperature changes. In addition, the optical system 1100, 1200, 1300 can improve resolution and chromatic aberration control characteristics by controlling incident light, and can improve vignetting characteristics of the optical system 1100, 1200, 1300.

The optical system 1100, 1200, 1300 or the camera module may include an image sensor 600. The image sensor 600 may detect light and convert the light into an electrical signal. The image sensor 600 may detect light that has sequentially passed through the lens part. The image sensor 600 may include a device capable of detecting incident light, such as a CCD (Charge Coupled Device) or a CMOS (Complementary Metal Oxide Semiconductor).

The optical system 1100, 1200, 1300 or the camera module may include a filter 500. The filter 500 may be arranged between the last lens and the image sensor 600. The filter 500 may be arranged between the lens closest to the sensor-side among the lenses of the lens part and the image sensor 600. For example, the filter 500 may be arranged between the nth lens and the image sensor 600.

The cover glass is placed between the filter 500 and the image sensor 600, and protects the upper part of the image sensor 600 and can prevent the reliability of the image sensor 600 from being deteriorated. The cover glass can be removed. The cover glass may be a protective glass.

The filter 500 may include an infrared filter or an infrared cut-off filter (IR cut-off). The filter 500 may pass light of a set wavelength band and filter light of a different wavelength band. When the filter 500 includes an infrared filter, it may block radiant heat emitted from external light from being transmitted to the image sensor 600. In addition, the filter 500 may transmit visible light and reflect infrared light.

The optical system 1100, 1200, 1300 according to the embodiment may include an aperture STOP. The aperture may adjust the amount of light incident on the optical system 1100, 1200, 1300. In the lenses arranged between the object and the aperture, the clear apearture of the lens surface tends to increase as it goes from the object-side to the aperture. In the lens surfaces arranged between the aperture and the sensor, the clear apearture of the lens surfaces tends to decrease as it goes from the aperture to the sensor-side. The meaning that the clear apearture of the lens surfaces tends to increase or decrease does not only mean the case where the clear apearture of the lens surfaces increases or decreases. For example, it also includes the case where the clear apearture of the lens surfaces increases and then decreases as it goes from the aperture to the sensor.

In the optical system 1100, 1200, 1300 of the second to fourth embodiments, the sum of the refractive indices of the lenses of the lens part may be 9 or more, for example, in the range of 9.5 to 11, and the average of the refractive indices may be in the range of 1.6 to 1.7. The sum of the Abbe's numbers of each of the lenses may be 240 or more, for example, in the range of 240 to 250, and the average of the Abbe's numbers may be 45 or less, for example, in the range of 38 to 42. The sum of the central thicknesses of the entire lens may be 5 mm or more, for example, in the range of 6 mm to 8 mm, and the average of the central thicknesses may be in the range of 1 mm to 1.5 mm. The sum of the center gaps between the lenses on the optical axis OA may be 4 mm or more, for example, in the range of 4 mm to 5 mm, and may be less than the sum of the center thicknesses of the lenses. In addition, the average value of the clear apearture of each lens surface S1-S14 of the lens part may be provided as 3 mm or more, for example, in the range of 3.5 mm to 4.5 mm.

In the optical system according to the second to fourth embodiments of the disclosure, the F number may be 2.4 or less, for example, in the range of 2 to 2.3. The vehicle optical system may have a horizontal field of view (FOV_H) in the Y-axis direction of more than 145 degrees and less than 160 degrees, for example, in the range of 150 degrees to 155 degrees. In addition, the vertical field of view may be provided at a smaller angle than the horizontal field of view. Accordingly, the focus position may be suppressed from changing due to temperature change, and a vehicle camera may be provided in which various aberrations are well corrected.

Since the embodiment is an optical system applied to a vehicle camera, even if a plastic lens and a glass lens are designed together, the first lens 201, 301, 401 may be provided as a glass material. This has the advantage that the glass material is more resistant to scratches than the plastic material and is not sensitive to external temperature. The first lens 201, 301, 401 may be a glass mold lens having an asphere and made of glass material. The glass mold lens may be manufactured by placing an optical glass ingot inside a mold that has an aspherical shape and heating and compressing the optical glass ingot.

In order to more effectively prevent scratches caused by foreign substances or by being placed inside a vehicle, a glass lens may be used as the first lens 201, 301, 401, and the object-side of the first lens 201, 301, 401 may have a gently curved shape so as not to come into contact with external structures. This minimizes the occurrence of scratches due to contact with external structures. The field of view may be more than 145 degrees and less than 155 degrees for driver monitoring, front/rear photography of the vehicle, lane detection, and detection of unexpected objects around the vehicle while the vehicle is being driven, and may be in the range of 150 degrees to 155 degrees, for example. This horizontal field of view may be a preset angle for an advanced driver assistance system (ADAS).

The optical system 1100, 1200, 1300 according to the embodiment may further include a reflective member for changing the path of light. The reflective member may be implemented as a prism that reflects light incident on the optical system 1100, 1200, 1300 toward the lenses. Hereinafter, the optical system according to the embodiment will be described in detail.

The optical system according to the second embodiment of the disclosure will be described.

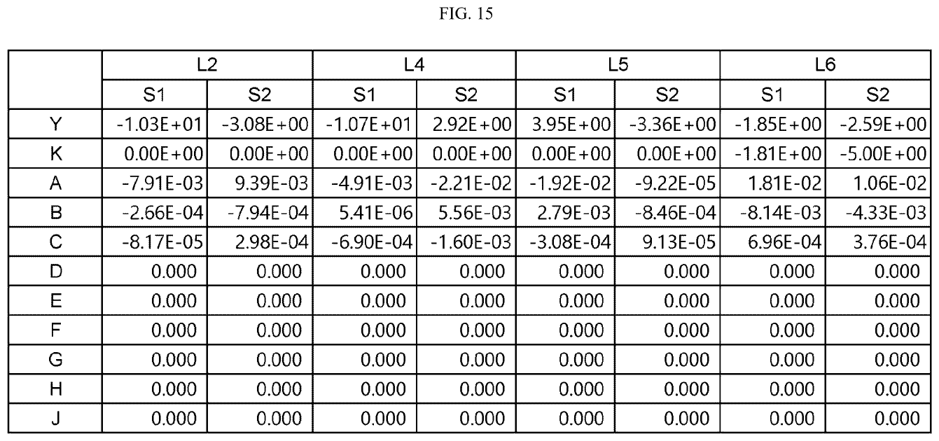

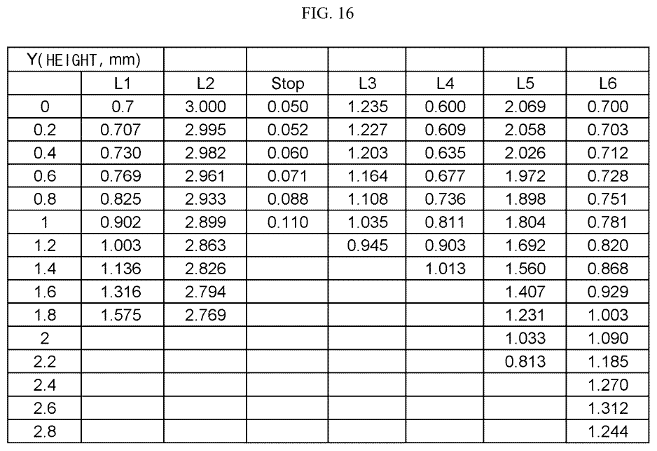

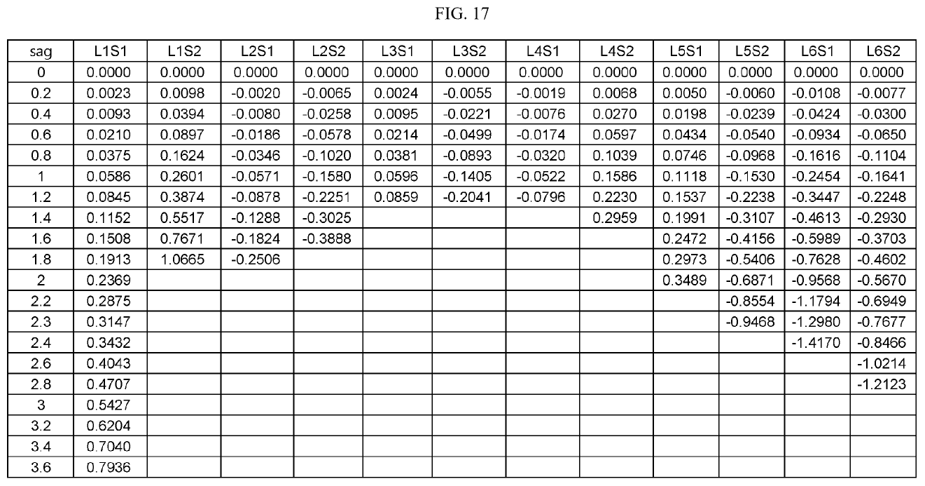

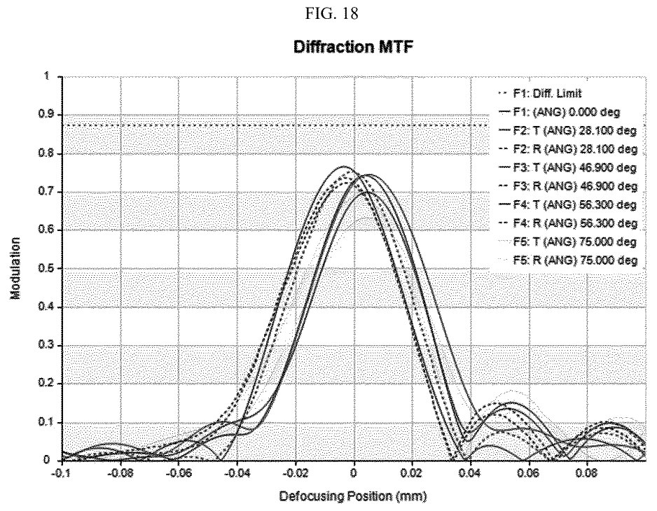

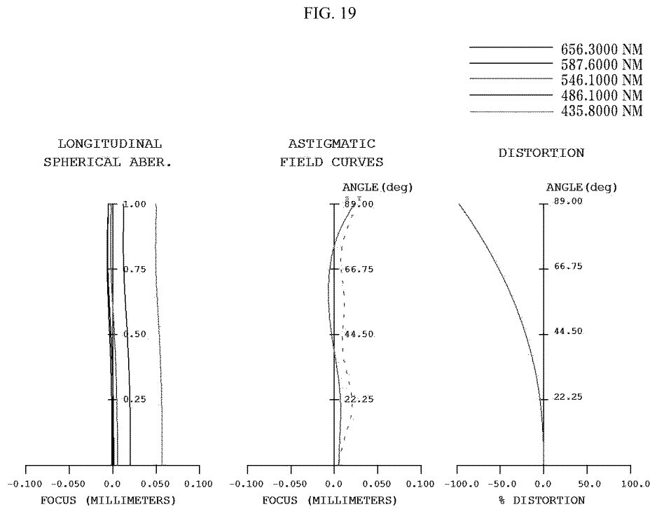

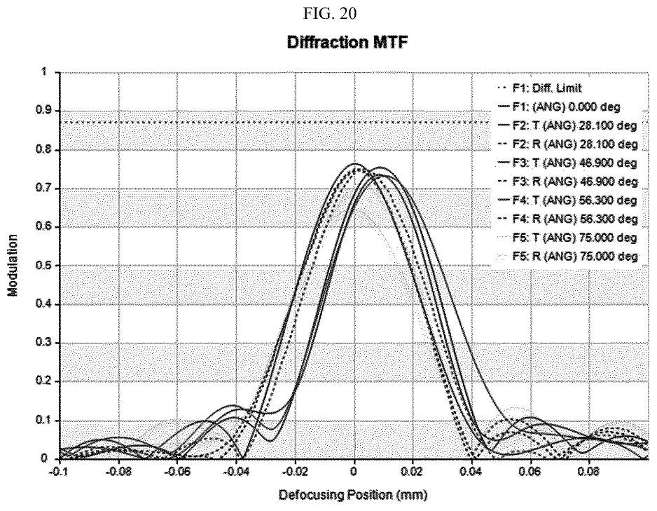

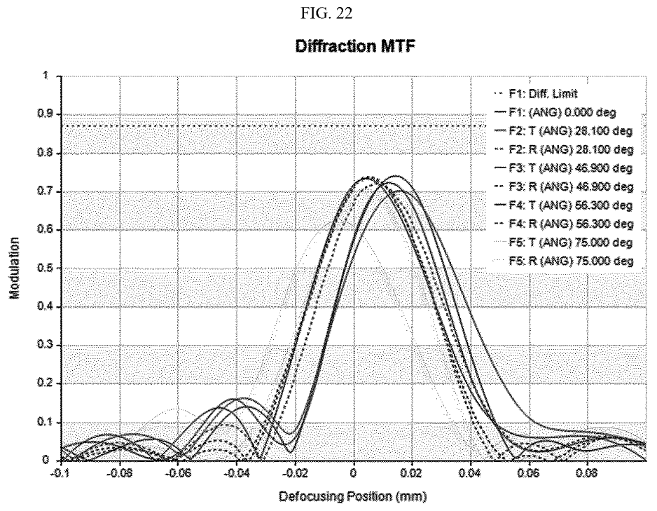

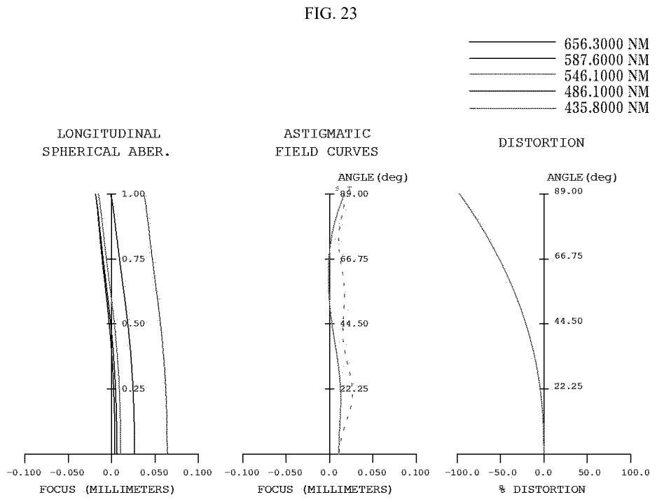

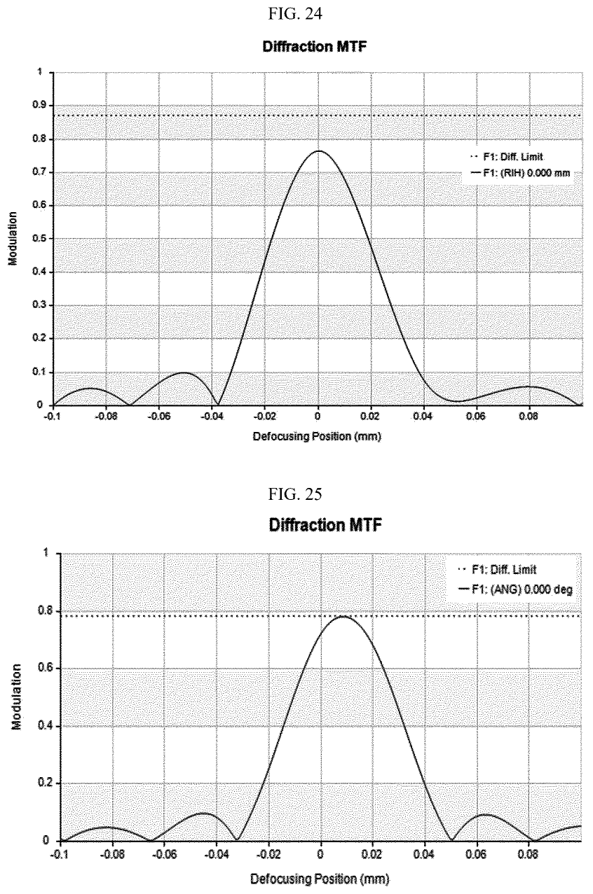

FIG. 14 is a side cross-sectional view of the optical system according to the second embodiment and the camera module having the same, FIG. 15 is a table illustrating the aspherical coefficients of the lenses in the optical system of FIG. 14, FIG. 16 is a table illustrating the thickness of each lens of the optical system of FIG. 14 and the distance between adjacent lenses, FIG. 17 is a table illustrating the Sag values of the lens surfaces of the first to sixth lenses of the optical system of FIG. 14, FIG. 18 is a graph illustrating data on the diffraction MTF (Modulation Transfer Function) of the optical system of FIG. 14 at low temperatures, FIG. 19 is a graph illustrating data on the aberration characteristics of the optical system of FIG. 14 at low temperatures, FIG. 20 is a graph illustrating data on the diffraction MTF of the optical system of FIG. 14 at room temperature, FIG. 21 is a graph illustrating data on the aberration characteristics of the optical system of FIG. 14 at room temperature, FIG. 22 is a graph illustrating data on the diffraction MTF of the optical system of FIG. 14 at high temperature, FIG. 23 is a graph illustrating data on the aberration characteristics of the optical system of FIG. 14 at high temperature, FIG. 24 is a graph illustrating data on the diffraction MTF of the optical system of FIG. 14 at RGB wavelength, and FIG. 25 is a graph illustrating data on the diffraction MTF of the optical system of FIG. 14 at IR wavelength.

Referring to FIG. 14, the optical system 1100 includes a lens part, and the lens part may include a first lens 201 to a sixth lens 206. The first to sixth lenses 201 to 206 may be sequentially arranged along the optical axis OA of the optical system 1100. Light corresponding to information about an object may pass through the first lens 201 to the sixth lens 206 and the filter 500 and be incident on the image sensor 600.

The first lens 201 may be arranged closest to the object-side. The first lens 201 may be arranged farthest from the sensor-side. The first lens 201 may have negative (−) refractive power on the optical axis OA. The first lens 201 may include a plastic material or a glass material, and may be, for example, a glass material. The first lens 201 made of glass can reduce changes in the center position and radius of curvature due to temperature changes in the surrounding environment and may protect the incident side of the optical system 1100.

The first surface S1 on the object-side of the first lens 201 based on the optical axis may be convex, and the second surface S2 on the sensor-side may be concave. The first lens 201 may have a meniscus shape convex toward the object-side. The first lens 201 is made of glass and can have a spherical surface.

The second lens 202 may be further separated from the first lens 201 due to the refractive characteristics of the first lens 201. In other words, the center gap between the first and second lenses 201, 202 may be the largest within the lens part.

The refractive index n1 of the first lens 201 may satisfy the condition of n1>1.8 or n1>1.82. Since the refractive index n1 of the first lens 201 is the largest in the lens part, the radius of curvature of the first and second lenses 201, 202 may be increased, and lens manufacturing may be facilitated. If the refractive index n1 of the first lens 201 is smaller than the condition, the lens surface must be formed sharply concave or convex in order to increase the refractive power of the first and second lenses 201, 202. In this case, lens manufacturing is not easy, the lens defect rate increases, and it may cause a decrease in yield.

The second lens 202 may be arranged second from the object-side. The second lens 202 may be arranged fifth from the sensor-side. The second lens 202 may be arranged between the first lens 201 and the third lens 203. The second lens 202 may have positive (+) refractive power on the optical axis OA. The second lens 202 may include a plastic or glass material. For example, the second lens 202 may be provided as a plastic material.

The third surface S3 on the object-side of the second lens 202 with respect to the optical axis OA may be concave, and the fourth surface S4 on the sensor-side may be convex. The second lens 202 may have a meniscus shape with the sensor-side being convex. The second lens 202 may be made of a plastic material and may be an asphere. At least one or both of the third surface S3 and the fourth surface S4 may be an asphere. The aspherical coefficients of the third and fourth surfaces S3, S4 may be provided as S1 and S2 of L2 of FIG. 15. At least one or both of the third surface S3 and the fourth surface S4 may be provided without a critical point from the optical axis OA to the end of the effective area.

The aperture STOP may be arranged around the sensor-side fourth surface S4 of the second lens 202. The aperture STOP may be arranged around the object-side fifth surface S5 of the third lens 203. The aperture may reduce the TTL within the field of view range, and may enable miniaturization of the optical system. Accordingly, a decrease in the yield by weight of the optical system may be prevented, and production efficiency may be improved. In addition, the optical system may be miniaturized by reducing the TTL within the horizontal field of view (FOV_H) of 130 degrees to 160 degrees.

The third lens 203 may be arranged third from the object-side. The third lens 203 may be arranged fourth from the sensor-side. The third lens 203 may be arranged between the second lens 202 and the fourth lens 204. The third lens 203 may have positive (+) refractive power on the optical axis OA. The third lens 203 may include a plastic or glass material. For example, the third lens 203 may be provided as a glass material.

The fifth surface S5 on the object-side of the third lens 203 with respect to the optical axis may be convex, and the sixth surface S6 on the sensor-side may be convex. The third lens 203 may have a convex shape on both sides. The third lens 203 may be made of glass and may be spherical. At least one or both of the fifth surface S5 and the sixth surface S6 may be spherical. At least one or both of the fifth surface S5 and the sixth surface S6 may be provided without a critical point from the optical axis OA to the end of the effective area.

Since both sides of the third lens 203 are provided convexly, the TTL and the number of lenses of the optical system can be minimized and light can be effectively refracted. In addition, when the radius of curvature of the fifth surface S5 of the third lens 203 is L3R1 and the radius of curvature of the sixth surface S6 is L3R2, the condition of L3R1<L3R2| can be satisfied. Through this, light may be efficiently refracted by the third surface S3, so that the clear apertures of the fourth to sixth lenses 204 to 206 may be guided so as not to increase, and the TTL may be reduced. If L3R1>L3R2|, a lot of aberration may occur on the object-side of the third lens 203, the light refractive efficiency may decrease on the sensor-side, the clear apearture of the rear lenses may increase, and the TTL may also increase.

The fourth lens 204 may be arranged fourth from the object-side. The fourth lens 204 may be arranged third from the sensor-side. The fourth lens 204 may be arranged between the third lens 203 and the fifth lens 205. The fourth lens 204 may have positive (+) or negative (−) refractive power on the optical axis OA. The fourth lens 204 may have negative (−) refractive power. The fourth lens 204 may include a plastic or glass material. For example, the fourth lens 204 may be provided as a plastic material.

The seventh surface S7 on the object-side of the fourth lens 204 with respect to the optical axis may be concave, and the eighth surface S8 on the sensor-side may be concave. The fourth lens 204 may have a concave shape on both sides. The fourth lens 204 is made of a plastic material and may be an asphere. At least one or both of the seventh surface S7 and the eighth surface S8 may be an asphere. The aspherical coefficients of the seventh and eighth surfaces S7, S8 may be provided as S1 and S2 of L4 of FIG. 15. At least one or both of the seventh surface S7 and the eighth surface S8 may be provided without a critical point from the optical axis OA to the end of the effective area.

The fifth lens 205 may be arranged fifth from the object-side. The fifth lens 205 may be arranged second from the sensor-side. The fifth lens 205 may be arranged between the fourth lens 204 and the sixth lens 206. The fifth lens 205 may have positive (+) or negative (−) refractive power on the optical axis OA. The fifth lens 205 may have positive (+) refractive power. The fifth lens 205 may include a plastic or glass material. For example, the fifth lens 205 may be provided with a plastic material.

The fifth lens 205 may have a convex ninth surface S9 on the object-side and a convex tenth surface S10 on the sensor-side based on the optical axis OA. The fifth lens 205 may have a convex shape on both sides. The fifth lens 205 may be made of a plastic material and may be an asphere. At least one or both of the ninth surface S9 and the tenth surface S10 may be an asphere. The aspherical coefficients of the ninth and tenth surfaces S9, S10 may be provided as S1 and S2 of L5 of FIG. 15. At least one or both of the ninth surface S9 and the tenth surface S10 may be provided without a critical point from the optical axis OA to the end of the effective area.

The sixth lens 206 may be arranged furthest from the object-side. The sixth lens 206 may be arranged closest to the image sensor 600. The sixth lens 206 may have positive (+) or negative (−) refractive power on the optical axis OA. The sixth lens 206 may have negative (−) refractive power. The sixth lens 206 may include a plastic or glass material. For example, the sixth lens 206 may be provided as a plastic material.

Based on the optical axis OA, the eleventh surface S11 of the sixth lens 206 on the object-side may be concave, and the twelfth surface S12 on the sensor-side may be convex. The sixth lens 206 may have a meniscus shape with a convex sensor-side. At least one or both of the eleventh surface S11 and the twelfth surface S12 may be an asphere. The aspherical coefficients of the eleventh and twelfth surfaces S11, S12 can be provided as L1 and L2 of L6 of FIG. 15. At least one or both of the eleventh surface S11 and the twelfth surface S12 can be provided without a critical point from the optical axis OA to the end of the effective area.

The sixth lens 206 may be a plastic lens closest to the image sensor 600. In addition, by arranging two or more plastic lenses adjacent to the image sensor 600, aberrations such as spherical aberration and chromatic aberration can be improved by the lens surface having an asphere, and the influence on the resolution may be controlled. In addition, by arranging the plastic lens as the lens adjacent to the image sensor 600, it can be insensitive to the assembly tolerance compared to the glass lens. In other words, being insensitive to the assembly tolerance means that even if the assembly is assembled with a slight difference compared to the design during assembly, it may not significantly affect the optical performance. In addition, by providing two lenses 205, 206 adjacent to the image sensor 600 with plastic material, optical performance can be improved by the lens surface having an asphere, and for example, aberration characteristics can be improved and resolution deterioration can be prevented.

TABLE 16

| | Sur- | | Thick- | | | Semi | Focal |
|---|---|---|---|---|---|---|---|
| Lens | face | Radius | ness | nd | vd | Aperture | length |
| 1 | S1 | 8.563 | 0.700 | 1.8348 | 42.7 | 3.747 | −3.381 |
| | S2 | 2.052 | 1.860 | | | 1.953 | |
| 2 | S3 | −10.260 | 3.000 | 1.6400 | 23.5 | 1.800 | 5.853 |
| | S4 | −3.080 | 0.459 | | | 1.585 | |
| | Stop | infinity | 0.050 | | | 1.180 | |
| 3 | S5 | 8.424 | 1.235 | 1.6780 | 55.5 | 1.180 | 3.887 |
| | S6 | −3.630 | 0.050 | | | 1.300 | |
| 4 | S7 | −10.722 | 0.600 | 1.6800 | 18.1 | 1.336 | −3.268 |
| | S8 | 2.920 | 0.475 | | | 1.541 | |
| 5 | S9 | 3.955 | 2.069 | 1.5350 | 55.8 | 2.028 | 3.750 |
| | S10 | −3.361 | 1.352 | | | 2.302 | |
| 6 | S11 | −1.850 | 0.700 | 1.6800 | 18.1 | 2.387 | −15.329 |
| | S12 | −2.588 | 0.050 | | | 2.806 | |
| Filter | | infinity | 0.300 | | | 3.054 | |
| | | infinity | 0.600 | | | 3.093 | |
| Cover | | infinity | 0.298 | | | 3.210 | |
| Image | | infinity | 0.002 | | | 3.278 | |

Table 16 illustrates the surface number (Surface), radius of curvature (Radius), center thickness of each lens or distance between lens surfaces (Thickness), refractive index (Index, nd), Abbe's number (Abbe, vd), effective radius (Semi Aperture), and focal length (Focal length) of the lens according to the second embodiment of the present disclosure. At this time, the unit of the radius of curvature and thickness or distance may be mm.

TABLE 17

| Item | Value | Item | Value |
|---|---|---|---|
| F | 2.2237 | F-number | 2.20 |
| ET1 | 1.2213 | FOV_H | 150.00 |
| ET2 | 2.9371 | EPD | 1.0411 |
| ET3 | 0.8934 | BFL | 1.2496 |
| ET4 | 1.0756 | TD | 12.0910 |
| ET5 | 0.7774 | ImgH | 7.28 |
| ET6 | 0.8844 | SD | 6.4808 |
| ΣIndex | 10.0478 | TTL | 13.7996 |
| ΣAbbe | 213.7 | GLca_Aver | 4.0897 |
| ΣCT | 8.3044 | PLca_Aver | 3.9462 |
| ΣCG | 4.2456 | CT_max | 3.0000 |
| CA_max | 5.700 | CT_min | 0.600 |
| CA_min | 2.480 | CT_Aver | 1.3841 |
| CA_Aver | 3.994 | RGB_BFL | 1.2416 |
| | | IR_BFL | 1.2510(+0.009) |

Table 17 illustrates the items of the mathematical expressions described above in the optical system 1100 of the second embodiment, including the TTL (Total track length) (mm), BFL (Back focal length), effective focal length (F) (mm), ImgH (mm), clear apearture (CA) (mm), thickness (mm), TTL (mm), TD (mm), which is the optical axis distance from the first surface S1 to the twelfth surface S12, sum of refractive indices, sum of Abbe's numbers, sum of thicknesses (mm), sum of distances between adjacent lenses, clear apearture characteristics, sum of refractive indices of glass lenses, sum of refractive indices of plastic materials, field of view (FOV_H) (Degree), edge thickness (ET), F number, or the like of the optical system 1100.

When the wavelength of light incident on the optical system 1100 changes, a focus shift phenomenon occurs. This phenomenon can be secured by minimizing the focus shift phenomenon for the long wavelength (IR) and visible light (RGB) areas through optical design correction. If design correction for the RGB wavelength and IR wavelength is not performed, a focus shift phenomenon of about 30 μm or more occurs, so the optical performance may not be guaranteed.

Referring to Table 17, the BFL in the RGB wavelength incident on the optical system 1100 according to the second embodiment is 1.2416 um, and the BFL in the IR wavelength is 1.2510 (+0.009) um, and the difference in BFL in the RGB wavelength and the IR wavelength is 0.0094 um, so the focus shift phenomenon is minimized.

Currently, the application of vehicle monitoring lenses is increasing, and the application of visible light (RGB) and infrared (IR) is emerging as the main performance of vehicle monitoring lenses. During the day, visible light can be used to distinguish colors, and at night, infrared can be used to obtain excellent color images and videos as in the daytime. Therefore, the monitoring lens of the vehicle should be able to operate stably during day and night driving, and have higher image quality. The optical lens may be well matched with the visible light (RGB) and infrared (IR) chips mounted on the vehicle, and may realize visible light and infrared confocal to achieve day and night dual-purpose effects.

The center thickness of the first to sixth lenses 201 to 206 is represented by CT1 to CT6, the edge thickness at the end of the effective area of each lens is represented by ET1 to ET6, the center gap between two adjacent lenses is represented by CG1 to CG5, and the edge distance between the edges of each lens is represented by EG1 to EG5. The BFL (Back focal length) is the optical axis distance from the image sensor 600 to the center of the last lens. The TTL is the optical axis distance from the center of the first surface S1 of the first lens 201 to the upper surface of the image sensor 600.

As illustrated in FIG. 15, among the lenses of the lens part of the second embodiment, the lens surfaces of the second, fourth, fifth, and sixth lenses 202, 204, 205, and 206 may include an asphere having a 30th-order asphere coefficient. For example, the second, fourth, fifth, and sixth lenses 202, 204, 205, and 206 may include lens surfaces having a 30th-order aspherical coefficient. As described above, since an asphere having a 30th-order aspherical coefficient (a non-zero value) can significantly change the aspherical shape of the periphery, the optical performance of the periphery of the field of view (FOV) can be well corrected.

The thickness T1-T6 of the first to sixth lenses 201-206 and the distance G1-G5 between adjacent two lenses can be set. As illustrated in FIG. 5, the thickness T1-T6 of each lens in the Y-axis direction can be expressed at distances of 0.1 mm or 0.2 mm or more, and the distance G1-G5 between each lens can be expressed at distances of 0.1 mm or 0.2 mm or more.

When compared in absolute values of the radius of curvature of each lens, the radius of curvature of the seventh surface S7 of the fourth lens 204 on the optical axis OA may be the largest among the lenses, and the radius of curvature of the eleventh surface S11 of the sixth lens 206 may be the smallest among the lenses. The difference between the maximum radius of curvature and the minimum radius of curvature may be 5 times or more, for example, 5.5 times to 6 times.

Since the clear apearture of the plastic lens is smaller than that of the glass lens, the lens placed on the object-side of the plastic lens may have strong refractive power in order to refract light with the plastic lens. In addition, the radius of curvature of the lens surface may be small in order to strengthen the refractive power.

The absolute value of the radius of curvature of the first surface S1 of the first lens 201 may be larger than the absolute value of the radius of curvature of the second surface S2. The absolute value of the radius of curvature of the third surface S3 of the second lens 202 may be larger than the absolute value of the radius of curvature of the fourth surface S4. The absolute value of the radius of curvature of the fifth surface S5 of the third lens 203 may be larger than the absolute value of the radius of curvature of the sixth surface S6. The absolute value of the radius of curvature of the seventh surface S7 of the fourth lens 204 may be greater than the absolute value of the radius of curvature of the eighth surface S8. The absolute value of the radius of curvature of the ninth surface S9 of the fifth lens 205 may be greater than the absolute value of the radius of curvature of the tenth surface S10. The absolute value of the radius of curvature of the eleventh surface S11 of the sixth lens 206 may be smaller than the absolute value of the radius of curvature of the twelfth surface S12.

The ratio of the curvature radii of each lens may satisfy the following conditions.

3.5<|L1R1/L1R2|<4.5 Condition 1:

3<|L2R1/L2R2|<4 Condition 2:

2<|L3R1/L3R2|<3 Condition 3:

3<|L4R1/L4R2|<4 Condition 4:

1<|L5R1/L5R2|<1.5 Condition 5:

0.1<|L6R1/L6R2<1 Condition 6:

When explaining the central thickness CT of the lens based on the optical axis, the central thickness CT2 of the second lens 202 is the largest among the lenses, and the central thickness CT4 of the fourth lens 204 is the smallest among the lenses. The difference between the maximum central thickness and the minimum central thickness among the lenses may be in the range of 2 mm or more and 2.5 mm or less.

The central thickness of each lens may satisfy any one of the conditions below.

CT2,CT3,CT5 >CT1=CT6 >CT4 Condition 1:

CT2>CT1,CT3,CT4,CT5,CT6 Condition 2:

CT2,CT5 >CT3 >CT1,CT4,CT6 Condition 3:

CT1,CT2,CT3,CT5,CT6 >CT4 Condition 4:

CT2 >CT5 >CT1,CT3,CT4,CT6 Condition 5:

If the center gap CG between the lenses is described, the center gap CG1 between the first lens 201 and the second lens 202 may be maximum, and the center gap CG3 between the third and fourth lenses 203, 204 may be minimum. The difference between the maximum center gap and the minimum center gap among the lens distances may be 1 mm or more, for example, in the range of 1.5 mm to 2 mm.

The center gap between each lens may satisfy the following conditions.

CG1 >CG2,CG3,CG4,CG5 Condition 1:

CG1,CG5 >CG2 >CG3,CG4 Condition 2:

CG1,CG2,CG4,CG5 >CG3 Condition 3:

CG1,CG2,CG5 >CG4 >CG3 Condition 4:

CG1 >CG5 >CG2,CG3,CG4 Condition 5:

In terms of the clear apearture, the lens having the maximum clear apearture may be arranged between the first lens 201 closest to the object and the sixth lens 206 closest to the image sensor 600. The lens having the maximum clear apearture may be a glass lens. The lens having the maximum clear apearture may be the first lens 201. Here, the clear apearture is the average of the clear apertures of the object-side and the sensor-side of each lens. The lens surface having the maximum clear apearture may be the first surface S1 of the first lens 201.

The lens having the minimum clear apearture may be a lens arranged between the aperture STOP and the image sensor 600. The lens having the minimum clear apearture may be the third lens 203. The lens surface having the minimum clear apearture may be the fifth surface S5 of the third lens 203. The clear apearture of the lens made of plastic may be smaller than that of the lens made of glass. A plastic lens can be placed adjacent to the image sensor.

The clear apearture of each lens may satisfy any of the following conditions.

CA_L1 >CA_L2,CA_L3,CA_L4,CA_L5,CA_L6 Condition 1:

CA_L1,CA_L5,CA_L6 >CA_L2 >CA_L3,CA_L4 Condition 2:

CA_L1,CA_L2,CA_L4,CA_L5,CA_L6 >CA_L3 Condition 3:

CA_L1,CA_L2,CA_L5,CA_L6 >CA_L4 >CA_L3 Condition 4:

CA_L1,CA_L6 >CA_L5 >CA_L2,CA_L3,CA_L4 Condition 5:

CA_L1 >CA_L6 >CA_L2,CA_L3,CA_L4,CA_L5 Condition 6:

In terms of the refractive index, the refractive index of the first lens 201 is the largest among the lenses and may be greater than 1.8, for example, greater than 1.82. Either or both of the third lens 203 and the sixth lens 206 may have the minimum refractive index among the lenses. For example, the refractive index of the fifth lens 205 may be the minimum among the lenses, and may be less than 1.6, for example, less than 1.55. The difference between the maximum refractive index and the minimum refractive index may be 0.2 or more. By providing a high refractive index lens made of glass closest to an object, and providing a lens adjacent to the glass lens and a lens adjacent to the image sensor 600 as low refractive index lenses made of plastic, the incidence efficiency may be increased, and the refractive power between the glass lens and the plastic lens may be adjusted to guide light to the image sensor 600.

The refractive index of each lens may satisfy any one of the following conditions.

n1 >n2,n3,n4,n5,n6 Condition 1:

n1,n3,n4,n6 >n2 >n5 Condition 2:

n1,n4,n6 >n3 >n2,n5 Condition 3:

n1 >n4=n6 >n2,n3,n5 Condition 4:

n1,n2,n3,n4,n6 >n5 Condition 5:

When comparing the Abbe's numbers, the Abbe's number of the fifth lens 205 is the largest among the lenses and may be 50 or more. The Abbe's numbers of the fourth lens 204 and the sixth lens 206 are the smallest among the lenses and may be 20 or less. The difference between the maximum refractive index and the minimum Abbe's number may be 30 or more. By making the Abbe's number of the third lens 203 arranged in the center of the optical system 1100 the largest and providing the Abbe's number of the sixth lens 206 with a low refractive index adjacent to the image sensor 600 the smallest, the color dispersion of light traveling between the lenses made of glass and plastic can be controlled, and the color dispersion between the lenses made of glass and plastic can be increased to guide it to the image sensor 600.

The Abbe's number of each lens can satisfy any one of the conditions below.

v3,v6 >v1 >v2,v4,v5 Condition 1:

v1,v3,v5 >v2 >v4,v6 Condition 2:

v5 >v3 >v1,v2,v4,v6 Condition 3:

v1,v2,v3,v5 >v4=v6 Condition 4:

v5 >v1,v2,v3,v4,v6 Condition 5:

The focal lengths F1, F4, F6 of the first, fourth, and sixth lenses 201, 204, 206 may have negative (−) signs. The first, fourth, and sixth lenses 201, 204, 206 may have negative (−) refractive powers. The focal lengths F2, F3, F5 of the second, third, and fifth lenses 202, 203, 205 may have positive (+) signs. The second, third, and fifth lenses 202, 203, and 205 may have positive (+) refractive power. The second and third lenses 202, 203 having positive (+) refractive power may be placed on the sensor-side of the first lens 201 having negative (−) refractive power. Through this, light incident from the object-side may move away from the optical axis direction and then gather again on the optical axis direction, thereby forming a stable optical path.

In addition, the fifth lens 205 and the sixth lens 206, which are adjacently arranged lenses, can satisfy the following conditions.

Refractive index of lens with positive refractive power <Refractive index of lens with negative refractive power Condition 1:

Dispersion value of lens with positive refractive power >Dispersion value of lens with negative refractive power Condition 2:

Here, among the plastic lenses, the fifth lens 205 has positive refractive power and the sixth lens 206 has negative refractive power, so according to conditions 1 and 2, the refractive index of the fifth lens 205 is smaller than the refractive index of the sixth lens 206, and the dispersion value of the fifth lens 205 is larger than the dispersion value of the sixth lens 206. Chromatic aberration occurring in the plastic lens can be corrected by the plastic lens. In addition, the fifth lens 205 and the sixth lens 206, which are plastic lenses arranged in series, can compensate for chromatic aberration occurring in the plastic lens by satisfying the refractive index difference of 0.1 or more and 0.15 or less and the Abbe's number difference of 20 or more and 50 or less.

The optical system generates chromatic aberration and corrects chromatic aberration by using a cemented lens or two lenses arranged in series. The lens repeatedly contracts and expands as the temperature changes from low to high. Since the lens characteristics of lenses of the same material change the same amount according to the temperature change, it is effective to correct chromatic aberration between lenses of the same material even if the temperature changes. Therefore, in the second embodiment of the present disclosure, the fifth lens 205 and the sixth lens 206 can be used to correct chromatic aberration occurring in the plastic lens.

When comparing the focal lengths in absolute value, the focal length of the sixth lens 206 is the largest among the lenses, and may be 10 or more and 20 or less. The focal length of the fourth lens 204 is the smallest among the lenses, and the absolute value of the focal length of the fifth lens 205 may be 3 or more and 5 or less.

The absolute value of the focal length of each lens may satisfy any one of the following conditions.

|f2|,|f3|,|f5|,|f6|>|f1|>|f4| Condition 1:

|f6|>|f2|>|f1|,|f3|,|f4|,|f5| Condition 2:

|f2|,f6|>|f3|>|f1|,|f4|,|f5 Condition 3:

|f1|,|f2|,|f3|,|f5|,|f6|>|f4| Condition 4:

|f1|,|f4|>|f5|>|f2|,|f3|,|f6| Condition 5:

|f6|>|f1|,|f2|,|f3|,|f4|,|f5| Condition 6:

The thickness (T1) of the first lens 201 may be such that the difference between the maximum thickness and the minimum thickness is 1.5 times or more, for example, in the range of 1.5 to 1.8 times, and the center thickness CT1 may be minimum and the edge thickness ET1 may be maximum. The thickness T2 of the second lens 202 may be such that the maximum thickness is 1 to 1.2 times the minimum thickness. The second lens 202 may have the center thickness CT2 as maximum and the edge thickness ET2 as minimum. The thickness T3 of the third lens 203 may be maximum at the center and minimum at the edge, and the maximum thickness is in the range of 1.2 to 1.5 times the minimum thickness. The thickness T4 of the fourth lens 204 may be minimum at the center and maximum at the edge, and the maximum thickness is in the range of 1.5 to 2 times the minimum thickness. The thickness T5 of the fifth lens 205 may be maximum at the center and minimum at the edge, and the maximum thickness is in the range of 2.5 to 3 times the minimum thickness. The thickness T6 of the sixth lens 206 may be minimum at the center and maximum at the edge, and the maximum thickness is in the range of 1 to 1.5 times the minimum thickness.

The thickness of each lens may satisfy any one of the conditions below.

0.1<CT1/ET1<1,1.5<ET1/CT1<2 Condition 1:

1<CT2/ET2<1.3,0.8<ET2/CT2<1 Condition 2:

1<CT3/ET3<1.5,0.5<ET3/CT3<1 Condition 3:

0.1<CT4/ET4<1,1.5<ET4/CT4<2 Condition 4:

2.5<CT5/ET5<3,0.1<ET5/CT5<0.5 Condition 5:

0.5<CT6/ET6<1,1.1<ET6/CT6<1.5 Condition 6:

1<ΣCT/ΣET<1.5,0.5<ΣET/ΣCT<1 Condition 7:

Among the distances G1-G6 between lenses, the first distance G1 between the first and second lenses 201, 202 may have a maximum in the center and a minimum in the edge. The second distance G2 between the second and third lenses 202, 203 may have a maximum in the edge and a minimum in the center. The third distance G3 between the third and fourth lenses 203, 204 may have a maximum in the edge and a minimum in the center. The fourth distance G4 between the fourth and fifth lenses 204, 205 may have a maximum in the center and a minimum in the edge. The fifth distance G5 between the fifth and sixth lenses 205, 206 may have a maximum in the center and a minimum in the edge.

FIGS. 18, 20, and 22 are graphs illustrating diffraction MTF (Modulation Transfer Function) at room temperature, low temperature, and high temperature in the optical system of FIG. 14, and are graphs illustrating luminance ratio (modulation) according to spatial frequency. As illustrated in FIGS. 18, 20, and 22, in the second embodiment of the disclosure, the deviation of MTF at low temperature or high temperature based on room temperature may be less than 10%, that is, 7% or less.

FIGS. 19, 21, and 23 are graphs illustrating aberration characteristics at room temperature, low temperature, and high temperature in the optical system of FIG. 14. In the aberration graphs of FIGS. 19, 21, and 23, longitudinal spherical aberration, astigmatic field curves, and distortion are measured. In FIGS. 19, 21, and 23, the X-axis may represent a focal length (mm) and a degree of distortion (%), and the Y-axis may represent the height of the image. In addition, the graph for spherical aberration is a graph for light in wavelength bands of about 435 nm, about 486 nm, about 546 nm, about 587 nm, and about 656 nm, and the graphs for astigmatic field curves, and distortion are graphs for light in wavelength bands of about 546 nm. In the aberration diagrams of FIGS. 19, 21, and 23, it can be interpreted that the closer each curve at room temperature, low temperature, and high temperature is to the Y-axis, the better the aberration correction function is, and it can be seen that the optical system 1100 according to the second embodiment has measurement values close to the Y-axis in almost all areas. In other words, the optical system 1100 according to the second embodiment has improved resolution and may have good optical performance not only in the center but also in the periphery of the field of view (FOV). Here, the low temperature is −20 degrees or lower, for example, in the range of −20 to −40 degrees, the room temperature is in the range of 22 degrees±5 degrees or in the range of 18 degrees to 27 degrees, and the high temperature can be 85 degrees or higher, for example, in the range of 85 degrees to 205 degrees. Accordingly, it can be seen that the decrease in the luminance ratio (modulation) from low to high temperature in FIGS. 19, 21 and 23 is less than 10%, for example, 5% or less, or is almost unchanged.

The optical system of the second embodiment disclosed above can effectively control aberration characteristics such as chromatic aberration and distortion, and may have good optical performance not only at the center but also at the periphery of the field of view (FOV).

The optical system according to the third embodiment of the disclosure will be described.

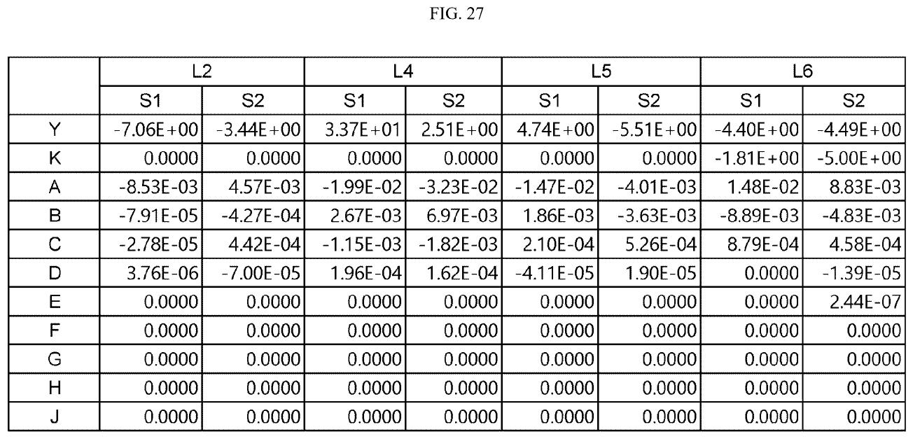

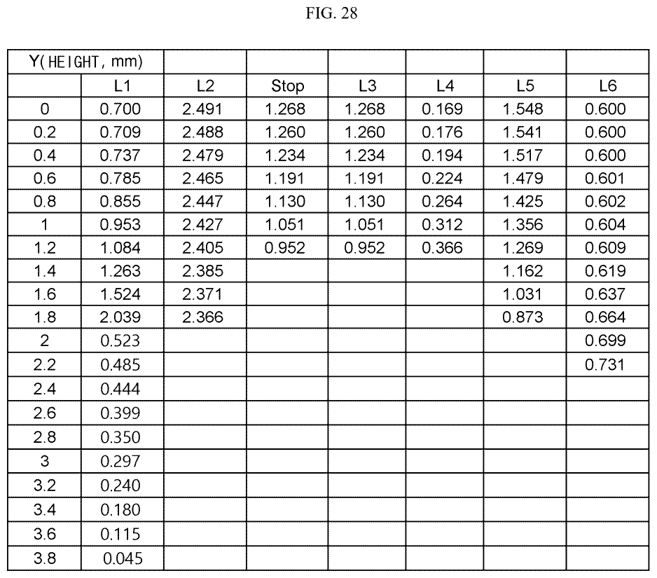

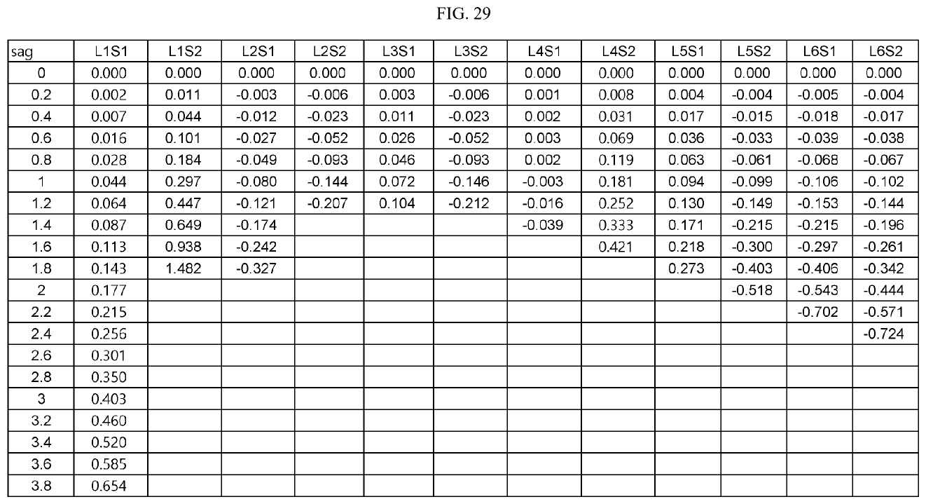

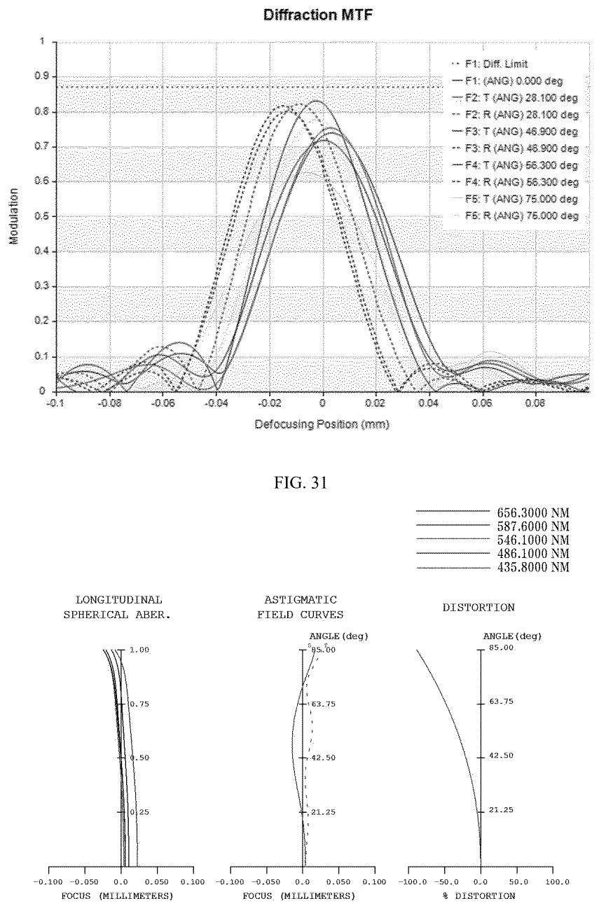

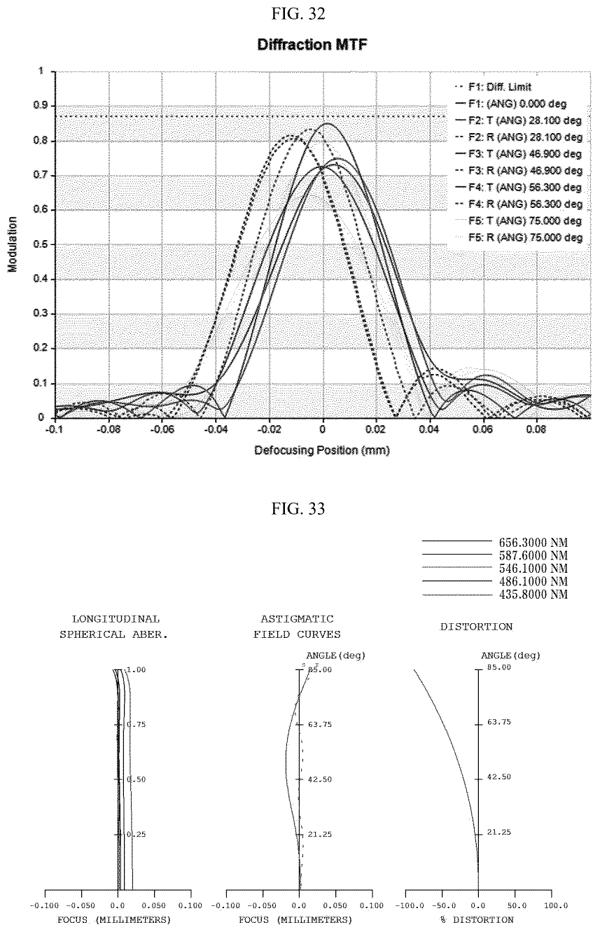

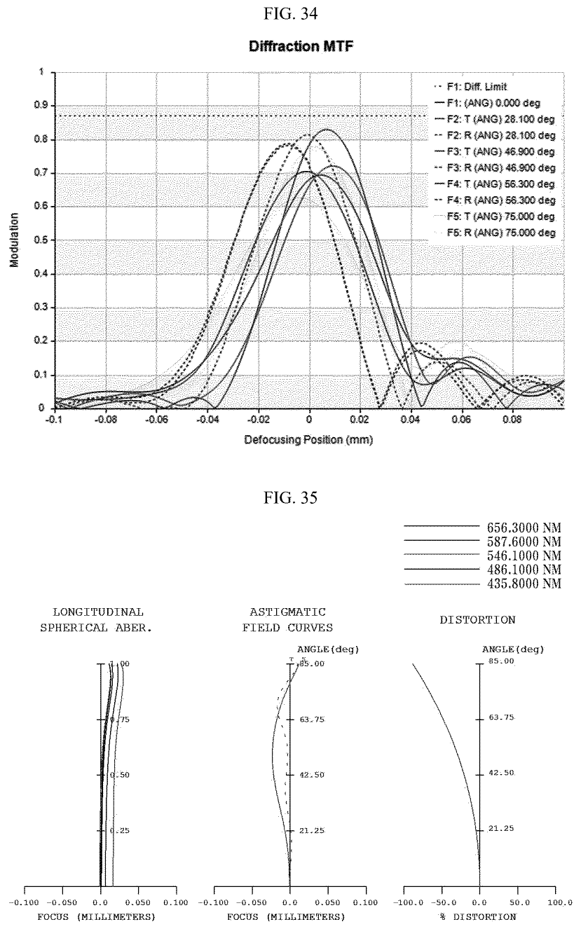

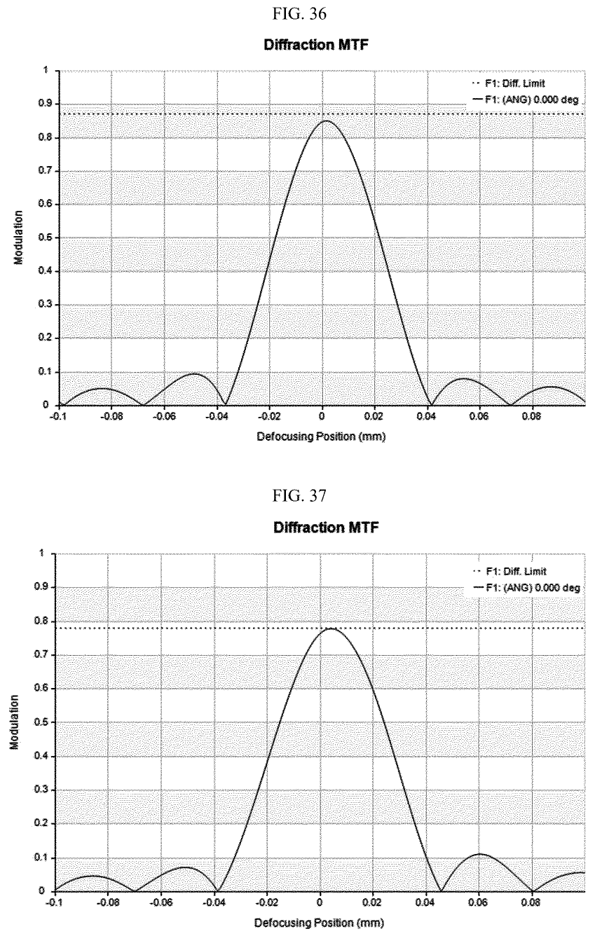

FIG. 26 is a cross-sectional side view of an optical system according to the third embodiment and a camera module having the same, FIG. 27 is a table illustrating aspherical coefficients of lenses in the optical system of FIG. 26, FIG. 28 is a table illustrating the thickness of each lens and the distance between adjacent lenses in the optical system of FIG. 26, FIG. 29 is a table illustrating the Sag values of the lens surfaces of the first to sixth lenses in the optical system of FIG. 26, FIG. 30 is a graph illustrating data on the diffraction MTF (Modulation Transfer Function) at low temperatures of the optical system of FIG. 26, FIG. 31 is a graph illustrating data on the aberration characteristics of the optical system of FIG. 26 at low temperatures, FIG. 32 is a graph illustrating data on the diffraction MTF of the optical system of FIG. 26 at room temperature, FIG. 33 is a graph illustrating data on the aberration characteristics of the optical system of FIG. 26 at room temperature, FIG. 34 is a graph illustrating data on the diffraction MTF of the optical system of FIG. 26 at high temperatures, FIG. 35 is a graph illustrating data on the aberration characteristics of the optical system of FIG. 26 at high temperatures, FIG. 36 is a graph illustrating data on the diffraction MTF of the optical system of FIG. 26 at RGB wavelengths, and FIG. 37 is a graph illustrating data on the diffraction MTF of the optical system of FIG. 26 at IR wavelengths.

Referring to FIG. 26, the optical system 1200 includes a lens part, and the lens part may include a first lens 301 to a sixth lens 306. The first to sixth lenses 301 to 306 may be sequentially arranged along the optical axis OA of the optical system 1200. Light corresponding to information on an object may pass through the first lens 301 to the sixth lens 306 and the filter 500 and be incident on the image sensor 600.

The first lens 301 may be arranged closest to the object-side. The first lens 301 may be positioned furthest from the sensor-side. The first lens 301 may have negative (−) refractive power on the optical axis OA. The first lens 301 may include a plastic material or a glass material, and may be, for example, a glass material. The first lens 301 made of a glass material may reduce changes in the center position and the radius of curvature due to temperature changes according to the surrounding environment, and may protect the incident side of the optical system 1200.

The first surface S1 on the object-side of the first lens 301 based on the optical axis may be convex, and the second surface S2 on the sensor-side may be concave. The first lens 301 may have a meniscus shape convex toward the object-side. The first lens 301 may be made of glass and may have a spherical surface.

Due to the refractive characteristics of the first lens 301, the second lens 302 may be further spaced from the first lens 301. In other words, the center gap between the first and second lenses 301, 302 may be the largest within the lens part.

The second lens 302 may be arranged second from the object-side. The second lens 302 may be arranged fifth from the sensor-side. The second lens 302 may be arranged between the first lens 301 and the third lens 303. The second lens 302 may have a positive refractive power on the optical axis OA. The second lens 302 may include a plastic or glass material. For example, the second lens 302 may be provided as a plastic material.

The third surface S3 on the object-side of the second lens 302 with respect to the optical axis OA may be concave, and the fourth surface S4 on the sensor-side may be convex. The second lens 302 may have a meniscus shape with the sensor-side being convex. The second lens 302 may be made of a plastic material and may be an asphere. At least one or both of the third surface S3 and the fourth surface S4 may be an asphere. The aspherical coefficients of the third and fourth surfaces S3, S4 may be provided as S1 and S2 of L2 of FIG. 27. At least one or both of the third surface S3 and the fourth surface S4 can be provided without a critical point from the optical axis OA to the end of the effective area.

The aperture STOP may be arranged around the sensor-side fourth surface S4 of the second lens 302. The aperture STOP may be arranged around the object-side fifth surface S5 of the third lens 303. The aperture may reduce the TTL within the field of view range, and the optical system may be miniaturized. Accordingly, the yield by weight of the optical system may be prevented from decreasing and the production efficiency may be improved. In addition, the optical system may be miniaturized by reducing the TTL at a horizontal field of view FOV_H of 130 degrees to 160 degrees.

The third lens 303 can be arranged third from the object-side. The third lens 303 can be arranged fourth from the sensor-side. The third lens 303 may be placed between the second lens 302 and the fourth lens 304. The third lens 303 may have positive (+) refractive power on the optical axis OA. The third lens 303 may include a plastic or glass material. For example, the third lens 303 may be provided as a glass material.

The fifth surface S5 on the object-side of the third lens 303 based on the optical axis may be convex, and the sixth surface S6 on the sensor-side may be convex. The third lens 303 may have a shape in which both sides are convex. The third lens 303 is made of glass and may be spherical. At least one or both of the fifth surface S5 and the sixth surface S6 may be spherical. At least one or both of the fifth surface S5 and the sixth surface S6 may be provided without a critical point from the optical axis OA to the end of the effective area.

The fourth lens 304 may be arranged fourth from the object-side. The fourth lens 304 may be arranged third from the sensor-side. The fourth lens 304 may be arranged between the third lens 303 and the fifth lens 305. The fourth lens 304 may have positive (+) or negative (−) refractive power on the optical axis OA. The fourth lens 304 may have negative (−) refractive power. The fourth lens 304 may include a plastic or glass material. For example, the fourth lens 304 may be provided as a plastic material.

The seventh surface S7 on the object-side of the fourth lens 304 based on the optical axis may be convex, and the eighth surface S8 on the sensor-side may be concave. The fourth lens 304 may have a meniscus shape with the object-side being convex. The fourth lens 304 may be made of a plastic material and may be an asphere. At least one or both of the seventh surface S7 and the eighth surface S8 may be an asphere. The aspherical coefficients of the seventh and eighth surfaces S7, S8 may be provided as S1 and S2 of L4 of FIG. 27. At least one or both of the seventh surface S7 and the eighth surface S8 may be provided without a critical point from the optical axis OA to the end of the effective area.

The fifth lens 305 may be arranged fifth from the object-side. The fifth lens 305 may be arranged second from the sensor-side. The fifth lens 305 may be arranged between the fourth lens 304 and the sixth lens 306. The fifth lens 305 may have positive (+) or negative (−) refractive power on the optical axis OA. The fifth lens 305 may have positive (+) refractive power. The fifth lens 305 may include a plastic or glass material. For example, the fifth lens 305 may be provided with a plastic material.

With respect to the optical axis OA, the ninth surface S9 on the object-side of the fifth lens 305 may be convex, and the tenth surface S10 on the sensor-side of the fifth lens 305 may be convex. The fifth lens 305 may have a convex shape on both sides. The fifth lens 305 may be made of a plastic material and may be an asphere. At least one or both of the ninth surface S9 and the tenth surface S10 may be an asphere. Aspherical coefficients of the ninth and tenth surfaces S9, S10 may be provided as S1 and S2 of L5 of FIG. 27. At least one or both of the ninth surface S9 and the tenth surface S10 may be provided without a critical point from the optical axis OA to the end of the effective area.

The sixth lens 306 may be arranged furthest from the object-side. The sixth lens 306 may be arranged closest to the image sensor 600. The sixth lens 306 may have positive (+) or negative (−) refractive power on the optical axis OA. The sixth lens 306 may have positive (+) refractive power. The sixth lens 306 may include a plastic or glass material. For example, the sixth lens 306 may be provided as a plastic material.

Based on the optical axis OA, the eleventh surface S11 of the sixth lens 306 on the object-side may be concave, and the twelfth surface S12 on the sensor-side may be convex. The sixth lens 306 may have a meniscus shape with a convex sensor-side. At least one or both of the eleventh surface S11 and the twelfth surface S12 may be an asphere. The aspherical coefficients of the eleventh and twelfth surfaces S11, S12 may be provided as L1 and L2 of L6 of FIG. 27. At least one or both of the eleventh surface S11 and the twelfth surface S12 may be provided without a critical point from the optical axis GA to the end of the effective area.

The sixth lens 306 may be a plastic lens closest to the image sensor 600. In addition, by arranging two or more plastic lenses adjacent to the image sensor 600, aberrations such as spherical aberration and chromatic aberration can be improved by the lens surface having an asphere, and the influence on the resolution can be controlled. In addition, by arranging the plastic lens as the lens adjacent to the image sensor 600, it can be insensitive to the assembly tolerance compared to a glass lens. In other words, being insensitive to assembly tolerance means that even if the assembly is slightly different from the design during assembly, it may not significantly affect the optical performance. In addition, by providing two lenses 305, 306 adjacent to the image sensor 600 with plastic material, the optical performance can be improved by the lens surface having an asphere, and for example, aberration characteristics can be improved and resolution deterioration can be prevented.

TABLE 18

| | | | | | | Semi | |
|---|---|---|---|---|---|---|---|
| | Sur- | | Thick- | | | Aper- | Focal |
| Lens | face | Radius | ness | nd | vd | ture | length |
| 1 | S1 | 11.367 | 0.700 | 1.6200 | 60.3 | 3.997 | −3.6129 |
| | S2 | 1.834 | 2.064 | | | 1.818 | |
| 2 | S3 | −7.062 | 2.491 | 1.6400 | 23.5 | 1.800 | 8.1590 |
| | S4 | −3.436 | 0.050 | | | 1.364 | |
| | Stop | infinity | 0.446 | | | 1.180 | |
| 3 | S5 | 6.964 | 1.268 | 1.6200 | 60.3 | 1.200 | 3.9215 |
| | S6 | −3.503 | 0.169 | | | 1.300 | |
| 4 | S7 | 33.745 | 0.600 | 1.6800 | 18.1 | 1.376 | −3.9621 |
| | S8 | 2.510 | 0.417 | | | 1.555 | |
| 5 | S9 | 4.736 | 1.548 | 1.5350 | 55.8 | 1.906 | 5.0008 |
| | S10 | −5.508 | 0.555 | | | 2.118 | |
| 6 | S11 | −4.404 | 0.600 | 1.6800 | 18.1 | 2.212 | 185.3455 |
| | S12 | −4.494 | 0.117 | | | 2.452 | |
| Filter | | infinity | 0.300 | | | 2.634 | |
| | | infinity | 0.600 | | | 2.673 | |
| Cover | | infinity | 1.573 | | | 2.796 | |
| Image | | infinity | 0.000 | | | 3.126 | |

Table 18 illustrates the surface number (Surface), radius of curvature (Radius), center thickness of each lens or distance between lens surfaces (Thickness), refractive index (Index, nd), Abbe's number (Abbe, vd), effective radius (Semi Aperture), and focal length (Focal length) of the lens according to the third embodiment of the present disclosure. At this time, the unit of the radius of curvature and thickness or distance may be mm.

TABLE 19

| Item | Value | Item | Value |
|---|---|---|---|
| F | 2.3725 | F-number | 2.2500 |
| ET1 | 1.5603 | FOV_H | 152.0000 |
| ET2 | 2.5017 | EPD | 1.0546 |
| ET3 | 0.9143 | BFL | 2.5905 |
| ET4 | 1.0355 | TD | 10.9092 |
| ET5 | 0.6665 | ImgH | 7.28 |
| ET6 | 0.5448 | SD | 5.1581 |
| ΣIndex | 9.7750 | TTL | 13.4993 |
| ΣAbbe | 236.1100 | GLca_Aver | 4.157619 |
| ΣCT | 7.2078 | PLca_Aver | 3.6955537 |
| ΣCG | 3.7014 | CT_max | 2.4910 |
| CA_max | 5.815 | CT_min | 0.600 |
| CA_min | 2.500 | CT_Aver | 1.3013 |
| CA_Aver | 3.850 | RGB_BFL | 2.591 |
| | | IR_BFL | 2.598(+0.007) |

Table 19 illustrates the items of the mathematical expressions described above in the optical system 1200 of the embodiment, including the TTL (Total track length) (mm), BFL (Back focal length), effective focal length F (mm), ImgH (mm), clear apearture CA (mm), thickness (mm), TTL (mm), TD (mm), which is the optical axis distance from the first surface S1 to the twelfth surface S12, sum of refractive indices, sum of Abbe's numbers, sum of thicknesses (mm), sum of distances between adjacent lenses, clear apearture characteristics, sum of refractive indices of glass lenses, sum of refractive indices of plastic materials, field of view (FOV_H) (Degree), edge thickness ET, F number, or the like of the optical system 1200.

When the wavelength of light incident on the optical system 1200 changes, a focus shift phenomenon occurs. This phenomenon can be secured by minimizing the focus shift phenomenon for the long wavelength IR and visible light RGB areas through optical design correction. If design correction for the RGB wavelength and IR wavelength is not performed, a focus shift phenomenon of about 30 um or more occurs, so the optical performance may not be guaranteed.

Referring to Table 19, the BFL in the RGB wavelength incident on the optical system 1200 according to the third embodiment is 1.2416 um, and the BFL in the IR wavelength is 1.2510 (+0.009) um, and the difference in BFL in the RGB wavelength and the IR wavelength is 0.0094 um, so the focus shift phenomenon is minimized.

Currently, the application of vehicle monitoring lenses is increasing, and the application of visible light RGB and infrared IR is emerging as the main performance of vehicle monitoring lenses. During the day, visible light can be used to distinguish colors, and at night, infrared can be used to obtain excellent color images and videos as in the daytime. Therefore, the monitoring lens of the vehicle should be able to operate stably during day and night driving, and have higher image quality. The optical lens can be well matched with the visible light RGB and infrared IR chips mounted on the vehicle, and can realize visible light and infrared confocal to achieve day and night dual-purpose effects.

The center thickness of the first to sixth lenses 301 to 306 is represented by CT1 to CT6, the edge thickness at the end of the effective area of each lens is represented by ET1 to ET6, the center gap between two adjacent lenses is represented by CG1 to CG5, and the edge distance between the edges of each lens is represented by EG1 to EG5. The BFL (Back focal length) is the optical axis distance from the image sensor 600 to the center of the last lens. The TTL is the optical axis distance from the center of the first surface S1 of the first lens 301 to the upper surface of the image sensor 600.

As illustrated in FIG. 27, among the lenses of the lens part of the third embodiment, the lens surfaces of the second, fourth, fifth, and sixth lenses 302, 304, 305, and 306 may include an asphere having a 30th-order asphere coefficient. For example, the second, fourth, fifth, and sixth lenses 302, 304, 305, and 306 may include lens surfaces having a 30th-order aspherical coefficient. As described above, since an asphere having a 30th-order aspherical coefficient (a non-zero value) can significantly change the aspherical shape of the periphery, the optical performance of the periphery of the field of view FOV can be well corrected.

The thickness T1-T6 of the first to sixth lenses 301-306 and the distance G1-G5 between adjacent two lenses can be set. As illustrated in FIG. 15, the thickness T1-T6 of each lens in the Y-axis direction can be expressed at distances of 0.1 mm or 0.2 mm or more, and the distance G1-G5 between each lens can be expressed at distances of 0.1 mm or 0.2 mm or more.

When comparing the absolute values of the curvature radii of each lens, the curvature radii of the seventh surface S7 of the fourth lens 304 on the optical axis OA may be the largest among the lenses, and the curvature radii of the second surface S2 of the first lens 301 may be the smallest among the lenses. The difference between the maximum curvature radii and the minimum curvature radii may be 25 times or more, for example, 26 to 30 times.

Since the clear apearture of the plastic lens is smaller than that of the glass lens, the lens arranged on the object-side of the plastic lens may have strong refractive power in order to refract light into the plastic lens. In addition, the curvature radii of the lens surface may be small in order to strengthen the refractive power.

The absolute value of the radius of curvature of the first surface S1 of the first lens 301 may be greater than the absolute value of the radius of curvature of the second surface S2. The absolute value of the radius of curvature of the third surface S3 of the second lens 302 may be greater than the absolute value of the radius of curvature of the fourth surface S4. The absolute value of the radius of curvature of the fifth surface S5 of the third lens 303 may be greater than the absolute value of the radius of curvature of the sixth surface S6. The absolute value of the radius of curvature of the seventh surface S7 of the fourth lens 304 may be greater than the absolute value of the radius of curvature of the eighth surface S8. The absolute value of the radius of curvature of the ninth surface S9 of the fifth lens 305 may be less than the absolute value of the radius of curvature of the tenth surface S10. The absolute value of the radius of curvature of the eleventh surface S 11 of the sixth lens 306 may be smaller than the absolute value of the radius of curvature of the twelfth surface S12.

The ratio of the curvature radii of each lens may satisfy the following conditions.

6<|L1R1/L1R2|<6.5 Condition 1:

2<|L2R1/L2R2|<3 Condition 2:

1.5<|L3R1/L3R2|<2.5 Condition 3:

10<|L4R1/L4R2|<15 Condition 4:

0.1<|L5R1/L5R2|<1 Condition 5:

0.1<|L6R1/L6R2|<1 Condition 6:

When explaining the center thickness CT of the lens based on the optical axis, the center thickness CT2 of the second lens 302 is the largest among the lenses, and the center thicknesses CT4, CT6 of the fourth lens 304 and the sixth lens 306 are the smallest among the lenses. The difference between the maximum center thickness and the minimum center thickness among the lenses may be in the range of 2 mm or more and 2.5 mm or less.

The center thickness of each lens may satisfy any one of the conditions below.

CT2,CT3,CT5 >CT1 >CT4,CT6 Condition 1:

CT2>CT1,CT3,CT4,CT5,CT6 Condition 2:

CT2,CT5 >CT3 >CT1,CT4,CT6 Condition 3:

CT1,CT2,CT3,CT5 >CT4=CT6 Condition 4:

CT2 >CT5 >CT1,CT3,CT4,CT6 Condition 5:

If the center gap CG between the lenses is described, the center gap CG1 between the first lens 301 and the second lens 302 may be maximum, and the center gap CG3 between the third and fourth lenses 303, 304 may be minimum. The difference between the maximum center gap and the minimum center gap among the lens distances may be 1 mm or more, for example, in the range of 1.5 mm to 2 mm.

The center gap between each lens may satisfy the following conditions.

CG1 >CG2,CG3,CG4,CG5 Condition 1:

CG1,CG5 >CG2 >CG3,CG4 Condition 2:

CG1,CG2,CG4,CG5 >CG3 Condition 3:

CG1,CG2,CG5 >CG4 >CG3 Condition 4:

CG1 >CG5 >CG2,CG3,CG4 Condition 5:

In terms of the clear apearture, the lens having the maximum clear apearture may be arranged between the first lens 301 closest to the object and the sixth lens 306 closest to the image sensor 600. The lens having the maximum clear apearture may be a glass lens. The lens having the maximum clear apearture may be the first lens 301. Here, the clear apearture is the average of the clear apertures of the object-side and the sensor-side of each lens. The lens surface having the maximum clear apearture may be the first surface S1 of the first lens 301.

The lens having the minimum clear apearture may be a lens arranged between the aperture STOP and the image sensor 600. The lens having the minimum clear apearture may be the third lens 303. The lens surface having the minimum clear apearture may be the fifth surface S5 of the third lens 303. The clear apearture of the lens made of plastic may be smaller than that of the lens made of glass. A plastic lens can be placed adjacent to the image sensor.

The clear apearture of each lens can satisfy any of the following conditions.

CA_L1 >CA_L2,CA_L3,CA_L4,CA_L5,CA_L6 Condition 1:

CA_L1,CA_L5,CA_L6 >CA_L2 >CA_L3,CA_L4 Condition 2:

CA_L1,CA_L2,CA_L4,CA_L5,CA_L6 >CA_L3 Condition 3:

CA_L1,CA_L2,CA_L5,CA_L6 >CA_L4 >CA_L3 Condition 4:

CA_L1,CA_L6 >CA_L5 >CA_L2,CA_L3,CA_L4 Condition 5:

CA_L1 >CA_L6 >CA_L2,CA_L3,CA_L4,CA_L5 Condition 6:

In terms of refractive indices, the refractive indices of the fourth lens 304 and the sixth lens 306 are the largest among the lenses and may be greater than 1.65, for example, greater than 1.67. The fifth lens 305 may have the minimum refractive index among the lenses. For example, the refractive index of the fifth lens 305 may be the minimum among the lenses, and may be less than 1.6, for example, less than 1.55. The difference between the maximum refractive index and the minimum refractive index may be 0.2 or more. By providing a high refractive index lens made of glass closest to the object, and providing a lens adjacent to the glass lens and a lens adjacent to the image sensor 600 as a low refractive index lens made of plastic, the incidence efficiency may be increased, and the refractive power between the glass lens and the plastic lens may be adjusted to guide the image sensor 600.

The refractive index of each lens may satisfy any one of the conditions below.

n2,n4,n6 >n1=n3 >n3,n5 Condition 1:

n4,n6 >n2 >n1,n3,n5 Condition 2:

n4=n6 >n1,n2,n3,n5 Condition 3:

n1,n2,n3,n4,n6 >n5 Condition 4:

When comparing the Abbe's numbers, the Abbe's numbers of the first lens 301 and the third lens 303 are the largest among the lenses and may be 55 or more. The Abbe's numbers of the fourth lens 304 and the sixth lens 306 are the smallest among the lenses and may be 20 or less. The difference between the maximum refractive index and the minimum Abbe's number may be 30 or more. By making the Abbe's number of the third lens 303 arranged in the center of the optical system 1200 the largest and providing the Abbe's number of the sixth lens 306 with a low refractive index adjacent to the image sensor 600 the smallest, the color dispersion of light traveling between the lenses made of glass and plastic may be controlled, and the color dispersion between the lenses made of glass and plastic may be increased and guided to the image sensor 600.

The Abbe's number of each lens can satisfy any one of the following conditions.

v1=v3 >v2,v4,v5,v6 Condition 1:

v1,v3,v5 >v2 >v4,v6 Condition 2:

v1,v2,v3,v5 >v4=v6 Condition 3:

v1,v3 >v5 >v2,v4,v6 Condition 4:

The focal lengths F1, F4 of the first and fourth lenses 301, 304 may have negative (−) signs. The first and fourth lenses 301, 304 may have negative (−) refractive power. The focal lengths F2, F3, F5, F6 of the second, third, fifth, and sixth lenses 302, 303, 305, 306 may have positive (+) signs. The second, third, fifth, and sixth lenses 302, 303, 305, 306 may have positive (+) refractive power. The second and third lenses 302, 303 having positive (+) refractive power may be arranged on the sensor-side of the first lens 301 having negative (−) refractive power. Through this, light incident from the object-side may move away from the optical axis direction and then gather back on the optical axis direction, thereby forming a stable optical path.

When comparing the focal lengths in absolute value, the focal length of the sixth lens 306 is the largest among the lenses, and may be 150 or more and 200 or less. The focal length of the first lens 301 is the smallest among the lenses, and the absolute value of the focal length of the first lens 301 may be 3 or more and 5 or less.

The absolute value of the focal length of each lens may satisfy any one of the following conditions.

|f2|,|f3|,|f4|,|f5|,|f6|>|f1| Condition 1:

|f6|>|f2|>|f1|,|f3|,|f4|,|f5| Condition 2:

|f2|,|f4|,|f5|,|f6|>|f3 |>|f1| Condition 3:

|f2|,|f5|,|f6|>|f4|>|f1|,|f3| Condition 4:

|f2|,|f6|>|f5|>|f1|,|f3|,|f4| Condition 5:

|f6|>|f1|,|f2|,|f3|,|f4|,|f5| Condition 6:

The thickness T1 of the first lens 301 may be a difference of at least twice the maximum thickness and the minimum thickness, for example, in a range of 2 to 2.5 times, and the center thickness CT1 may be a minimum and the edge thickness ET1 may be a maximum. The thickness T2 of the second lens 302 may be a maximum thickness in a range of 1 to 1.2 times the minimum thickness. The second lens 302 may be a minimum in the center thickness CT2 and the maximum in the edge thickness ET2. The thickness T3 of the third lens 303 may be a maximum at the center and a minimum at the edge, and the maximum thickness is in a range of 1.2 to 1.5 times the minimum thickness. The thickness T4 of the fourth lens 304 may be a minimum at the center and a maximum at the edge, and the maximum thickness is in a range of 1.5 to 2 times the minimum thickness. The thickness T5 of the fifth lens 305 may be maximum at the center and minimum at the edge, and the maximum thickness is in the range of 2 to 2.5 times the minimum thickness. The thickness T6 of the sixth lens 306 may be minimum at the center and maximum at the edge, and the maximum thickness is in the range of 1 to 1.5 times the minimum thickness.

The thickness of each lens may satisfy any one of the conditions below.

0.1<CT1/ET1<0.5,2<ET1/CT1<2.5 Condition 1:

0.5<CT2/ET2<1,1<ET2/CT2<1.5 Condition 2:

1<CT3/ET3<1.5,0.5<ET3/CT3<1 Condition 3:

0.1<CT4/ET4<1,1.5<ET4/CT4<2 Condition 4:

2<CT5/ET5<2.5,0.1<ET5/CT5<0.5 Condition 5:

1<CT6/ET6<1.5,0.5<ET6/CT6<1 Condition 6:

0.5<ΣCT/ΣET<1,1<ΣET/ΣCT<1.5 Condition 7:

Between lenses Among the distances G1-G6, the first distance G1 between the first and second lenses 301, 302 may have a maximum in the center and a minimum in the edge. The second distance G2 between the second and third lenses 302, 303 may have a maximum in the edge and a minimum in the center. The third distance G3 between the third and fourth lenses 303, 304 may have a maximum in the edge and a minimum in the center. The fourth distance G4 between the fourth and fifth lenses 304, 305 may have a maximum in the center and a minimum in the edge. The fifth distance G5 between the fifth and sixth lenses 305, 306 may have a maximum in the center and a minimum in the edge.

FIGS. 30, 32, and 34 are graphs illustrating the diffraction MTF (Modulation Transfer Function) at room temperature, low temperature, and high temperature in the optical system of FIG. 26, and are graphs illustrating the luminance ratio (modulation) according to the spatial frequency. As in FIGS. 30, 32, and 34, in the third embodiment of the disclosure, the deviation of the MTF at low temperature or high temperature based on room temperature may be less than 10%, that is, 7% or less.

FIGS. 31, 33, and 35 are graphs illustrating the aberration characteristics at room temperature, low temperature, and high temperature in the optical system of FIG. 26. The graphs of the aberration graphs of FIGS. 31, 33, and 35 are graphs measuring Longitudinal Spherical Aberration, astigmatic field curves, and distortion. In FIGS. 31, 33, and 35, the X-axis may represent a focal length (mm) and a distortion degree (%), and the Y-axis may represent the height of the image. In addition, the graph for spherical aberration is a graph for light having a wavelength band of about 435 nm, about 486 nm, about 546 nm, about 587 nm, and about 656 nm, and the graph for astigmatic field curves and distortion is a graph for light having a wavelength band of about 546 nm. In the aberration diagrams of FIGS. 31, 33, and 35, it can be interpreted that the closer the respective curves at room temperature, low temperature, and high temperature are to the Y-axis, the better the aberration correction function is. It can be seen that the optical system 1200 according to the third embodiment has measurement values close to the Y-axis in almost all areas. In other words, the optical system 1200 according to the third embodiment has improved resolution and may have good optical performance not only in the center but also in the periphery of the field of view (FOV). Here, the low temperature is −20 degrees or lower, for example, in the range of −20 to −40 degrees, the room temperature is in the range of 22 degrees±5 degrees or in the range of 18 degrees to 27 degrees, and the high temperature can be 85 degrees or higher, for example, in the range of 85 degrees to 305 degrees. Accordingly, it can be seen that the decrease in the luminance ratio (modulation) from the low temperature to the high temperature of FIGS. 31, 33, and 35 is less than 10%, for example, 5% or lower, or is hardly changed.

The optical system of the third embodiment disclosed above can effectively control aberration characteristics such as chromatic aberration and distortion, and may have good optical performance not only at the center but also at the periphery of the field of view (FOV_H).

The optical system according to the fourth embodiment of the disclosure will be described.

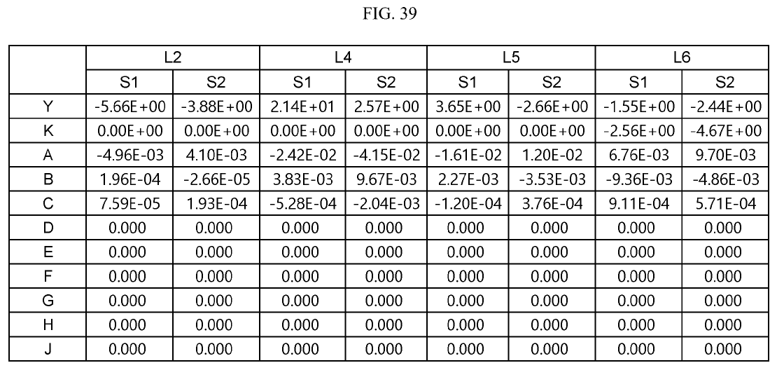

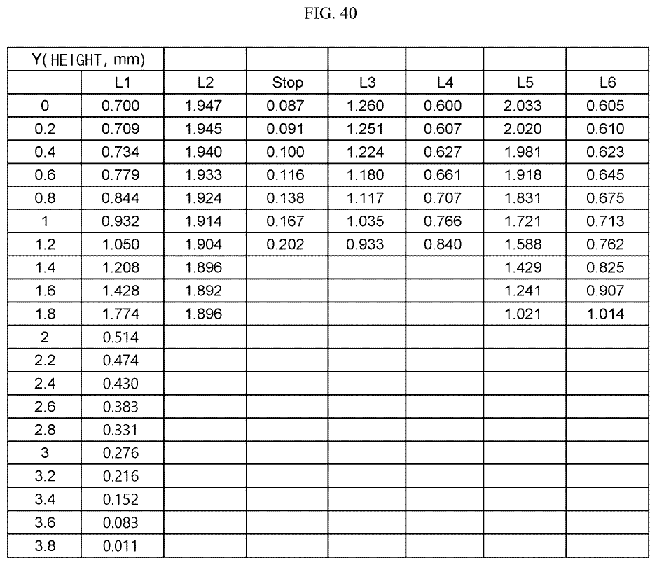

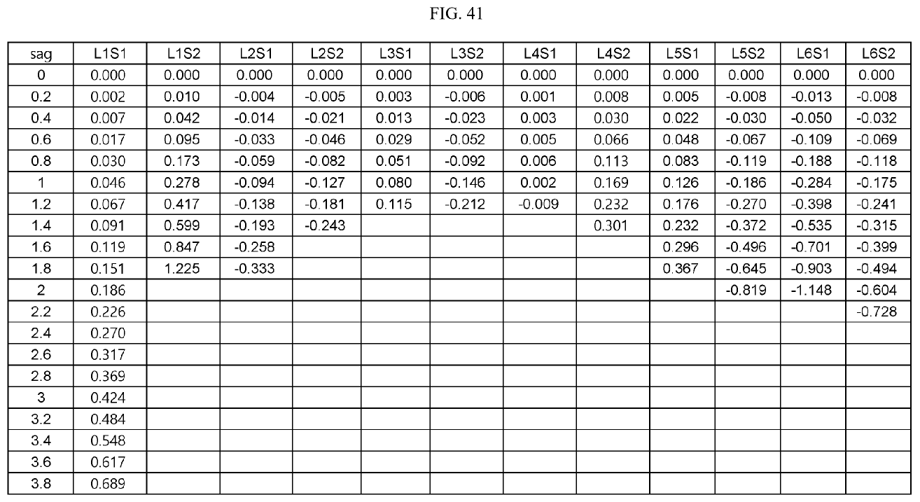

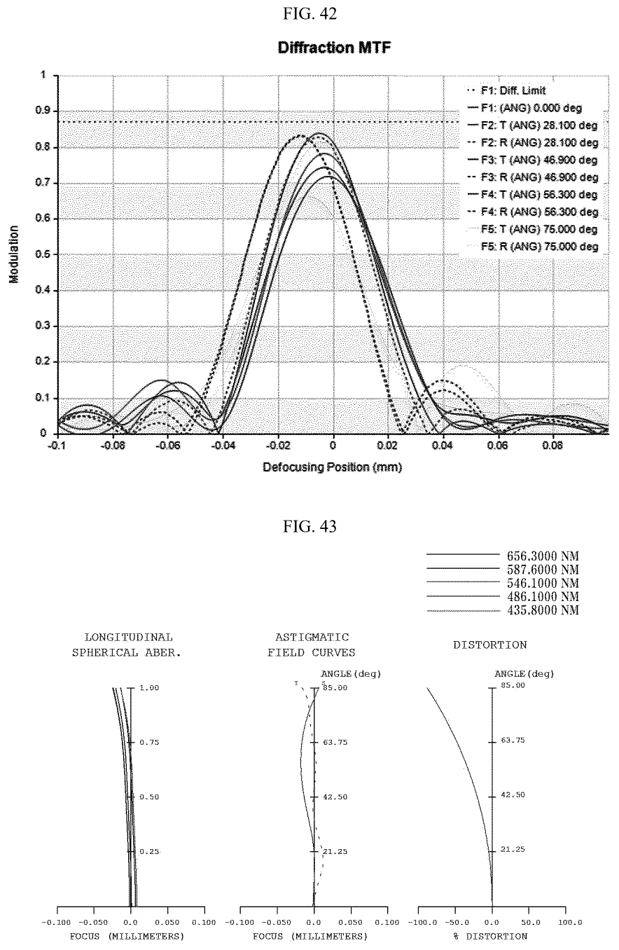

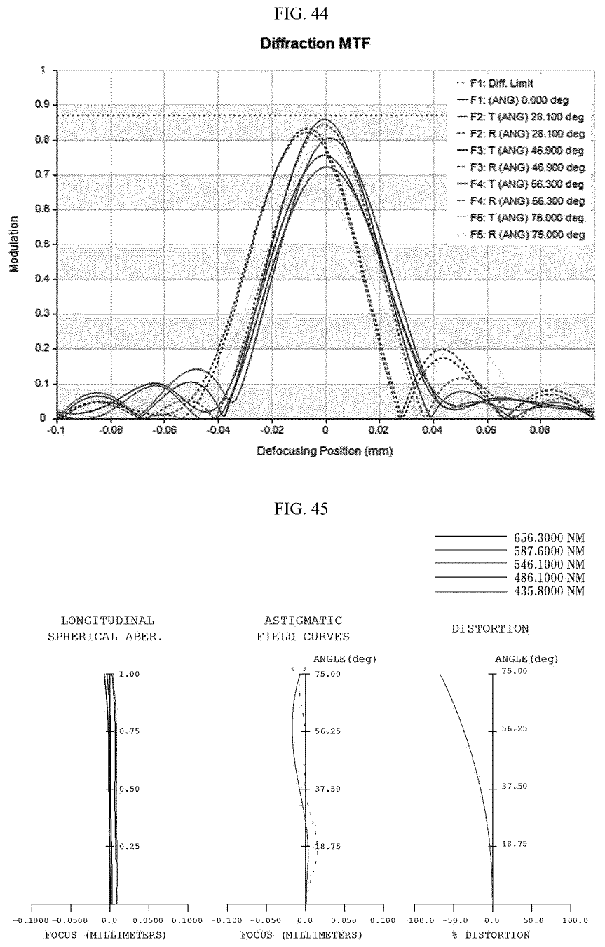

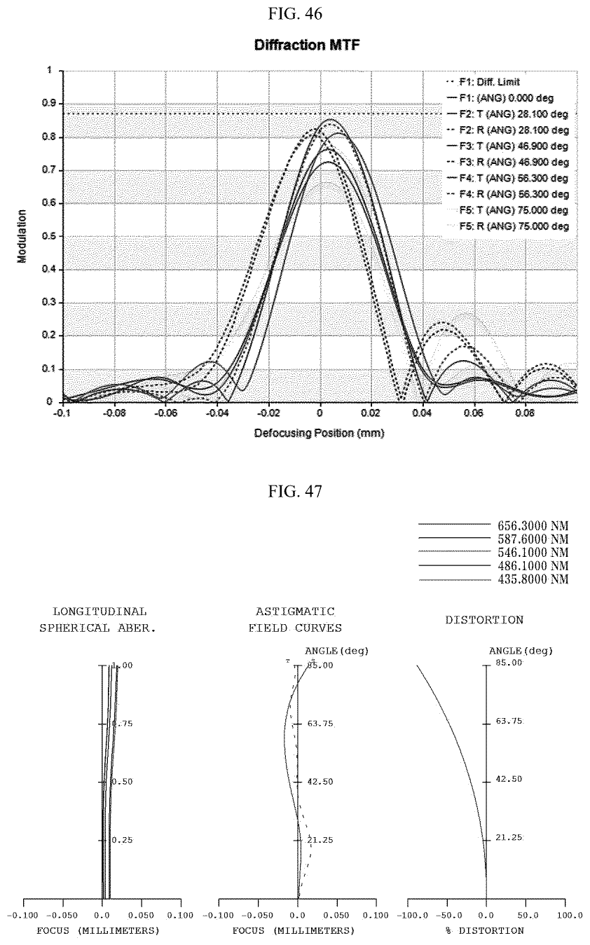

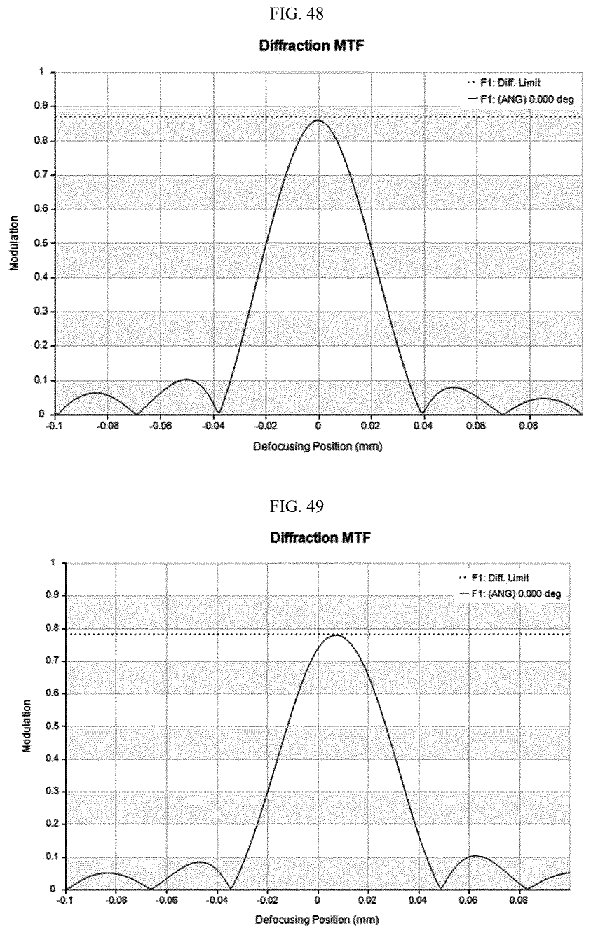

FIG. 38 is a cross-sectional side view of an optical system according to the fourth embodiment and a camera module having the same, FIG. 39 is a table illustrating aspherical coefficients of lenses in the optical system of FIG. 38, FIG. 40 is a table illustrating the thickness of each lens of the optical system of FIG. 38 and the distance between adjacent lenses, FIG. 41 is a table illustrating the Sag values of the lens surfaces of the first to sixth lenses in the optical system of FIG. 38, FIG. 42 is a graph illustrating data on the diffraction MTF (Modulation Transfer Function) of the optical system of FIG. 38 at low temperatures, FIG. 43 is a graph illustrating data on the aberration characteristics of the optical system of FIG. 38 at low temperatures, FIG. 44 is a graph illustrating data on the diffraction MTF of the optical system of FIG. 38 at room temperature, FIG. 45 is a graph illustrating data on the aberration characteristics of the optical system of FIG. 38 at room temperature, FIG. 46 is a graph illustrating data on the diffraction MTF of the optical system of FIG. 38 at high temperatures, FIG. 47 is a graph illustrating data on the aberration characteristics of the optical system of FIG. 38 at high temperatures, FIG. 48 is a graph illustrating data on the diffraction MTF of the optical system of FIG. 38 at RGB wavelengths, and FIG. 49 is a graph illustrating data on the diffraction MTF at the IR wavelength of the optical system of FIG. 38.

Referring to FIG. 38, the optical system 1300 includes a lens part, and the lens part may include a first lens 401 to a sixth lens 406. The first to sixth lenses 401 to 406 may be sequentially arranged along the optical axis OA of the optical system 1300. Light corresponding to information on an object may pass through the first lens 401 to the sixth lens 406 and the filter 500 and be incident on the image sensor 600.

The first lens 401 may be arranged closest to the object-side. The first lens 401 may be positioned furthest from the sensor-side. The first lens 401 may have negative (−) refractive power on the optical axis OA. The first lens 401 may include a plastic material or a glass material, and may be, for example, a glass material. The first lens 401 made of a glass material may reduce changes in the center position and the radius of curvature due to temperature changes according to the surrounding environment, and may protect the incident side of the optical system 1300.

The first surface S1 on the object-side of the first lens 401 based on the optical axis may be convex, and the second surface S2 on the sensor-side may be concave. The first lens 401 may have a meniscus shape convex toward the object-side. The first lens 401 may be made of glass and may have a spherical surface.

The second lens 402 may be further separated from the first lens 401 due to the refractive characteristics of the first lens 401. In other words, the center gap between the first and second lenses 401, 402 may be the largest within the lens part.

The refractive index n1 of the first lens 401 may satisfy the condition of n1>1.55 or n1>1.6. Since the refractive index n1 of the first lens 401 is the largest in the lens part, the radius of curvature of the first and second lenses 401, 402 can be increased, and lens manufacturing can be facilitated. If the refractive index n1 of the first lens 401 is smaller than the condition, the lens surface must be formed sharply concave or convex in order to increase the refractive power of the first and second lenses 401, 402, and in this case, lens manufacturing is not easy, the lens defect rate increases, and it can cause a decrease in yield.

The second lens 402 can be arranged second from the object-side. The second lens 402 can be arranged fifth from the sensor-side. The second lens 402 can be arranged between the first lens 401 and the third lens 403. The second lens 402 can have positive (+) refractive power on the optical axis OA. The second lens 402 may include a plastic or glass material. For example, the second lens 402 may be provided as a plastic material.

The third surface S3 on the object-side of the second lens 402 with respect to the optical axis OA may be concave, and the fourth surface S4 on the sensor-side may be convex. The second lens 402 may have a meniscus shape with the sensor-side being convex. The second lens 402 may be made of a plastic material and may be an asphere. At least one or both of the third surface S3 and the fourth surface S4 may be an asphere. The aspherical coefficients of the third and fourth surfaces S3, S4 may be provided as S1 and S2 of L2 of FIG. 39. At least one or both of the third surface S3 and the fourth surface S4 may be provided without a critical point from the optical axis OA to the end of the effective area.

The aperture STOP may be arranged around the sensor-side fourth surface S4 of the second lens 402. The aperture STOP may be arranged around the object-side fifth surface S5 of the third lens 403. The aperture may reduce the TTL within the field of view range, and may enable miniaturization of the optical system. Accordingly, a decrease in the yield by weight of the optical system may be prevented, and production efficiency may be improved. In addition, the optical system may be miniaturized by reducing the TTL within the horizontal field of view (FOV_H) of 130 degrees to 160 degrees.

The third lens 403 may be arranged third from the object-side. The third lens 403 may be arranged fourth from the sensor-side. The third lens 403 may be arranged between the second lens 402 and the fourth lens 404. The third lens 403 may have positive (+) refractive power on the optical axis OA. The third lens 403 may include a plastic or glass material. For example, the third lens 403 may be provided as a glass material.

The fifth surface S5 on the object-side of the third lens 403 with respect to the optical axis may be convex, and the sixth surface S6 on the sensor-side may be convex. The third lens 403 may have a convex shape on both sides. The third lens 403 may be made of glass and may be spherical. At least one or both of the fifth surface S5 and the sixth surface S6 may be spherical. At least one or both of the fifth surface S5 and the sixth surface S6 may be provided without a critical point from the optical axis OA to the end of the effective area.

The fourth lens 404 may be arranged fourth from the object-side. The fourth lens 404 may be arranged third from the sensor-side. The fourth lens 404 may be arranged between the third lens 403 and the fifth lens 405. The fourth lens 404 may have positive (+) or negative (−) refractive power on the optical axis OA. The fourth lens 404 may have negative (−) refractive power. The fourth lens 404 may include a plastic or glass material. For example, the fourth lens 404 may be provided with a plastic material.

The seventh surface S7 on the object-side of the fourth lens 404 based on the optical axis may be convex, and the eighth surface S8 on the sensor-side may be concave. The fourth lens 404 may have a meniscus shape with the object-side being convex. The fourth lens 404 may be made of a plastic material and may be an asphere. At least one or both of the seventh surface S7 and the eighth surface S8 may be an asphere. The aspherical coefficients of the seventh and eighth surfaces S7, S8 may be provided as S1 and S2 of L4 of FIG. 39. At least one or both of the seventh surface S7 and the eighth surface S8 may be provided without a critical point from the optical axis OA to the end of the effective area.

The fifth lens 405 may be arranged fifth from the object-side. The fifth lens 405 may be arranged second from the sensor-side. The fifth lens 405 may be arranged between the fourth lens 404 and the sixth lens 406. The fifth lens 405 may have positive (+) or negative (−) refractive power on the optical axis OA. The fifth lens 405 may have positive (+) refractive power. The fifth lens 405 may include a plastic or glass material. For example, the fifth lens 405 may be provided as a plastic material.

Based on the optical axis OA, the ninth surface S9 on the object-side of the fifth lens 405 may be convex, and the tenth surface S10 on the sensor-side may be convex. The fifth lens 405 may have a convex shape on both sides. The fifth lens 405 may be made of a plastic material and may be an asphere. At least one or both of the ninth surface S9 and the tenth surface S10 may be an asphere. The aspheric coefficients of the ninth and tenth surfaces S9, S10 can be provided as S1 and S2 of L5 in FIG. 39. At least one or both of the ninth surface S9 and the tenth surface S10 can be provided without a critical point from the optical axis OA to the end of the effective area.

The sixth lens 406 may be arranged furthest from the object-side. The sixth lens 406 may be arranged closest to the image sensor 600. The sixth lens 406 may have positive (+) or negative (−) refractive power on the optical axis OA. The sixth lens 406 may have negative (−) refractive power. The sixth lens 406 may include a plastic or glass material. For example, the sixth lens 406 may be provided as a plastic material.

Based on the optical axis OA, the eleventh surface S11 of the sixth lens 406 on the object-side may be concave, and the twelfth surface S12 on the sensor-side may be convex. The sixth lens 406 may have a meniscus shape with a convex sensor-side. At least one or both of the eleventh surface S11 and the twelfth surface S12 may be an asphere. The aspherical coefficients of the eleventh and twelfth surfaces S11, S12 may be provided as L1 and L2 of L6 of FIG. 39. At least one or both of the eleventh surface S 11 and the twelfth surface S12 may be provided without a critical point from the optical axis OA to the end of the effective area.

The sixth lens 406 may be a plastic lens closest to the image sensor 600. In addition, by arranging two or more plastic lenses adjacent to the image sensor 600, aberrations such as spherical aberration and chromatic aberration can be improved by the lens surface having an asphere, and the influence on the resolution can be controlled. In addition, by arranging the plastic lens as the lens adjacent to the image sensor 600, it can be insensitive to the assembly tolerance compared to a glass lens. In other words, being insensitive to assembly tolerance means that even if the assembly is slightly different from the design during assembly, it may not significantly affect the optical performance. In addition, by providing two lenses 405, 406 adjacent to the image sensor 600 with plastic material, the optical performance can be improved by the lens surface having an asphere, and for example, aberration characteristics can be improved and resolution deterioration can be prevented.

TABLE 20

| | Sur- | | Thick- | | | Semi | Focal |
|---|---|---|---|---|---|---|---|
| Lens | face | Radius | ness | nd | vd | Aperture | length |
| 1 | S1 | 10.819 | 0.700 | 1.62 | 60.3 | 4.312 | −3.9011 |
| | S2 | 1.935 | 2.311 | | | 1.929 | |
| 2 | S3 | −5.661 | 1.947 | 1.64 | 23.5 | 1.800 | 13.3457 |
| | S4 | −3.879 | 0.568 | | | 1.583 | |
| | Stop | infinity | 0.087 | | | 1.150 | |
| 3 | S5 | 6.328 | 1.260 | 1.589 | 61.2 | 1.204 | 4.0052 |
| | S6 | −3.506 | 0.074 | | | 1.300 | |
| 4 | S7 | 21.420 | 0.600 | 1.64 | 23.5 | 1.376 | −4.5802 |
| | S8 | 2.571 | 0.408 | | | 1.585 | |
| 5 | S9 | 3.651 | 2.033 | 1.535 | 55.8 | 2.003 | 3.2282 |
| | S10 | −2.664 | 0.666 | | | 2.140 | |
| 6 | S11 | −1.553 | 0.605 | 1.68 | 18.1 | 2.068 | −8.6201 |
| | S12 | −2.437 | 0.050 | | | 2.451 | |
| Filter | | infinity | 0.300 | | | 2.670 | |
| | | infinity | 0.600 | | | 2.715 | |
| Cover | | infinity | 1.291 | | | 2.855 | |
| Image | | infinity | 0.000 | | | 3.157 | |

Table 20 illustrates the surface number (Surface), radius of curvature (Radius), center thickness of each lens or distance between lens surfaces (Thickness), refractive index (Index, nd), Abbe's number (Abbe, vd), effective radius (Semi Aperture), and focal length (Focal length) of a lens according to the fourth embodiment of the present disclosure. At this time, the unit of the radius of curvature and thickness or distance may be mm.

TABLE 21

| Item | Value | Item | Value |
|---|---|---|---|
| F | 2.3345 | F-number | 2.23 |
| ET1 | 1.5873 | FOV_H | 152.0 |
| ET2 | 1.9753 | EPD | 1.0449 |
| ET3 | 0.8944 | BFL | 2.2413 |
| ET4 | 0.9953 | TD | 11.2593 |
| ET5 | 0.6385 | ImgH | 7.28 |
| ET6 | 0.9478 | SD | 5.7336 |
| ΣIndex | 9.7040 | TTL | 13.5002 |
| ΣAbbe | 242.45 | GLca_Aver | 4.372 |
| ΣCT | 7.1445 | PLca_Aver | 3.751 |
| ΣCG | 4.1073 | CT_max | 2.0330 |
| CA_max | 6.242 | CT_min | 0.600 |
| CA_min | 2.504 | CT_Aver | 1.1908 |
| CA_Aver | 3.959 | RGB_BFL | 2.241 |
| | | IR_BFL | 2.249(+0.008) |

Table 21 illustrates the items of the mathematical expressions described above in the optical system 1300 of the fourth embodiment, including the TTL (Total track length) (mm), BFL (Back focal length), effective focal length F (mm), ImgH (mm), clear apearture CA (mm), thickness (mm), TTL (mm), TD (mm), which is the optical axis distance from the first surface S1 to the twelfth surface S12, sum of refractive indices, sum of Abbe's numbers, sum of thicknesses (mm), sum of distances between adjacent lenses, clear apearture characteristics, sum of refractive indices of glass lenses, sum of refractive indices of plastic materials, field of view (FOV_D) (Degree), edge thickness ET, F number, or the like of the optical system 1300.

When the wavelength of light incident on the optical system 1300 changes, a focus shift phenomenon occurs. This phenomenon can be secured by minimizing the focus shift phenomenon for the long wavelength IR and visible light RGB areas through optical design correction. If design correction for the RGB wavelength and IR wavelength is not performed, a focus shift phenomenon of about 30 um or more occurs, so the optical performance may not be guaranteed.

Referring to Table 21, the BFL in the RGB wavelength incident on the optical system 1300 according to the fourth embodiment is 2.241 um, and the BFL in the IR wavelength is 2.249 (+0.008) um, and the difference in BFL in the RGB wavelength and the IR wavelength is 0.008 um, so the focus shift phenomenon is minimized.

Currently, the application of vehicle monitoring lenses is increasing, and the application of visible light RGB and infrared IR is emerging as the main performance of vehicle monitoring lenses. During the day, visible light can be used to distinguish colors, and at night, infrared can be used to obtain excellent color images and videos as in the daytime. Therefore, the monitoring lens of the vehicle should be able to operate stably during day and night driving, and have higher image quality. The optical lens can be well matched with the visible light RGB and infrared IR chips mounted on the vehicle, and can realize visible light and infrared confocal to achieve day and night dual-purpose effects.

The center thickness of the first to sixth lenses 401 to 406 is represented by CT1 to CT6, the edge thickness at the end of the effective area of each lens is represented by ET1 to ET6, the center gap between two adjacent lenses is represented by CG1 to CG5, and the edge distance between the edges of each lens is represented by EG1 to EG5. The BFL (Back focal length) is the optical axis distance from the image sensor 600 to the center of the last lens. The TTL is the optical axis distance from the center of the first surface S1 of the first lens 401 to the upper surface of the image sensor 600.

As illustrated in FIG. 39, among the lenses of the lens part of the fourth embodiment, the lens surfaces of the second, fourth, fifth, and sixth lenses 402, 404, 405, and 406 may include an asphere having a 30th-order asphere coefficient. For example, the second, fourth, fifth, and sixth lenses 402, 404, 405, and 406 may include lens surfaces having a 30th-order aspherical coefficient. As described above, since an asphere having a 30th-order aspherical coefficient (a non-zero value) can significantly change the aspherical shape of the periphery, the optical performance of the periphery of the field of view FOV can be well corrected.

The thickness T1-T6 of the first to sixth lenses 401-406 and the distance G1-G5 between adjacent two lenses can be set. As illustrated in FIG. 40, the thickness T1-T6 of each lens in the Y-axis direction can be expressed at distances of 0.1 mm or 0.2 mm or more, and the distance G1-G5 between each lens can be expressed at distances of 0.1 mm or 0.2 mm or more.

When comparing the absolute values of the curvature radii of each lens, the curvature radii of the seventh surface S7 of the fourth lens 404 on the optical axis OA may be the largest among the lenses, and the curvature radii of the eleventh surface S11 of the sixth lens 406 may be the smallest among the lenses. The difference between the maximum curvature radii and the minimum curvature radii may be 5 times or more, for example, 5.5 to 6 times.

Since the clear apearture of the plastic lens is smaller than that of the glass lens, the lens arranged on the object-side of the plastic lens may have strong refractive power in order to refract light into the plastic lens. In addition, the curvature radii of the lens surfaces may be small in order to strengthen the refractive power.

The absolute value of the curvature radii of the first surface S1 of the first lens 401 may be larger than the absolute value of the curvature radii of the second surface S2. The absolute value of the radius of curvature of the third surface S3 of the second lens 402 may be greater than the absolute value of the radius of curvature of the fourth surface S4. The absolute value of the radius of curvature of the fifth surface S5 of the third lens 403 may be greater than the absolute value of the radius of curvature of the sixth surface S6. The absolute value of the radius of curvature of the seventh surface S7 of the fourth lens 404 may be greater than the absolute value of the radius of curvature of the eighth surface S8. The absolute value of the radius of curvature of the ninth surface S9 of the fifth lens 405 may be greater than the absolute value of the radius of curvature of the tenth surface S10. The absolute value of the radius of curvature of the eleventh surface S11 of the sixth lens 406 may be less than the absolute value of the radius of curvature of the twelfth surface S12.

The ratio of the radius of curvature of each lens can satisfy the following conditions.

6<|L1R1/L1R2|<6.5 Condition 1:

1.8<|L2R1/L2R2|<2.2 Condition 2:

1.8<|L3R1/L3R2|<2.2 Condition 3:

10<|L4R1/L4R2|<15 Condition 4:

0.1<|L5R1/L5R2|<1 Condition 5:

0.8<|L6R1/L6R2<1.2 Condition 6:

When describing the center thickness CT of the lenses based on the optical axis, the center thickness CT2 of the second lens 402 is the largest among the lenses, and the center thicknesses CT4 of the fourth lens 404 and the sixth lens 406 are the smallest among the lenses. The difference between the maximum center thickness and the minimum center thickness among the lenses may be in the range of 2 mm or more and 2.5 mm or less.

The center thickness of each lens may satisfy any one of the following conditions.

CT2,CT3,CT5 >CT1 >CT4,CT6 Condition 1:

CT2>CT1,CT3,CT4,CT5,CT6 Condition 2:

CT2,CT5 >CT3 >CT1,CT4,CT6 Condition 3:

CT1,CT2,CT3,CT5 >CT4=CT6 Condition 4:

CT2 >CT5 >CT1,CT3,CT4,CT6 Condition 5:

If the center gap CG between the lenses is described, the center gap CG1 between the first lens 401 and the second lens 402 may be maximum, and the center gap CG3 between the third and fourth lenses 403, 404 may be minimum. The difference between the maximum center gap and the minimum center gap among the lens distances may be 1 mm or more, for example, in the range of 1.5 mm to 2 mm.

The center gap between each lens can satisfy the following conditions.

CG1 >CG2,CG3,CG4,CG5 Condition 1:

CG1,CG5 >CG2 >CG3,CG4 Condition 2:

CG1,CG2,CG4,CG5 >CG3 Condition 3:

CG1,CG2,CG5 >CG4 >CG3 Condition 4:

CG1 >CG5 >CG2,CG3,CG4 Condition 5:

Regarding the clear apearture, the lens having the maximum clear apearture can be arranged between the first lens 401 closest to the object and the sixth lens 406 closest to the image sensor 600. The lens having the maximum clear apearture can be a glass lens. The lens having the maximum clear apearture can be the first lens 401. Here, the clear apearture is the average of the clear apertures of the object-side and the sensor-side of each lens. The lens surface having the maximum clear apearture may be the first surface S1 of the first lens 401.

The lens having the minimum clear apearture may be a lens arranged between the aperture STOP and the image sensor 600. The lens having the minimum clear apearture may be the third lens 403. The lens surface having the minimum clear apearture may be the fifth surface S5 of the third lens 403. The clear apearture of the lens made of plastic may be smaller than that of the lens made of glass. The lens made of plastic may be arranged adjacent to the image sensor.

The clear apearture of each lens can satisfy any of the conditions below.

CA_L1 >CA_L2,CA_L3,CA_L4,CA_L5,CA_L6 Condition 1:

CA_L1,CA_L5,CA_L6 >CA_L2 >CA_L3,CA_L4 Condition 2:

CA_L1,CA_L2,CA_L4,CA_L5,CA_L6>CA_L3 Condition 3:

CA_L1,CA_L2,CA_L5,CA_L6>CA_L4>CA_L3 Condition 4:

CA_L1,CA_L6>CA_L5>CA_L2,CA_L3,CA_L4 Condition 5:

CA_L1 >CA_L6>CA_L2,CA_L3,CA_L4,CA_L5 Condition 6:

In terms of the refractive index, the refractive index of the sixth lens 406 is the largest among the lenses and may be greater than 1.6, for example, greater than 1.65. The fifth lens 405 may have the minimum refractive index among the lenses. The refractive index of the fifth lens 405 may be less than 1.6, for example, less than 1.55. The difference between the maximum refractive index and the minimum refractive index may be 0.2 or more. By providing a high refractive index lens made of glass closest to the object and providing a lens adjacent to the glass lens and a lens adjacent to the image sensor 600 as a low refractive index lens made of plastic, the incidence efficiency can be increased, and the refractive power between the glass lens and the plastic lens can be adjusted to guide it to the image sensor 600.

The refractive index of each lens can satisfy any one of the conditions below.

n2,n4,n6 >n1 >n3,n5 Condition 1:

n1,n6 >n2=n4 >n3,n5 Condition 2:

n1,n2,n6 >n3 >n4,n5 Condition 3:

n1,n2,n3,n4,n6 >n5 Condition 4:

n6 >n1,n2,n3,n4,n5 Condition 5:

When comparing the Abbe's numbers, the Abbe's number of the third lens 403 is the largest among the lenses and may be 55 or more. The Abbe's number of the sixth lens 406 is the smallest among the lenses and may be 20 or less. The difference between the maximum refractive index and the minimum Abbe's number may be 30 or more. By making the Abbe's number of the third lens 403 arranged in the center of the optical system 1300 the largest and providing the Abbe's number of the sixth lens 406 with a low refractive index adjacent to the image sensor 600 the smallest, the color dispersion of light traveling between the lenses made of glass and plastic can be controlled, and the color dispersion between the lenses made of glass and plastic can be increased to guide it to the image sensor 600.

The Abbe's number of each lens can satisfy any one of the conditions below.

v3 >v1 >v2,v4,v5,v6 Condition 1:

v1,v3,v5 >v2=v4 >v6 Condition 2:

v3 >v1,v2,v4,v5,v6 Condition 3:

v1,v3 >v5 >v2,v4,v6 Condition 4:

The focal lengths (F1, F4, F6) of the first, fourth, and sixth lenses 401, 404, 406 may have negative (−) signs. The first, fourth, and sixth lenses 401, 404, 406 may have negative (−) refractive power. The focal lengths F2, F3, F5 of the second, third, and fifth lenses 402, 403, 405 may have positive (+) signs. The second, third, and fifth lenses 402, 403, 405 may have positive (+) refractive power. The second and third lenses 402, 403 having positive (+) refractive power can be placed on the sensor-side of the first lens 401 having negative (−) refractive power. Through this, light incident from the object-side can move away from the optical axis direction and then gather back toward the optical axis direction, thereby forming a stable optical path.

In addition, the fifth lens 405 and sixth lens 406, which are adjacently placed lenses, can satisfy the following conditions.

Refractive index of lens with positive refractive power <Refractive index of lens with negative refractive power Condition 1:

Dispersion of lens with positive refractive power >Dispersion of lens with negative refractive power Condition 2:

Here, among the plastic lenses, the fifth lens 405 has positive refractive power and the sixth lens 406 has negative refractive power, so according to conditions 1 and 2, the refractive index of the fifth lens 405 is smaller than the refractive index of the sixth lens 406, and the dispersion value of the fifth lens 405 is larger than the dispersion value of the sixth lens 406. Chromatic aberration occurring in a plastic lens can be corrected by a plastic lens. In addition, since the fifth lens 405 and the sixth lens 406, which are plastic lenses arranged in succession, satisfy the refractive index difference of 0.1 or more and 0.15 or less and the Abbe's number difference of 20 or more and 50 or less, the chromatic aberration occurring in a plastic lens can be compensated for by a plastic lens.

The optical system has chromatic aberration, and chromatic aberration is corrected by using cemented lenses or two lenses arranged in series. As the temperature changes from low to high, the lenses repeatedly contract and expand. Since the amount of change in lens characteristics according to the temperature change is the same for lenses of the same material, it is effective to correct chromatic aberration between lenses of the same material even when the temperature changes. Therefore, in the fourth embodiment of the present disclosure, chromatic aberration occurring in a plastic lens can be corrected by using the fifth lens 405 and the sixth lens 406.

When comparing the focal lengths in absolute value, the focal length of the second lens 402 is the largest among the lenses, and may be 10 or more and 20 or less. The focal length of the fourth lens 404 is the smallest among the lenses, and the absolute value of the focal length of the third lens 403 may be 3 or more and 5 or less.

The absolute value of the focal length of each lens may satisfy any one of the following conditions.

|f2|,|f3|,|f4|,|f5|,|f6|>|f1|>|f5| Condition 1:

|f2|>|f1|,|f3|,|f4|,|f5|,|f6| Condition 2:

|f2|,|f4|,|f6|>|f3|>|f1|,|f5| Condition 3:

|f2|,|f6|>|f4|>|f1,|f3,|f5| Condition 4:

|f1|,|f2|,|f3,|f4|,|f6|>|f5| Condition 5:

|f2|>|f6|>|f1|,|f3,|f4|,|f5| Condition 6:

The thickness T1 of the first lens 401 may be such that the difference between the maximum thickness and the minimum thickness is 1.5 times or more, for example, in the range of 1.5 to 1.8 times, and the center thickness CT1 may be minimum and the edge thickness ET1 may be maximum. The thickness T2 of the second lens 402 may be such that the maximum thickness is 1 to 1.2 times the minimum thickness. The second lens 402 may have the center thickness CT2 maximum and the edge thickness ET2 minimum. The thickness T3 of the third lens 403 may be maximum at the center and minimum at the edge, and the maximum thickness is in the range of 1.2 to 1.5 times the minimum thickness. The thickness T4 of the fourth lens 404 may be minimum at the center and maximum at the edge, and the maximum thickness is in the range of 1.5 to 2 times the minimum thickness. The thickness T5 of the fifth lens 405 may be maximum at the center and minimum at the edge, and the maximum thickness is in the range of 2.5 to 3 times the minimum thickness. The thickness T6 of the sixth lens 406 may be minimum at the center and maximum at the edge, and the maximum thickness is in the range of 1 to 1.5 times the minimum thickness.

The thickness of each lens may satisfy any one of the conditions below.

0.1<CT1/ET1<0.5,2<ET1/CT|<2.5 Condition 1:

0.8<CT2/ET2<1.2,0.9<ET2/CT2<1.3 Condition 2:

1.2<CT3/ET3<1.6,0.5<ET3/CT3<1 Condition 3:

0.1<CT4/ET4<1,1.5<ET4/CT4<2 Condition 4:

3<CT5/ET5<3.5,0.1<ET5/CT5<0.5 Condition 5:

0.5<CT6/ET6<1,1.4<ET6/CT6<1.8 Condition 6:

1<ΣCT/ΣET<1.5,0.5<ΣET/ΣCT<1 Condition 7:

Among the distances G1-G6 between the lenses, the first distance G1 between the first and second lenses 401, 402 may have a maximum in the center and a minimum in the edge. The second distance G2 between the second and third lenses 402, 403 may have a maximum in the edge and a minimum in the center. The third distance G3 between the third and fourth lenses 403, 404 may have a maximum in the edge and a minimum in the center. The fourth distance G4 between the fourth and fifth lenses 404, 405 may have a maximum in the center and a minimum in the edge. The fifth distance G5 between the fifth and sixth lenses 405, 406 may have a maximum in the center and a minimum in the edge.

FIGS. 42, 44, and 46 are graphs illustrating diffraction MTF (Modulation transfer function) at room temperature, low temperature, and high temperature in the optical system of FIG. 38, and are graphs illustrating luminance ratio (modulation) according to spatial frequency. As illustrated in FIGS. 42, 44, and 46, in the fourth embodiment of the disclosure, the deviation of MTF at low temperature or high temperature based on room temperature may be less than 10%, that is, 7% or less.

FIGS. 43, 45, and 47 are graphs illustrating aberration characteristics at room temperature, low temperature, and high temperature in the optical system of FIG. 38. In the aberration graphs of FIGS. 43, 45, and 47, longitudinal spherical aberration, astigmatic field curves, and distortion are measured. In FIGS. 43, 45, and 47, the X-axis may represent a focal length (mm) and a degree of distortion (%), and the Y-axis may represent the height of the image. In addition, the graph for spherical aberration is a graph for light in wavelength bands of about 435 nm, about 486 nm, about 546 nm, about 587 nm, and about 656 nm, and the graphs for astigmatic field curves and distortion are graphs for light in wavelength bands of about 546 nm. In the aberration diagrams of FIGS. 43, 45, and 47, it can be interpreted that the closer each curve at room temperature, low temperature, and high temperature is to the Y-axis, the better the aberration correction function is, and it can be seen that the optical system 1300 according to the fourth embodiment has measurement values close to the Y-axis in almost all areas. In other words, the optical system 1300 according to the fourth embodiment has improved resolution and may have good optical performance not only in the center of the field of view (FOV) but also in the periphery. Here, the low temperature is −20 degrees or lower, for example, in the range of −20 to −40 degrees, the room temperature is in the range of 22 degrees±5 degrees or in the range of 18 degrees to 27 degrees, and the high temperature can be 85 degrees or higher, for example, in the range of 85 degrees to 405 degrees. Accordingly, it can be seen that the reduction in the luminance ratio (modulation) from low to high temperature in FIGS. 43, 45 and 47 is less than 10%, for example, less than 5%, or is almost unchanged.

The optical system of the fourth embodiment disclosed above can effectively control aberration characteristics such as chromatic aberration and distortion, and may have good optical performance not only in the center of the field of view (FOV_H) but also in the periphery.

The optical system 1100, 1200, 1300 according to the second to fourth embodiments disclosed above can satisfy at least one or two or more of the mathematical expressions described below. Accordingly, the optical system 1100, 1200, 1300 according to the second to fourth embodiments can have improved optical characteristics. For example, when the optical system 1100, 1200, 1300 satisfies at least one mathematical expression, the optical system 1100, 1200, 1300 can effectively control aberration characteristics such as chromatic aberration and distortion, and may have good optical performance not only at the center but also at the periphery of the field of view FOV. In addition, the optical system 1100, 1200, 1300 can have improved resolution. In addition, the thickness of the lens at the optical axis OA and the distance of adjacent lenses at the optical axis OA described in the mathematical expressions may refer to the second to fourth embodiments disclosed above.

0.3<ΣCT/TTL<0.8 [Mathematical expression 41]

Mathematical expression 41 can set the relationship between the sum (ΣCT) of the center thicknesses of the first to sixth lenses 201-206, 301-306, 401-406 and TTL, which is the distance (mm) from the center of the first surface S1 of the first lens 201, 301, 401 to the upper surface of the image sensor 600 on the optical axis OA. To reduce TTL, a lot of light refraction must occur. In order to refract a lot of light, the power of the lenses must increase, and in order to increase the power, the lenses become thicker. When it is less than the lower limit of mathematical expression 41, the sum of the lens thicknesses decreases and the refractive power weakens. When it exceeds the upper limit of mathematical expression 41, there is a problem that the sum of the lens thicknesses increases excessively, causing TTL to increase. In the second to fourth embodiments, mathematical expression 41 may preferably satisfy 0.4<ΣCT/TTL <0.7.

0.1<ΣCG/TTL<0.5 [Mathematical expression 42]

Mathematical expression 42 can set the relationship between the sum (ΣCG) of the adjacent lens distances among the first to sixth lenses 201-206, 301-306, 401-406 and TTL, which is the distance (mm) from the center of the first surface S1 to the upper surface of the image sensor 600 on the optical axis OA. In order to reduce TTL, a lot of light refraction must occur. In order to refract light a lot, the power of the lenses must be increased, and in order to increase the power, the lenses become thicker. When it is less than the lower limit of mathematical expression 42, the sum of the lens thicknesses becomes small and the refractive power becomes weaker than the desired power. If the upper limit of mathematical expression 42 is exceeded, there is a problem that the sum of the thicknesses of the lenses increases excessively, thereby increasing the TTL. In the second to fourth embodiments, mathematical expression 42 may preferably satisfy 0.2<ΣCG/TTL <0.4.

1<ΣCT/ΣCG<2.5 [Mathematical expression 43]

In mathematical expression 43, ΣCT is the sum of the central thicknesses of the lenses, and ΣCG is the sum of the distances between adjacent lenses. When mathematical expression 43 is satisfied, the optical system may have good optical performance at the focal length at the set field of view, and may reduce the TTL. In the second to fourth embodiments, mathematical expression 43 may preferably satisfy 1.5<ΣCT/ΣCG <2.

5<ΣIndex <15 [Mathematical expression 44]

In mathematical expression 44, ΣIndex means the sum of the refractive indices of the d-lines of each of the plurality of lenses. When mathematical expression 44 is satisfied, TTL may be controlled in an optical system 1100, 1200, 1300 in which a plastic lens and a glass lens are mixed, and improved resolution may be achieved. In the second to fourth embodiments, mathematical expression 44 may preferably satisfy 8<ΣIndex <12.

20<ΣAbb/ΣIndex <30 [Mathematical expression 45]

In mathematical expression 45, ΣAbb means the sum of Abbe's numbers of each of the plurality of lenses, and ΣIndex means the sum of refractive indices of each of the plurality of lenses at the d-line. If mathematical expression 45 is satisfied, the optical system 1100, 1200, 1300 may have improved aberration characteristics and resolution. By setting the sum of Abbe's numbers and the sum of refractive indices of the lenses in mathematical expression 45, the optical characteristics may be controlled. In the second to fourth embodiments, mathematical expression 45 may preferably satisfy 20<ΣAbb/ΣIndex <25.

0.1<ΣCT/ΣET<1 [Mathematical expression 46]

In mathematical expression 46, ΣCT is the sum of the center thicknesses of the lenses, and ΣET is the sum of the edge thicknesses, that is, the ends of the effective areas of the lenses. When mathematical expression 46 is satisfied, the optical system may have good optical performance at the focal length at the set field of view, and can reduce the TTL. In the second to fourth embodiments, mathematical expression 46 may preferably satisfy 0.4<ΣCT/ΣET <0.7.

0.1<CT1/ET1<1 [Mathematical expression 47]

In mathematical expression 47, CT1 is the center thickness of the first lens 201, 301, 401, and ET1 is the edge thickness of the first lens 201, 301, 401. Through this, it is possible to set a factor affecting the field of view of the optical system, and to set a factor affecting the effective focal length (EFL). Mathematical expression 47 may preferably satisfy 0.3<CT1/ET1<0.6 in the second to fourth embodiments.

2<CT5/ET5<3.5 [Mathematical expression 48]

In Mathematical expression 48, CT5 is the center thickness of the fifth lens 105, 205, 305, and ET5 is the edge thickness of the fifth lens 105, 205, 305. Through this, it is possible to set a factor affecting the field of view of the optical system, and to set a factor affecting the effective focal length (EFL). Mathematical expression 48 may preferably satisfy 2<CT5/ET5<3.2 in the second to fourth embodiments.

0.5<CT6/ET6<1.5 [Mathematical expression 49]

In mathematical expression 49, CT6 is the center thickness of the sixth lens 106, 206, 306, and ET6 is the edge thickness of the sixth lens 106, 206, 306. Through this, it is possible to set a factor affecting the field of view of the optical system, and it is possible to set a factor affecting the effective focal length (EFL). In the second to fourth embodiments, mathematical expression 49 may preferably satisfy 0.5<CT6/ET6<1.2.

1<GLCa_AVER/PLCa_AVER <1.5 [Mathematical expression 50]

In mathematical expression 50, GLCa_AVER represents the average clear apearture of glass lenses, and PLCa_AVER represents the average clear apearture of plastic lenses. The lens barrel in which the lens part is arranged has at least one inner barrel within the lens barrel, and at least some of the plastic material lenses included in the lens part can be arranged in the inner barrel. In the case of the plastic material lens, since the amount of expansion is large at high temperatures, a wider space is required within the lens barrel. In the mathematical expression 50, by setting the clear apearture size of the glass lens and the clear apearture size of the plastic lens, the deterioration of the optical characteristics due to temperature change may be suppressed, and the optical system 1100, 1200, 1300 may control the incident light and set the factors affecting the aberration. In the second to fourth embodiments, the mathematical expression 50 may preferably satisfy 1<GLCa_AVER/PLCa_AVER <1.2.

Here, nGL <nPL may be satisfied. nGL is the number of glass material lenses, and nPL is the number of plastic lenses. In addition, the condition of nPL −nGL=0 or 1 may be satisfied.

1.5<CA_L1S1/CA_L1S2<2.5 [Mathematical expression 51]

In mathematical expression 51, CA_L1S1 means the clear apearture of the first surface S1 of the first lens 201, 301, 401, and CA_L1S2 means the clear apearture of the second surface S2 of the first lens 201, 301, 401. When mathematical expression 51 is satisfied, the deterioration of optical characteristics due to temperature change can be suppressed, and the optical system 1100, 1200, 1300 can control the incident light and set the factors affecting the aberration. In the second to fourth embodiments, mathematical expression 51 may preferably satisfy 1.8<CA_L1S1/CA_L1S2<2.3.

0.5<CA_L1/CA_L6<1.5 [Mathematical expression 52]

In mathematical expression 52, CA_L1 means the clear apearture of the first lens 201, 301, 401, and CA_L6 means the clear apearture of the sixth lens (106, 206, 306). The lens barrel in which the lens part is arranged has at least one inner barrel within the lens barrel, and at least some of the plastic material lenses included in the lens part can be arranged in the inner barrel. In the case of the plastic material lens, since the amount of expansion is large at high temperatures, a wider space is required within the lens barrel. Therefore, if the mathematical expression 52, which sets the relationship between the clear apearture of the first lens 201, 301, 401 made of glass and the clear apearture of the sixth lens 106, 206, 306 made of plastic, is satisfied, the deterioration of optical characteristics due to temperature change can be suppressed, and the optical system 1100, 1200, 1300 can control the incident light and set the factor affecting the aberration. In the second to fourth embodiments, the mathematical expression 52 may preferably satisfy 0.9<CA_L1/CA_L6<1.4.

0.5<CA_L1/ImgH<1 [Mathematical expression 53]

Mathematical expression 53 can set the relationship between the size of the clear apearture (CA_L1) of the first lens 201, 301, 401 and ImgH, the maximum diagonal length of the image sensor. If mathematical expression 53 is satisfied, TTL suitable for a vehicle optical system is satisfied, and the set field of view can be satisfied. If it is less than the lower limit of mathematical expression 53, the clear apearture of the lens arranged in the optical system 1100, 1200, 1300 becomes the largest, and there is a problem that the TTL becomes long due to this. If it exceeds the upper limit of mathematical expression 53, there is a problem that the field of view becomes excessively larger than that satisfied by the optical system 1100, 1200, 1300. In the second to fourth embodiments, mathematical expression 53 may preferably satisfy 0.6<CA_L1/ImgH <0.9.

0.5<CT_Max/CG_Max <2 [Mathematical expression 54]

In mathematical expression 54, CT_Max is the maximum center thickness among the lenses, and CG_Max is the maximum distance between adjacent lenses. When mathematical expression 54 is satisfied, the optical system may have good optical performance at the focal length at the set field of view and can reduce the TTL. In the second to fourth embodiments, mathematical expression 54 may preferably satisfy 0.7<CT_Max/CG_Max <1.7.

2<CA_max/CA_min <3 [Mathematical expression 55]

In mathematical expression 55, CA_max represents the maximum clear apearture among the object-side and sensor-sides of the lenses, and CA_Min represents the minimum clear apearture among the object-side and sensor-sides of the lenses. When mathematical expression 55 is satisfied, the optical system can set the size for a slim and compact structure while maintaining optical performance. In the second to fourth embodiments, mathematical expression 55 may preferably satisfy 2.1<CA_max/CA_min <2.5.

1<CA_max/CA_Aver <2 [Mathematical expression 56]

In mathematical expression 56, CA_max represents the maximum clear apearture among the object-side and sensor-sides of the lenses, and CA_Aver represents the average of the clear apertures among the object-side and sensor-sides of the lenses. When mathematical expression 56 is satisfied, the optical system can set a size for a slim and compact structure while maintaining optical performance. In the second to fourth embodiments, mathematical expression 56 may preferably satisfy 1.3<CA_max/CA_Aver <1.6.

0.5<CA_min/CA_Aver <1 [Mathematical expression 57]

In mathematical expression 57, CA_Min represents the minimum clear apearture among the object-side and sensor-sides of the lenses, and CA_Aver represents the average of the clear apertures among the object-side and sensor-sides of the lenses. If mathematical expression 57 is satisfied, the optical system can maintain optical performance and set a size for a slim and compact structure. In the second to fourth embodiments, mathematical expression 57 may preferably satisfy 0.5<CA_min/CA_Aver <0.8.

0.1<CA_max/ImgH<1 [Mathematical expression 58]

In mathematical expression 58, CA_max represents the maximum clear apearture among the object-side and sensor-sides of the lenses, and Imgh represents the maximum diagonal length of the image sensor 600. If mathematical expression 58 is satisfied, the optical system can maintain good optical performance and set a size for a slim and compact structure. In the second to fourth embodiments, mathematical expression 58 may preferably satisfy 0.5<CA_max/ImgH <1.

10<TTL<15 [Mathematical expression 59]

In mathematical expression 59, TTL (Total track length) means the distance (mm) from the center of the first surface S1 of the first lens 201, 301, 401 to the upper surface of the image sensor 600 on the optical axis OA. When mathematical expression 59 is satisfied, a suitable vehicle optical system can be provided. In the second to fourth embodiments, mathematical expression 59 may preferably satisfy 12<TTL <14.

5<ImgH<9 [Mathematical expression 60]

In mathematical expression 60, ImgH means the maximum diagonal length of the image sensor 600. Mathematical expression 60 can set the diagonal size (ImgH) of the image sensor 600 and can provide an optical system having a vehicle sensor size. In the second to fourth embodiments, mathematical expression 60 preferably may preferably satisfy 6<ImgH <8.

1<BFL<3 [Mathematical expression 61]

In mathematical expression 61, BFL is the optical axis distance from the image sensor 600 to the center of the sensor-side of the last lens. When mathematical expression 61 is satisfied, the installation space of the filter 500 and the cover glass can be secured, and the assembly of the components can be improved through the distance between the image sensor 600 and the last lens, and the bonding reliability can be improved. In the second to fourth embodiments, mathematical expression 61 may preferably satisfy 1<BFL <2.6. When the BFL is less than the range of mathematical expression 61, some of the light traveling to the image sensor may not be transmitted to the image sensor, which may cause a decrease in resolution. When the BFL exceeds the range of mathematical expression 61, stray light may be introduced, which may deteriorate the aberration characteristics of the optical system.

2<F<5 [Mathematical expression 62]

Mathematical expression 62 can set the total focal length F to suit the vehicle optical system. In the second to fourth embodiments, mathematical expression 62 can satisfy 2<F<3.

130<FOV<170 [Mathematical expression 63]

In mathematical expression 63, FOV (Field of view) means the field of view (Degree) of the optical system 1100, 1200, 1300, and can provide an field of view suitable for the vehicle optical system. In the second to fourth embodiments, FOV may preferably satisfy 145<FOV <160.

2<TTL/CA_max <3 [Mathematical expression 64]

In mathematical expression 64, CA_max means the largest clear apearture (mm) among the object-side and sensor-side of a plurality of lenses, and TTL (Total track length) means the distance (mm) from the apex of the first surface S1 of the first lens 201, 301, 401 to the upper surface of the image sensor 600 on the optical axis OA. Mathematical expression 64 sets the relationship between the total optical axis length of the optical system and the maximum clear apearture, thereby providing an improved vehicle optical system. In the second to fourth embodiments, mathematical expression 64 may preferably satisfy 2<TTL/CA_max <2.5.

1.5<TTL/ImgH<2.5 [Mathematical expression 65]

Mathematical expression 65 means that TTL (Total track length) means the distance (mm) from the apex of the first surface S1 of the first lens to the upper surface of the image sensor 600 on the optical axis OA, and ImgH means the maximum diagonal length of the image sensor 600. When mathematical expression 65 is satisfied, the optical system 1100, 1200, 1300 can have TTL for application to the vehicle image sensor 600, thereby providing improved image quality. In the second to fourth embodiments, mathematical expression 65 may preferably satisfy 1.5<TTL/ImgH <2.

0.1<BFL/ImgH<1 [Mathematical expression 66]

Mathematical expression 66 means that BFL is the optical axis distance from the image sensor 600 to the center of the sensor-side of the last lens, and ImgH means the maximum diagonal length of the image sensor 600. When mathematical expression 66 is satisfied, the optical system 1100, 1200, 1300 can secure a BFL (Back focal length) for applying the size of the vehicle image sensor 600, can set the distance between the last lens and the image sensor 600, and may have good optical characteristics at the center and periphery of the field of view (FOV). In the second to fourth embodiments, mathematical expression 66 may preferably satisfy 0.1<BFL/ImgH <0.5.

5<TTL/BFL<15 [Mathematical expression 67]

Mathematical expression 67 means that TTL (Total track length) is the distance (mm) from the apex of the first surface S1 of the first lens 201, 301, 401 to the upper surface of the image sensor 600 on the optical axis OA, and BFL means the optical axis distance from the image sensor 600 to the center of the sensor-side of the last lens. When mathematical expression 67 is satisfied, the optical system 1100, 1200, 1300 can secure BFL. In the second to fourth embodiments, mathematical expression 67 may preferably satisfy 5<TTL/BFL <12.

5<TTL/F<8 [Mathematical expression 68]

Mathematical expression 68 means that TTL (Total track length) is the distance (mm) from the apex of the first surface S1 of the first lens to the upper surface of the image sensor 600 on the optical axis OA, and F is the effective focal length of the optical system. Accordingly, an optical system for a driver assistance system may be provided. When the optical system 1100, 1200, 1300 according to the embodiment satisfies mathematical expression 68, the optical system 1100, 1200, 1300 may have an appropriate focal length in the set TTL range, and provides an optical system that may form an image while maintaining an appropriate focal length even when the temperature changes from low temperature to high temperature. If it is less than the lower limit of mathematical expression 68, it is necessary to increase the refractive power of the lenses, so that correction of spherical aberration or distortion becomes difficult, and if it exceeds the upper limit of mathematical expression 68, the clear apearture or TTL of the lenses becomes long, so that the problem of the photographing lens system becoming large may occur. In the second to fourth embodiments, mathematical expression 68 may preferably satisfy 5<TTL/F<6.5.

0.5<F/BFL<2 [Mathematical expression 69]

In mathematical expression 69, F is the effective focal length of the optical system, and BFL means the optical axis distance from the image sensor 600 to the center of the sensor-side of the last lens. If mathematical expression 69 is satisfied, the optical system 1100, 1200, 1300 can have a set field of view and an appropriate focal length, and a vehicle optical system can be provided. In addition, the optical system 1100, 1200, 1300 can minimize the distance between the last lens and the image sensor 600, so that it may have good optical characteristics at the periphery of the field of view (FOV). In the second to fourth embodiments, mathematical expression 69 may preferably satisfy 0.5<F/BFL <1.8.

0.1<F/ImgH<1 [Mathematical expression 70]

In mathematical expression 70, F is the effective focal length of the optical system, and ImgH means the maximum diagonal length of the image sensor 600. Such optical systems 1100, 1200, 1300 can have improved aberration characteristics in the size of the vehicle image sensor 600. In the second to fourth embodiments, mathematical expression 70 may preferably satisfy 0.1<F/ImgH<0.5.

$$z = \frac{{cY}^{2}}{1 + \sqrt{1 - ( 1 + K ) {c}^{2} {Y}^{2}}} + {AY}^{4} + {BY}^{5} + {CY}^{4} + {DY}^{5} + {EY}^{4} + … \qquad [ Mathematical expression 71 ]$$

In the mathematical expression 71, Z may mean a distance in the direction of the optical axis from an arbitrary position on the asphere to the apex of the asphere with Sag. Y may mean a distance in the direction perpendicular to the optical axis from an arbitrary position on the asphere to the optical axis. c may mean the curvature of the lens, and K may mean the conic constant. In addition, A, B, C, D, E, and F may mean aspheric coefficients.

The optical system 1100, 1200, 1300 according to the second to fourth embodiments may satisfy at least one or two or more mathematical expressions among the mathematical expressions 41 to 71. In this case, the optical system 1100, 1200, 1300 may have improved optical characteristics. In detail, when the optical system 1100, 1200, 1300 satisfies at least one or more of the mathematical expressions 41 to 71, the optical system 1100, 1200, 1300 has improved resolution and can improve aberration and distortion characteristics. In addition, the optical system 1100, 1200, 1300 can secure a BFL (Back focal length) for applying a vehicle image sensor 600, can compensate for optical characteristic degradation due to temperature change, and can minimize the distance between the last lens and the image sensor 600, so that it may have good optical performance at the center and periphery of the field of view (FOV).

Table 22 illustrates the result values for the mathematical expressions 41 to 70 described above in the optical system 1100, 1200, 1300 of the embodiment. Referring to Table 22, it can be seen that the optical system 1100, 1200, 1300 satisfies at least one, two or more, or three or more of mathematical expressions 41 to 70. In detail, it can be seen that the optical system 1100, 1200, 1300 according to the embodiment satisfies all of mathematical expressions 41 to 70. Accordingly, the optical system 1100, 1200, 1300 may have good optical performance at the center and periphery of the field of view (FOV) and can have excellent optical characteristics.

TABLE 22

| | | Second | Third | Fourth |
|---|---|---|---|---|
| Mathematical expression | | example | example | example |
| 41 | 0.3 < ΣCT/TTL < 0.8 | 0.602 | 0.534 | 0.529 |
| 42 | 0.1 < ΣCG/TTL < 0.5 | 0.308 | 0.274 | 0.304 |
| 43 | 1 < ΣCT/ΣCG < 2.5 | 1.956 | 1.947 | 1.739 |
| 44 | 5 < ΣIndex < 15 | 10.048 | 9.775 | 9.704 |
| 45 | 20 < ΣAbb/ΣIndex < 30 | 21.268 | 24.154 | 24.985 |
| 46 | 0.1 < ΣCT/ΣET < 1 | 0.602 | 0.534 | 0.529 |
| 47 | 0.1 < CT1/ET1 < 1 | 0.573 | 0.449 | 0.441 |
| 48 | 2 < CT5/ET5 < 3.5 | 2.661 | 2.323 | 3.184 |
| 49 | 0.5 < CT6/ET6 < 1.5 | 0.791 | 1.101 | 0.638 |
| 50 | 1 < GLCa_AVER/PLCa_AVER < 1.5 | 1.036 | 1.125 | 1.166 |
| 51 | 1.5 < CA_L1S1/CA_L1S2 < 2.5 | 1.919 | 2.199 | 2.235 |
| 52 | 0.5 < CA_L1/CA_L6 < 1.5 | 1.098 | 1.247 | 1.381 |
| 53 | 0.5 < CA_L1/ImgH < 1 | 0.783 | 0.799 | 0.857 |
| 54 | 0.5 < CT_Max/CG_Max < 2 | 1.613 | 1.207 | 0.880 |
| 55 | 2 < CA_max/CA_min < 3 | 2.298 | 2.326 | 2.493 |
| 56 | 1 < CA_max/CA_Aver < 2 | 1.427 | 1.510 | 1.577 |
| 57 | 0.5 < CA_min/CA_Aver < 1 | 0.621 | 0.649 | 0.632 |
| 58 | 0.1 < CA_max/ImgH < 1 | 0.783 | 0.799 | 0.857 |
| 59 | 10 < TTL < 15 | 13.800 | 13.499 | 13.500 |
| 60 | 5 < ImgH < 9 | 7.280 | 7.280 | 7.280 |
| 61 | 1 < BFL < 3 | 1.250 | 2.591 | 2.241 |
| 62 | 2 < F < 5 | 2.224 | 2.373 | 2.335 |
| 63 | 130 < FOV < 170 | 150 | 152 | 152 |
| 64 | 2 < TTL/CA_max < 3 | 2.421 | 2.321 | 2.163 |
| 65 | 1.5 < TTL/ImgH < 2.5 | 1.896 | 1.854 | 1.854 |
| 66 | 0.1 < BFL/ImgH < 1 | 0.172 | 0.356 | 0.308 |
| 67 | 5 < TTL/BFL < 15 | 11.043 | 5.211 | 6.023 |
| 68 | 5 < TTL/F < 8 | 6.206 | 5.690 | 5.783 |
| 69 | 0.5 < F/BFL < 2 | 1.780 | 0.916 | 1.042 |
| 70 | 0.1 < F/ImgH < 1 | 0.305 | 0.326 | 0.321 |

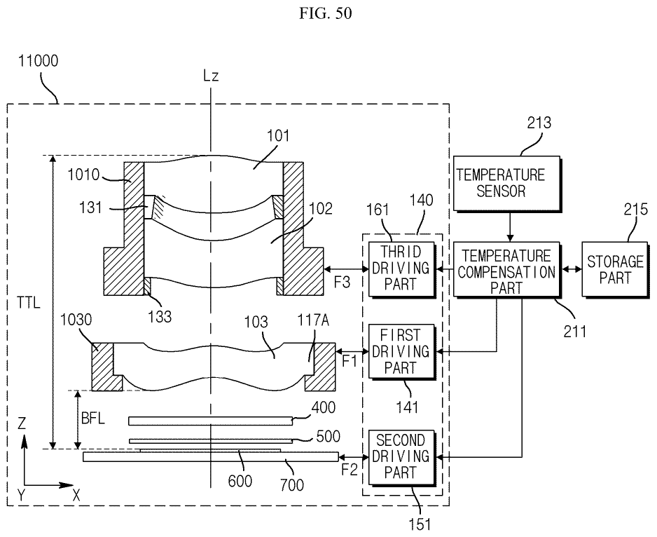

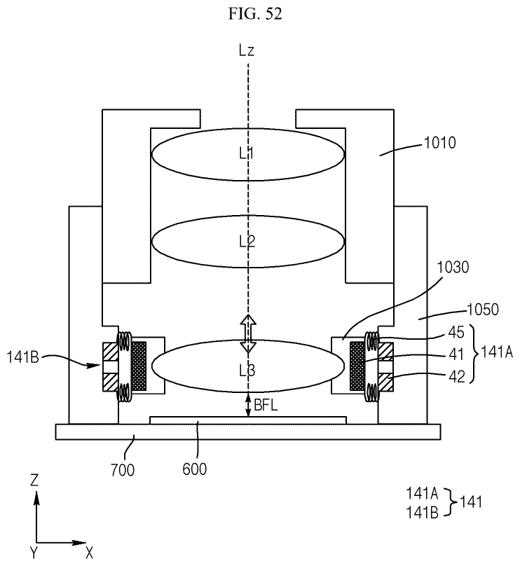

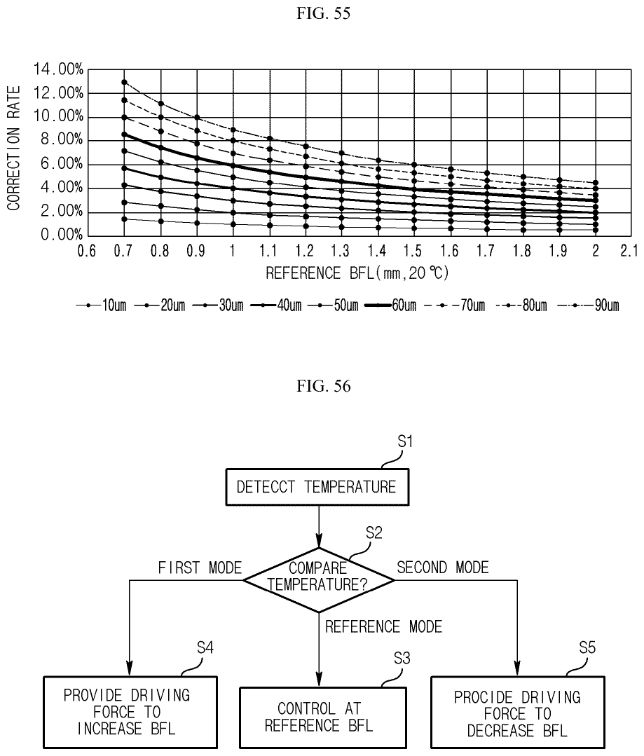

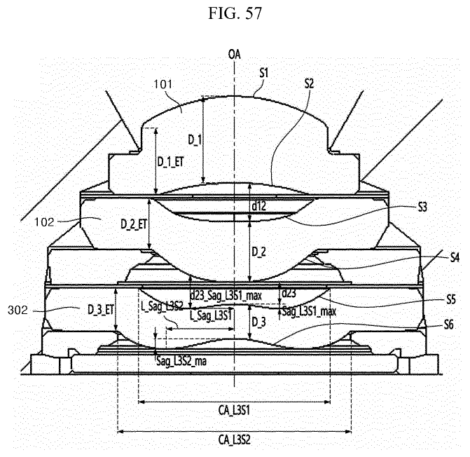

Hereinafter, with reference to FIGS. 50 to 56, a camera module that adjusts the distance between lenses or the distance between lenses and an image sensor according to temperature changes in an optical system of the present embodiment will be described. The camera module according to the present embodiment can minimize changes in performance according to temperature.

Referring to FIG. 50, a camera system according to the present embodiment may include a camera module 11000, a temperature compensation part 211 that provides a driving signal to the camera module 11000, a temperature sensor 213 that detects the ambient temperature of the camera module 11000, and a storage part 215 that stores a compensation rate according to temperature changes.

The driving part 140 may be implemented as a first driving part 141 that moves one lens of the second lens holder 1030 in the direction of the optical axis Lz. As another example, the driving part 140 may be implemented as a second driving part 151 that moves the main board 700 in the direction of the optical axis Lz.

As another example, the driving part 140 may be implemented as a third driving part 161 that moves one lens of the first lens holder 1010 in the direction of the optical axis Lz. The driving part 140 may be implemented as a single driving part, but as another example, may be implemented as two or more driving parts, for example, may be implemented as first and second driving parts 141, 151, as first and third driving parts 141, 161, or as second and third driving parts 151, 161.

The actuator may be a VCM (Voice Coil Motor) type drive having a magnet and a coil, and may further include a supporting member, and a yoke or/and a Hall sensor may be arranged on the outside of the magnet.

The camera module 11000 may be configured such that a plurality of lenses 101, 102, 103 may be stacked along the optical axis Lz from the object-side toward the sensor-side, and may be stacked, for example, as a first lens 101, a second lens 102, and a third lens 103. The first lens 101 may be the lens closest to the object-side or the first lens. The third lens 103 may be defined as the lens closest to the sensor or the last lens.

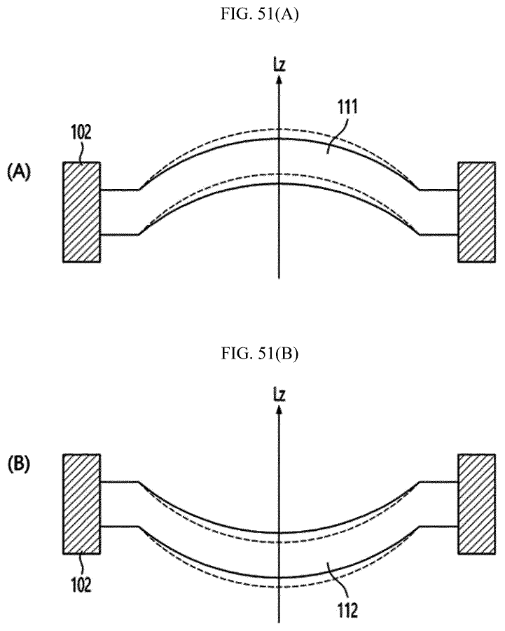

The camera module 11000 may be configured only with plastic lenses. When using a plastic lens in a vehicle, the price may be lowered compared to a glass lens, and the incident side surface and the output side surface may be provided as aspheres, so that light path control may be facilitated. Here, the plastic material may be 5 times higher than the coefficient of thermal expansion (CTE) of the glass material, and the change value of the refractive index according to the function of temperature may be 10 times lower than that of the glass material. In the case where the expansion and contraction ratio according to temperature is large, such as in a plastic lens, as in (A)(B) of FIG. 51, the plastic lens 111, 112 may expand or contract according to temperature changes, and for example, as in (A), when the object-side is convex and/or the sensor-side is concave, it may expand in the object-side direction, and as in (B), when the object-side is concave and/or the sensor-side is convex, it may expand in the sensor-side direction. These lenses 111, 112 may have different positions of the incident-side surface and the output-side surface or the height of the optical axis Lz. Accordingly, the lenses 111, 112 may affect the optical characteristics according to temperature changes.

The first lens holder 1010 may be made of a plastic material or a metal material for heat dissipation efficiency. The second lens holder 1030 may be made of a plastic material or a metal material for heat dissipation efficiency. If the lens holder 1010, 1030 is made of metal, it can improve the heat dissipation effect of the camera module 11000, or if it is applied with the same material as the plastic lens, it can reduce the difference in thermal expansion coefficient. The metal material can be selected from, for example, Al, Ag, or Cu, and can be Al or an Al alloy. A hydrophilic material can be coated or applied on the surface of the first and second lens holders 101, 103. In an embodiment of the disclosure, the material of the second lens holder 1030 can be made of metal for compensation of BFL.

Each of the lenses 101, 102, 103 can include an effective area having an clear apearture where light is incident, and a flange, which is a non-effective area outside the effective area. The non-effective area may be an area where light is blocked by a light shield 131, 133. The flange can extend in a circumferential direction with respect to the optical axis Lz in the effective area of the lens 101, 102, 103. At least one of the lenses 101, 102, 103 may be provided without a flange part or with a relatively short length. The third lens 103 may have a flange 117A on its outer periphery that may be coupled to the inner side of the second lens holder 1030.

The temperature sensor 213 can detect the surrounding temperature of the camera module 11000. The detected temperature can detect the temperature inside or outside the camera module 11000, and can detect in the range of −50 degrees to 125 degrees. The camera module 11000 can be applied to a moving body such as a vehicle, an airplane, a ship, or a portable terminal, and for example, in the case of a vehicle, the temperature deviation can be large due to the external environment. At this time, the reference temperature can be the temperature inside the vehicle.

The temperature compensation part 211 controls the driving mode of the driving part(s) based on the temperature detected by the temperature sensor 213. The storage part 215 can match and store the detected temperature and the temperature compensation rate according to the temperature.

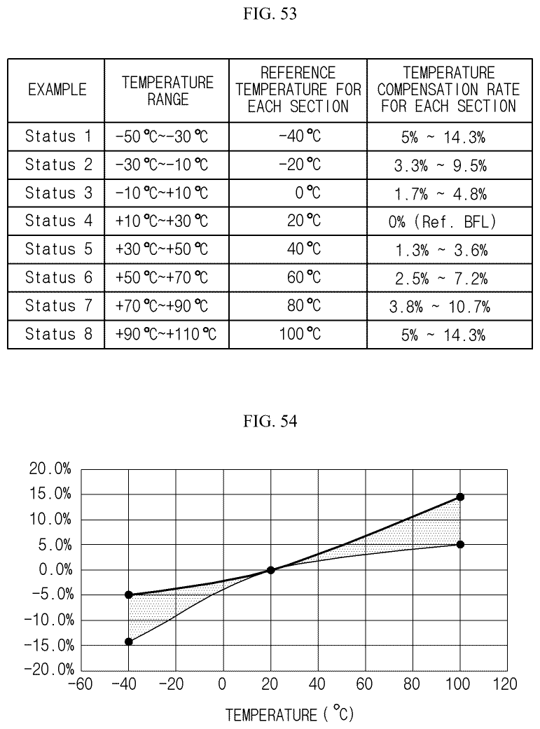

For example, as illustrated in FIG. 53, the temperature compensation rate by section may be set to a first mode (Status 1-3) for compensating when the temperature is lower than the reference (Ref) temperature based on the reference temperature, and a second mode (Status 5-8) for compensating when the temperature is higher than the reference (Ref) temperature. The reference (Ref) temperature may be an indoor temperature, for example, a range of 10 to 30 degrees or a range of 15 to 25 degrees, and preferably 20 degrees±10 degrees. The first mode (Status 1-3) is a temperature lower than the reference (Ref) temperature, and the temperature for each section may be divided into at least three sections ranging from 10 degrees to −50 degrees, and the first section (Status 1) may be in the range of 10 to −10 degrees, the second section (Status 2) may be in the range of −10 degrees to −30 degrees, and the third section (Status 3) may be in the range of −30 degrees to −50 degrees. The reference temperatures for each section of the first to third sections (Status 1-3) can be 0 degrees, −20 degrees, and −40 degrees, and the deviation of the temperature for each section can be ±10 degrees. The second mode is a temperature higher than the reference (Ref) temperature, and the temperature by section can be divided into at least four sections from 30 degrees to 100 degrees, and looking at the temperature by section, the first section (Status 5) has a range of 30 to 50 degrees, the second section (Status 6) has a range of 50 to 70 degrees, the third section (Status 7) has a range of 70 to 90 degrees, and the fourth section (Status 8) may be a range of 90 to 110 degrees. The reference temperatures by section of the first to fourth sections (Status 5-8) may be 40 degrees, 60 degrees, 80 degrees, and 100 degrees, and the deviation of the temperature by section may be ±10 degrees.

Another example of the disclosure is that the temperature compensation rate for each section may be compensated by the average temperature change amount of each section (status 1-8). For example, in the first section (status 1) lower than the reference temperature, the temperature compensation rate may be set as the average value of the temperature compensation rate of 10 degrees and the temperature compensation rate of −10 degrees, and in this manner, the average temperature compensation rate of each of the second to third sections lower than the reference temperature can be set. In addition, in the first section (status 5) higher than the reference temperature, the temperature compensation rate of the section may be set as the average value of the temperature compensation rate of 30 degrees and the temperature compensation rate of 50 degrees, and in this manner, the average temperature compensation rate of each of the second to fourth sections higher than the reference temperature may be compensated.

Another example of the disclosure is that, in calculating the average temperature compensation rate, in each section lower than the reference temperature, more weight can be given to the compensation rate of a relatively low temperature, and in each section higher than the reference temperature, more weight can be given to the compensation rate of a relatively high temperature. For example, in the first section (Status 1) lower than the reference temperature, a temperature compensation rate of 10 degrees can be given a weight of 30%, a temperature compensation rate of −10 degrees can be given a weight of 70%, and the temperature compensation rate can be set as an average value of these, and in this manner, an average temperature compensation rate with added weights of each of the second to third sections lower than the reference temperature can be set. In addition, in the first section (Status 5) higher than the reference temperature, a temperature compensation rate of 30 degrees can be given a weight of 30%, and a temperature compensation rate of 50 degrees can be given an additional weight of 70%, and the temperature compensation rate of the corresponding section can be set as an average value of these, and in this manner, each of the second to fourth sections higher than the reference temperature can be compensated for with an average temperature compensation rate.

The temperature compensation part 211 can determine the driving mode with the matching temperature by comparing the detected temperature with the reference mode, the temperature compensation rate of each section (Status 1-3) of the first mode, and the temperature compensation rate of each section (Status 1-3) of the second mode stored in the storage part 215. Alternatively, the temperature compensation part 211 can control the position of the BFL based on the average temperature compensation rate of each section.

The temperature compensation part 211 can control at least one driving part 141, 151, 161 according to the driving mode. For example, when the first driving part 141 is driven by the first control signal F1, the optical axis Lz distance between the sensor-side of the third lens 103 and the image sensor 600, i.e., the BFL (Back focal length), can be increased or decreased. Preferably, since the third lens 103 contracts or expands according to the temperature change, the reference BFL can be decreased or increased.

In one section, the third lens 103 can be contracted, thereby increasing the BFL from a reference value, and the temperature compensation part 211 can control the driving part 141, 151 so that the BFL increases according to the temperature compensation rate of the BFL. Conversely, in one section of the second mode where the detected temperature is higher than the reference temperature, the third lens 103 may be expanded, which may result in a decrease in the BFL from the reference value, and the temperature compensation part 211 can control the first driving part 141, 151 so that the BFL decreases according to the temperature compensation rate of the BFL.

When a first control signal F1 is input, the first driving part 141 can move the third lens 103 up or down in the direction of the optical axis Lz. When a second control signal F2 is input, the second driving part 151 can move the main board 700 up or down in the direction of the optical axis Lz. When a third control signal F3 is input, the third driving part 161 can move the first lens holder 1010 or any one of the internal lenses 101, 102, 103 up or down in the direction of the optical axis Lz. Here, when the third driving part 161 is driven, the change in the TTL (Total track length) of the camera module 11000 can be controlled according to a temperature change, or the TTL according to a BFL change can be reduced or increased. TTL is the optical axis Lz distance from the object-side of the first lens 101 to the image sensor 600.

As illustrated in FIG. 54, the embodiment of the disclosure drives the first or second driving part 141, 151 to increase or decrease the BFL according to the temperature change or BFL change of the last lens 300 within the area connecting the point of minimum −5% and maximum −14.3% when the temperature is lowest −40 degrees, and the point of minimum 5% and minimum 14.3% when the temperature is highest 100 degrees, thereby maintaining a constant reference BFL. Accordingly, the change in the optical performance of the camera module due to the temperature change can be suppressed.

When a control signal is input based on the temperature detected by the temperature compensator 211, the first and second actuators 141A, 141B move the magnets 41 up or down along the optical axis Lz together with the second lens holder 1030 due to the electromagnetic influence between the coil 42 and the magnet 41. At this time, the spring member 45 supports the movement of the second lens holder 1030 on the optical axis Lz direction, and the optical axis distance (BFL) between the lens L3 of the second lens holder 1030 and the image sensor 600 increases or decreases. Therefore, the distance (BFL) between the last lens L3 of the second lens holder 1030 and the image sensor 600 can be maintained constant even if the last lens L3 expands or contracts due to temperature. Accordingly, the camera module 11000 can suppress changes in optical performance even if the temperature varies according to the configuration.

Referring to FIG. 56, the BFL compensation method by the temperature compensation part 211 detects the ambient temperature of the camera module 11000 by the temperature sensor 213 (S1), and compares and matches the detected ambient temperature with the temperature compensation table stored in the storage part 215 (S2). At this time, if the ambient temperature is the reference mode, it is controlled to be maintained at the reference BFL (S3), and if the first temperature is lower than the reference temperature, driving force is provided to the first or second driving part 141, 151 of the camera module to increase the BFL (S4), and if the second temperature is higher than the reference temperature, driving force is provided to the first or second driving part 141, 151 of the camera module to decrease the BFL (S5).

1. An optical system comprising:
first to sixth lenses arranged along an optical axis, from an object side to a sensor side,
wherein the first lens has negative (−) refractive power,
wherein the second lens has positive (+) refractive power,
wherein the third lens has positive (+) refractive power,
wherein the fourth lens has negative (−) refractive power,
wherein the fifth lens has positive (+) refractive power,
wherein the sixth lens has negative (−) refractive power,
wherein an aperture is arranged between the second lens and the third lens, and
wherein among distances between adjacent lenses on the optical axis, the distance between the first lens and the second lens is the greatest, and
wherein the distance between the third lens and the fourth lens on the optical axis is smaller than the distance between the fourth lens and the fifth lens on the optical axis.

2. The optical system of claim 1,
wherein at least one of the first lens and the third lens is made of glass, and
wherein at least one of the second lens, the fourth lens, and the fifth lens is made of plastic.

3. The optical system of claim 1,
wherein thickness of the second lens among thicknesses of the first to sixth lenses on the optical axis is the greatest.

4. The optical system of claim 1,
wherein the second lens has a meniscus shape convex toward the sensor side.

5. The optical system of claim 1,
wherein the fifth lens has convex surfaces on both sides.

6. The optical system of claim 1,
wherein the sixth lens has a meniscus shape convex toward the sensor side.

7. The optical system of claim 1,
wherein the following conditional expression is satisfied,
10<TTL<15 <Conditional expression>
(In the above conditional expression, TTL means the distance from an object-side of the first lens to an upper surface of an image sensor on the optical axis).

8. The optical system of claim 1,
wherein the following conditional expression is satisfied,
0.3<ΣCT/TTL<0.8 <Conditional expression>
(In the above conditional expression, ΣCT means the sum of central thicknesses of the first to sixth lenses, and TTL means the distance from an object-side of the first lens to an upper surface of an image sensor on the optical axis).

9. The optical system of any one of claim 1,
wherein the following conditional expression is satisfied,
0.5<CA_L1/CA_L6<1.5 <Conditional expression>
(In the above conditional expression, CA_L1 means a clear aperture of the first lens, and CA_L6 means a clear aperture of the sixth lens).

10. An optical system comprising:
first to sixth lenses arranged along an optical axis, from an object side to a sensor side,
wherein the second lens has positive (+) refractive power,
wherein the fourth lens has negative (−) refractive power,
wherein the fifth lens has positive (+) refractive power,
wherein the sixth lens has negative (−) refractive power,
wherein the second lens has a largest thickness among thicknesses of the first to sixth lenses on the optical axis,
wherein the fifth lens has a convex shape on both sides, and
wherein the sixth lens has a meniscus shape convex toward the sensor-side, and
wherein, among distances between adjacent lenses, the distance between the third lens and the fourth lens on the optical axis is smaller than the distance between the fourth lens and the fifth lens on the optical axis.

11. The optical system of claim 10,
wherein among clear apertures of the first to sixth lenses, the clear aperture of the first lens is the largest, and the clear aperture of the third lens is the smallest.

12. The optical system of claim 10,
wherein among the distances between adjacent lenses on the optical axis, the distance between the third lens and the fourth lens is the smallest.

13. The optical system of claim 10,
wherein the distance between the second lens and the third lens on the optical axis is smaller than the distance between the fifth lens and the sixth lens on the optical axis.

14. The optical system of claim 10,
wherein the following conditional expression is satisfied,
1.5<TTL/ImgH<2.5 <Conditional expression>
(In the above conditional expression, TTL means the distance on the optical axis from an object-side of the first lens to an upper surface of an image sensor, and ImgH means ½ of a maximum diagonal length of the image sensor on the optical axis).

15. The optical system of claim 10,
wherein the following conditional expression is satisfied,
1<ΣCT/ΣCG<2.5 <Conditional expression>
(In the above conditional expression, ΣCT means the sum of central thicknesses of the first to sixth lenses on the optical axis, and ΣCG means the sum of the distances between adjacent lenses on the optical axis).

16. An optical system comprising:
first to sixth lenses arranged along an optical axis,
wherein the first lens has negative (−) refractive power,
wherein the second lens has positive (+) refractive power,
wherein the third lens has positive (+) refractive power,
wherein the fourth lens has negative (−) refractive power,
wherein the fifth lens has positive (+) refractive power,
wherein the sixth lens has negative (−) refractive power,
wherein an aperture is arranged between the second lens and the third lens, and
wherein, among distances between adjacent lenses, the distance between the third lens and the fourth lens on the optical axis is smaller than the distance between the fourth lens and the fifth lens on the optical axis.

17. The optical system of claim 16,
wherein the distance between the third lens and the fourth lens on the optical axis is smaller than the distance between the second lens and the third lens on the optical axis.

18. The optical system of claim 16,
wherein the distance between the first lens and the second lens on the optical axis is smaller than a thickness of the second lens on the optical axis.

19. The optical system of claim 16,
wherein the distance between the first lens and the second lens on the optical axis is smaller than a thickness of the fifth lens on the optical axis.

20. The optical system of claim 16,
wherein the following conditional expression is satisfied,
1.5<TTL/ImgH<2.5 <Conditional expression>
(In the above conditional expression, TTL means the distance on the optical axis from an object-side of the first lens to an upper surface of an image sensor, and ImgH means ½ of a maximum diagonal length of the image sensor on the optical axis).
